(19) United States
(12) Patent Application Publication
(10) Pub. No.: US 2024/0122221 A1
(43) Pub. Date: Apr. 18, 2024

(54) INSOLUBLE SACCHARIDE-COMPRISING COMPOSITIONS AND RELATED METHODS

(71) Applicant: Cambridge Glycoscience Ltd, Cambridge (GB)

(72) Inventors: Thomas J. SIMMONS, Cambridge (GB); Jeremy BARTOSIAK-JENTYS, Chester (GB)

(21) Appl. No.: 18/488,702

(22) Filed: Oct. 17, 2023

Related U.S. Application Data
(63) Continuation of application No. PCT/EP2022/060880, filed on Apr. 25, 2022.

(51) Int. Cl. A23L 27/30; A21D 2/18; A21D 13/062; A23G 1/40; A23G 9/34

(52) U.S. Cl. CPC A23L 27/33; A21D 2/181; A21D 13/062; A23G 1/40; A23G 9/34

(57) ABSTRACT

Compositions comprising soluble oligosaccharides and insoluble saccharides are provided. Methods for the formation of the compositions, food products, baked goods, or sweeteners, including the enzymatic production of the saccharides, the mixtures with various ratios and properties of the saccharides, and the uses of the same are also provided.

### CROSS REFERENCE

This application is a continuation of International Application No.: PCT/EP2022/060880 filed Apr. 25, 2022, which application claims the benefit of U.S. Provisional Application Nos. 63/178,836, filed Apr. 23, 2021, and 63/183,583 filed May 3, 2021 which are hereby incorporated by reference in their entirety.

### BACKGROUND

Sugary foods and drinks are an important part of cultural and lifestyle habits across the world, but the sugar they contain has been linked to obesity, diabetes, poor dental health, and disruptive behavior in people. Obesity and diabetes have tripled since the 1970's. In 2016, close to two billion adults were overweight. Over 650 million of these adults were medically obese. Furthermore, about ten percent of world population suffered from diabetes in 2019.

Natural sugar substitutes have emerged as a choice as a sugar replacement in food and beverages. Compared to artificial sweeteners, they do not produce bitter undertones or other unpleasant tastes along with their sweetness, both of which consumers find unappealing. But sugar substitutes may disrupt gut flora, whether they are natural or not. Adding dietary fiber alongside sugar substitutes helps maintain digestive health and a well-regulated gut flora. Such fiber includes saccharides of varying chain lengths and types. In addition to being found naturally in a wide spectrum of foods, fiber can also be produced separately and added to other foods during their manufacture.

However, dietary fiber can decrease the functional performance of the food, and in turn, the appeal of the food to the public. Hence, methods and compositions to incorporating fibers into food and beverage without compromising the functional performance of the food are sought.

### SUMMARY

Disclosed herein are methods and compositions that incorporate fiber into consumable products (e.g., food etc.) either without compromising the functional performance of the consumable product (e.g., food etc.) or improving the functional performance of the consumable product (e.g., food etc.). In some embodiments, provided herein is a composition comprising a first component (e.g., an insoluble saccharide component) and a second component (e.g., a soluble oligosaccharide component). In certain embodiments, the weight ratio of first component to second component is any suitable amount, such as about 1:99 to about 1:1. In some embodiments, the first and second component are in the composition in a combined total amount of at least 50 wt. %. In specific embodiments, the first component comprises one or more insoluble saccharides. In some specific embodiments, the second component is or comprises soluble saccharide, lipid(s), protein(s), surfactant, or a combination thereof.

In some aspects, described herein are sweetener compositions may comprise: a soluble oligosaccharide component, wherein the soluble oligosaccharide component may be a mixture of cello-oligosaccharides and xylo-oligosaccharides; and an insoluble saccharide component, wherein the insoluble saccharide component is a partially hydrolyzed fiber; wherein the insoluble saccharide component may have a particle size from 30 microns to 300 microns; wherein the sweetener composition comprises from 10% to 30% w/w of the insoluble saccharide component; wherein a food product made using the sweetener component may have a smell, flavor, texture comparable to a control food composition made using sucrose as a sweetener component.

In some embodiments, the insoluble saccharide component may have a particle size from 30 microns to 60 microns. In some embodiments, the insoluble saccharide component may have a particle size from 50 microns to 200 microns.

In some embodiments, the weight ratio of the insoluble saccharide component to the soluble oligosaccharide component being 2:98 to 30:70. In some embodiments, the soluble oligosaccharide may comprise at least 80% dry wt. % soluble oligosaccharides having a DP of two to twenty. In some embodiments, the insoluble saccharide may comprise partially hydrolyzed biomass, wherein the ratio of cellulose:hemicellulose in the partially hydrolyzed biomass is greater than in the corresponding unhydrolyzed biomass. In some embodiments, the partially hydrolyzed biomass may comprise microcrystalline cellulose (MCC), partially hydrolyzed oat fiber, partially hydrolyzed corn cob fiber, partially hydrolyzed corn bran, partially hydrolyzed corn stover, partially hydrolyzed wheat straw or partially hydrolyzed wheat bran

In some embodiments, the partially hydrolyzed biomass may comprise cellulose, lignin, and/or hemicellulose. In some embodiments, the insoluble saccharide may comprise at least one of: (i) a cellulose; (ii) a xylan; or (iii) a mannan. In some embodiments, the insoluble saccharide may comprise at least two of: (i) a cellulose; (ii) a xylan; or (iii) a mannan.

In some embodiments, the insoluble saccharide may comprise greater than 20% cellulose. In some embodiments, the insoluble saccharide may comprise greater than 40% cellulose. In some embodiments, the insoluble saccharide may comprise greater than 1% xylan. In some embodiments, the insoluble saccharide may comprise greater than 5% xylan. In some embodiments, the insoluble saccharide may comprise less than 70% xylan. In some embodiments, the insoluble saccharide may comprise less than 50% xylan.

In some embodiments, the insoluble saccharide may comprise greater than 1% mannan. In some embodiments, the insoluble saccharide may comprise greater than 5% mannan. In some embodiments, the insoluble saccharide may comprise less than 70% mannan. In some embodiments, the insoluble saccharide may comprise less than 50% mannan. In some embodiments, the insoluble saccharide may comprise greater than 0.1% mixed-linkage glucan. In some embodiments, the insoluble saccharide may comprise less than 17.5% mixed-linkage glucan.

In some embodiments, the sweetener composition may comprise less than 20% w/w glucose, fructose, galactose, sucrose, maltose, or lactose. In some embodiments, the sweetener composition may comprise less than 20% w/w monosaccharides.

In some embodiments, the insoluble saccharide may comprise a multimolecular complex of cellulose and hemicellulose. In some embodiments, the insoluble saccharide may comprise a polyaromatic compound.

In some embodiments, the partially hydrolyzed biomass may be a biomass which may have been hydrolyzed using enzyme hydrolysis. In some embodiments, the partially hydrolyzed biomass may be a biomass which may have been hydrolyzed using non-enzyme hydrolysis.

In some embodiments, the weight ratio of the cello-oligosaccharide to the xylo-oligosaccharide being 2:98 to 50:50. In some embodiments, the cello-oligosaccharide having a DP of 2 to 4. In some embodiments, the cello-oligosaccharide may comprise greater than 30% cellobiose. In some embodiments, the cello-oligosaccharide may comprise less than 10% cellotriose. In some embodiments, the cello-oligosaccharide may comprise less than 5% cellotetraose.

In some embodiments, the xylo-oligosaccharide having a DP of 2 to 6. In some embodiments, the xylo-oligosaccharide may comprise less than 70% xylobiose. In some embodiments, the xylo-oligosaccharide may comprise less than 30% xylotriose. In some embodiments, the xylo-oligosaccharide may comprise less than 10% xylotetraose. In some embodiments, the xylo-oligosaccharide may comprise at least 5% substituted xylo-oligosaccharide.

In some embodiments, the sweetener composition may be consumable by a human.

In some embodiments, described herein are food products. The food product may comprise from 1% to 50% w/w of the sweetener composition, wherein at least one characteristic of the food product selected of the group consisting of texture, height, color, water loss or sweetness being within 20% of the same characteristic of a control food product, the control food product comprising a soluble oligosaccharide and lacking an insoluble saccharide in the composition of a component whose purpose in the food product is to modulate the above characteristics.

In some embodiments, the food product may comprise from 1% to 50% w/w of the sweetener composition, wherein at least one characteristic of the food product selected of the group consisting of texture, height, color, water loss or sweetness being within 10% of the same characteristic of a control food product, the control food product comprising a soluble oligosaccharide and lacking an insoluble saccharide in the composition of a component whose purpose in the food product is to modulate the above characteristics.

In some embodiments, the food product may be a baked good. In some embodiments, the baked good selected from the group consisting of a cookie, cake, biscuit, pastry, or scone.

In some embodiments, the food product or the baked good comprise lignocellulose thermochemical breakdown products, such as alpha pinene, tetrahydrolinalool, dihydromyrcenol, furfural, menthone, isomenthone, linalool, menthyl acetate, neomenthol, caryophyllene, Isomenthol, menthol, Phenylacetaldehyde, Pulegone, 4-t-butylcyclohexyl acetate, Carvone, dihydroxybenzaldehyde isomer, anethole, guaiacol, verdyl acetate, 2-phenylethyl alcohol, beta ionone, diphenyl ether, phenolicmethoxybenzaldehyde isomer, Thymol, vinyl guaiacol, hexyl salicylate, Myristicin, isoeugenol, alpha hexylcinnamaldehyde, vinyl phenol, vanillin, hexadecanoic acid at greater than 10 ppb.

In some embodiments, the food product being a being a fat-based food product containing more than 20% w/w fat. In some embodiments, the fat-based food product selected from the group consisting of chocolate and ice cream.

In some embodiments, the food product being a water-based food product. In some embodiments, the water-based food product selected from the group consisting of jam, jelly, icing, and candy.

In some aspects, described herein are sweetener compositions. The sweetener composition may comprise: from 50% to 70% w/w xylo-oligosaccharides; wherein the xylo-oligosaccharides have a degree of polymerization from 2-6; from 5% to 20% w/w cello-oligosaccharides; wherein the cello-oligosaccharides have a degree of polymerization from 2-4; from 7.5% to 30% w/w insoluble saccharides, wherein the insoluble saccharides are an at least partially hydrolyzed biomass with a particle size from 30 microns to 300 microns; wherein the sweetener composition consists essentially a mixture of a, b and c.

In some aspects, described herein are methods of forming a composition. The method may comprise: providing a plant biomass, the plant biomass may comprise cellulose and hemicellulose; and incubating the plant biomass with at least one enzyme, thereby yielding a composition may comprise: i. a soluble oligosaccharide component, the soluble oligosaccharide component may comprise soluble oligosaccharide having a degree of polymerization (DP) of 2 to 20; and ii.

an insoluble saccharide component, the insoluble saccharide component may comprise insoluble saccharide having a DP of at least 20, the composition may comprise the soluble oligosaccharide component and the insoluble saccharide component in a combined total amount of at least 50 dry wt. %, the weight ratio of the soluble oligosaccharide component to the insoluble saccharide component being 1:99 to 50:50.

In some embodiments, the method may comprise thermochemically treating the plant biomass. In some embodiments, the weight ratio of the insoluble saccharide component to the soluble oligosaccharide component being 2:98 to 50:50.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. The patent of application file contains at least one drawing executed in color. Copies of this patent or patent application publication with color drawing(s) will be provided by the Office upon request and payment of the necessary fee. A better understanding of the features and advantages of the present disclosure will be obtained by reference to the following detailed description that sets forth illustrative embodiments, in which the principles of the disclosure are utilized, and the accompanying drawings of which:

FIG. 1 shows muffin batter mixes with various amounts of partially hydrolyzed corn cob fiber.

FIG. 2A shows two views of whole baked muffins with various amounts of partially hydrolyzed corn cob fiber. A muffin made with sucrose is shown on the far right. The top row shows the front/side view of the whole muffin. The bottom row shows the top view of the whole muffin.

FIG. 2B shows the mid-sectional view of whole baked muffins with various amounts of partially hydrolyzed corn cob fiber. A muffin made with sucrose is shown on the far right.

FIG. 3 shows the water loss of whole baked muffins with various amounts of partially hydrolyzed corn cob fiber after baking. The Y-axis shows the percentage (%) of water loss of the muffin 10 minutes after baking. The X-axis shows the amount of partially hydrolyzed corn cob fiber in the muffin. Error bars represent standard deviations.

FIG. 4A shows a typical force analysis plot of a whole baked muffin using the probe shown in FIG. 4B.

FIG. 4B shows a firmness and springiness test for whole baked muffins with various amounts of partially hydrolyzed corn cob fiber. The left Y-axis shows the percentage (%) of firmness of the muffin. The right Y-axis shows the percentage (%) of springiness of the muffin. The X-axis shows the amount of partially hydrolyzed corn cob fiber in the muffin. A picture of the probe used in this test is shown to the left of the plot. The dotted lines indicate the trendline for the firmness or springiness measurement. Error bars represent standard deviations.

FIG. 4C shows another firmness and springiness test for whole baked muffins with various amounts of partially hydrolyzed corn cob fiber. The left Y-axis shows the percentage (%) of firmness of the muffin. The right Y-axis shows the percentage (%) of springiness of the muffin. The X-axis shows the amount of partially hydrolyzed corn cob fiber in the muffin. A picture of the probe used in this test is shown to the left of the plot. The dotted lines indicate the trendline for the firmness or springiness measurement. Error bars represent standard deviations.

FIG. 5A shows a sensory evaluation form for the sensory evaluation of the whole baked muffins with various amounts of partially hydrolyzed corn cob fiber.

FIG. 5B shows the sensory evaluation of whole baked muffins with various amounts of partially hydrolyzed corn cob fiber. The Y-axis shows the sensory rating of the muffin. The sensory rating includes smell, sweetness, mouthfeel, and overall acceptance of the muffins. The X-axis shows the muffins with various amounts of partially hydrolyzed corn cob fiber. Error bars represent standard deviations.

FIG. 5C shows the sensory evaluation of whole baked muffins with various amounts of partially hydrolyzed corn cob fiber. The Y-axis shows the sensory rating of the muffin. The sensory rating includes color and texture of the muffins. The X-axis shows the muffins with various amounts of partially hydrolyzed corn cob fiber. Error bars represent standard deviations.

FIG. 6A shows cookie dough mixes with various amounts of microcrystalline cellulose (MCC) fiber. A cookie dough mix obtained with sucrose is shown on the lower right.

FIG. 6B shows whole baked cookies with various amounts of MCC fiber. A whole baked cookie obtained with sucrose is shown on the far right.

FIG. 7 shows the water loss of whole baked cookies with various amounts of MCC fiber after baking. The Y-axis shows the percentage (%) of water loss of the cookie 10 minutes after baking. The X-axis shows the cookie with various amounts of insoluble saccharide/fiber. Error bars represent standard deviations.

FIG. 8 shows the sensory evaluation of whole baked cookies with various amounts of MCC fiber. The Y-axis shows the sensory rating of the cookie. The sensory rating includes color, texture, smell, sweetness, mouthfeel, and overall acceptance of the cookies. The X-axis shows the cookie with various amounts of MCC fiber. A whole baked cookie obtained with sucrose is included for comparison.

FIG. 9 shows cookie dough mixes with various amounts of unhydrolyzed corn cob fiber (UHF).

FIG. 10 shows two views of whole baked cookies with various amounts of UHF. The top row shows the top view of the cookie. The bottom row shows the front and side-sectional views of the cookie.

FIG. 11 shows color of the cookie dough mixes and whole baked cookies with various amounts of UHF. The top row shows the cookie dough mix. The middle row shows the top view of the cookie. The bottom row shows top view of the half cookie. The cookie dough mixes and cookies in the top and middle rows are labelled with color ranking (the higher the ranking is, the darker the color is).

FIG. 12 shows the dispersibility of whole baked cookies with various amounts of UHF and MCC fiber.

FIG. 13 shows the water loss of whole baked cookies with various amounts of UHF and MCC fiber after baking. The Y-axis shows the percentage (%) of water loss of the cookie 10 minutes after baking. The X-axis shows the amount of UHF and MCC fiber in the muffin. Error bars represent standard deviations.

FIG. 14 shows the sensory evaluation of whole baked cookies with various amounts of UHF and MCC fiber. The Y-axis shows the overall acceptance rating of the cookie. The X-axis shows the amount of UHF and MCC fiber in the muffin. Error bars represent standard deviations.

FIG. 15 shows the response of consumers (n=13) when asked if they could recognize UHF in cookies.

FIG. 16 shows the response of consumers (n=13) when asked if they could differentiate partially hydrolyzed corn cob fiber from UHF in cookies.

FIG. 17 shows the response of consumers (n=13) when asked if any cookie stuck in their teeth.

FIG. 18 shows whole baked cookies with various fibers. The cookies were pressed down on the baking tray.

FIG. 19 shows the response of consumers (n=13) when asked if there was a difference among UHFs with fiber particles of different sizes.

FIG. 20 shows the response of consumers (n=13) when asked if they could feel a bitty/sandy mouthfeel in whole baked cookies with various fibers.

FIG. 21 shows the response of consumers (n=13) when asked which cookies they preferred in terms of mouthfeel.

FIG. 22 shows the response of consumers (n=13) when asked which cookie had the worst mouthfeel.

FIG. 23 shows the particle size distribution of partially hydrolyzed corn cob fiber (PHF) and micro-crystalline cellulose (MCC) composition as observed by HPLC analysis.

FIG. 24 shows cookie doughs with various XOS:COS (7:1) to unhydrolyzed oat fiber ratios and with two particle size ranges (<53 μm and <200-100 μm)

FIG. 25 shows the harness (g·sec) of cookies with various XOS:COS (7:1) to unhydrolyzed oat fiber ratios and two particle size ranges (<53 μm FIG. 25(a) and <200-100 μm FIG. 25(b))

FIG. 26 shows the water loss (%) of cookies with various XOS:COS (7:1) to unhydrolyzed oat fiber ratios and two particle size ranges (<53 μm FIG. 26(a) and <200-100 μm FIG. 26(b))

FIG. 27 shows the baked cookies at various XOS:COS (7:1) to unhydrolyzed oat fiber ratios and with two particle size ranges (<53 μm and <200-100 μm)

FIG. 28 shows the cookie doughs with various XOS:COS (7:1) to partially hydrolyzed oat (ph-OF) fiber ratios and two levels of sucrose replacement (100% replacement—top row; 50% replacement bottom row).

FIG. 29 shows the baked cookies at various XOS:COS (7:1) to partially hydrolyzed oat fiber ratios and two levels of sucrose replacement (100% replacement—top row; 50% replacement bottom row).

FIG. 30 shows the water loss (%) of cookies with various XOS:COS (7:1) to partially hydrolyzed oat fiber ratios and two levels of sucrose replacement.

FIG. 31 shows the hardness (g·sec) of cookies with various XOS:COS (7:1) to partially hydrolyzed oat fiber ratios and two levels of sucrose replacement.

FIG. 32 shows the baked cookies at various XOS:COS (7:1) to MCC partially hydrolyzed fiber ratios.

FIG. 33 shows the water loss (%) of cookies with various XOS:COS (7:1) to MCC partially hydrolyzed fiber, partially hydrolyzed oat fiber or unhydrolyzed oat fiber ratios at 100% sucrose replacement level.

FIG. 34 shows the spreadability of cookies with various XOS:COS (7:1) to MCC partially hydrolyzed fiber, partially hydrolyzed oat fiber, or unhydrolyzed oat fiber ratios at 100% sucrose replacement level.

FIG. 35 shows the hardness (g·sec) of cookies with various XOS:COS (7:1) to MCC partially hydrolyzed fiber, partially hydrolyzed oat fiber, or unhydrolyzed oat fiber ratios at 100% sucrose replacement level.

FIG. 36 shows the chemical composition of the unhydrolyzed oat fiber (OF—FIG. 36(a)) and of the partially hydrolyzed oat fiber (ph-OF—FIG. 36(b)).

### DETAILED DESCRIPTION

Described herein are insoluble saccharides that can be useful in food products, baked goods, sweeteners, nutraceuticals, cosmetics, home care or personal care goods. Also described are methods of forming or formulating the same. The insoluble saccharides may be obtained from partially hydrolyzed biomass. The insoluble saccharides may include, cellulose, or hemicellulose. Adding the insoluble saccharides obtained from partially hydrolyzed biomass may improve the functional performance of the food products, baked goods, sweeteners, nutraceuticals, cosmetics, home care or personal care goods compared to those lacking the same.

In certain specific embodiments, the insoluble saccharide component comprises insoluble saccharide having a degree of polymerization (DP) of at least 20 (e.g., wherein the insoluble saccharide having a DP of at least 20 comprises a single DP or a mixture of DP of at least 20).

Further adding soluble saccharides alongside the insoluble saccharides may improve the functional performance of the food products, baked goods, sweeteners, nutraceuticals, cosmetics, home care or personal care goods compared to those lacking the same. The soluble oligosaccharides may also include cello-oligosaccharides, xylo-oligosaccharides, and/or mannan-oligosaccharides.

Provided in various embodiments herein are compositions, sweetener compositions, nutraceutical compositions, cosmetic compositions, home care compositions or personal care compositions, foodstuffs comprising such a (e.g., sweetener) composition, methods of making such (e.g., sweetener) compositions, methods of making foodstuffs with such sweetener compositions, and the like. In certain embodiments, provided herein are compositions comprising a soluble oligosaccharide component and an insoluble saccharide component (e.g., comprising oligosaccharide and/or polysaccharide). In some embodiments, a composition provided herein comprises additional agents (e.g., monosaccharide(s)).

In certain embodiments, a composition provided herein comprises any suitable amount of soluble oligosaccharide and insoluble saccharide (e.g., having the DP, composition, size, shape or other parameters described herein), such as in a combined total amount of at least 50 dry wt. %. In some embodiments, a composition provided herein comprises any ratio of soluble oligosaccharide to insoluble saccharide (e.g., having the DP, composition, size, shape or other parameters described herein), such as in a weight ratio of at least 1:1 (e.g., 1:1 to 99:1).

In some specific embodiments, the soluble oligosaccharide component comprises soluble oligosaccharide having a DP of 2 to 20 (e.g., wherein the soluble oligosaccharide having a DP of 2 to 20 comprises a single DP or a mixture of DP within the 2 to 20 range).

A composition provided herein can comprise any suitable amount of a first component (e.g., insoluble saccharide) and a second component (e.g., lipid, protein, soluble saccharide, surfactant, etc.), such as in a weight ratio from 1:1 to 99:1. The weight ratio of insoluble saccharide to a second component described herein can be less than 99:1, 95:1, 90:1, 85:1, 80:1, 75:1, 70:1, 65:1, 60:1, 55:1, 50:1, 45:1, 40:1, 35:1, 30:1, 25:1, 20:1, 15:1, 10:1, 5:1, or 1:1. The weight ratio of insoluble saccharide to a second component described herein can be greater than 2:1, 5:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, or 98:1.

A composition provided herein can comprise any suitable amount of a first component (e.g., soluble oligosaccharide, lipid, protein, etc.) and a second component (insoluble saccharide), such as in a weight ratio from 1:1 to 99:1. The weight ratio of soluble oligosaccharide to a second component described herein can be less than 99:1, 95:1, 90:1, 85:1, 80:1, 75:1, 70:1, 65:1, 60:1, 55:1, 50:1, 45:1, 40:1, 35:1, 30:1, 25:1, 20:1, 15:1, 10:1, 5:1, or 1:1. The weight ratio of soluble oligosaccharide to a second component described herein can be greater than 2:1, 5:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, or 98:1.

In certain embodiments, the first component is a lipid. A composition provided herein can comprise any suitable amount of lipid and insoluble saccharide (e.g., having the DP, composition, size, shape or other parameters described herein), such as in a combined total amount of at least 50 dry wt. %. In some embodiments, a composition provided herein comprises any ratio of lipid to insoluble saccharide (e.g., having the DP, composition, size, shape or other parameters described herein), such as in a weight ratio of at least 1:1 (e.g., 1:1 to 99:1).

In some specific embodiments, the lipid component comprises monoglycerides, diglycerides, triglycerides, phospholipids (such as lecithin), sterols (such as cholesterol), fatty acids, fatty alcohols, fatty acid ester, or waxes.

In certain embodiments, the first component is protein. A composition provided herein can comprise any suitable amount of protein and insoluble saccharide (e.g., having the DP, composition, size, shape or other parameters described herein), such as in a combined total amount of at least 50 dry wt. %. In some embodiments, a composition provided herein comprises any ratio of protein to insoluble saccharide (e.g., having the DP, composition, size, shape or other parameters described herein), such as in a weight ratio of at least 1:1 (e.g., 1:1 to 99:1).

In some specific embodiments, the protein component comprises amino acids, oligopeptides, polypeptides, enzymes (catalytic proteins), structural proteins. Proteins can be chemically modified through biological or synthetic processes and via oxidation, reduction, or other reactions. Examples of modified proteins include glycoproteins (such as arabinogalactan proteins) and lipoproteins.

In certain embodiments, the first component is soluble polysaccharide. A composition provided herein can comprise any suitable amount of soluble polysaccharide and insoluble saccharide (e.g., having the DP, composition, size, shape or other parameters described herein), such as in a combined total amount of at least 50 dry wt. %. In some embodiments, a composition provided herein comprises any ratio of soluble polysaccharide to insoluble saccharide (e.g., having the DP, composition, size, shape or other parameters described herein), such as in a weight ratio of at least 1:1 (e.g., 1:1 to 99:1).

In some specific embodiments, the soluble polysaccharide component comprises polysaccharides of DP 20 or greater which can be solubilized in a pH-neutral aqueous medium at or below a given concentration. Relevant concentrations are between 10 and 100 g/L. Examples of soluble polysaccharides include hemicelluloses (such as xylans, mannans, mixed-linage glucans, lichenans, xyloglucans), pectins (such as homogalacturonan, rhamnogalacturonan, xylogalacturonan), inulin, starch (such as amylose and amylopectin) and gums (such as konjac gum).

In certain embodiments, the composition comprises water. A composition provided herein can comprise any suitable amount of water and insoluble saccharide (e.g., having the DP, composition, size, shape or other parameters described herein), such as in a combined total amount of at least 50 wt. %. In some embodiments, a composition provided herein comprises any ratio of water to insoluble saccharide (e.g., having the DP, composition, size, shape or other parameters described herein), such as in a weight ratio of at least 1:1 (e.g., 1:1 to 99:1).

In certain embodiments, the composition comprises a surfactant. A composition provided herein can comprise any suitable amount of surfactant and insoluble saccharide (e.g., having the DP, composition, size, shape or other parameters described herein), such as in a combined total amount of at least 50 dry wt. %. In some embodiments, a composition provided herein comprises any ratio of surfactant to insoluble saccharide (e.g., having the DP, composition, size, shape or other parameters described herein), such as in a weight ratio of at least 1:1 (e.g., 1:1 to 99:1).

In some specific embodiments, the surfactant component comprises anionic surfactants (such as sulfate surfactants, sulfonate surfactants, phosphate surfactants, and carboxylate surfactants), cationic surfactants, zwitterionic surfactants, nonpolar surfactants, alkyl glycosides, alkyl polyglycosides, alkyl glucosides, alkyl polyglucosides, alkyl xylosides, alkyl polyxylosides. In some specific embodiments, the surfactant component may be chemical, biological, synthetic and/or natural. In some specific embodiments, the surfactant component forms part of an emulsified medium in which the insoluble saccharide component is dispersed, soaked, coated, covered and/or suspended.

In certain embodiments, a composition provided herein comprises any suitable amount of water and insoluble saccharide (e.g., having the DP, composition, size, shape or other parameters described herein), such as in a combined total amount of at least 30 wt. %. In some embodiments, a composition provided herein comprises any ratio of water to insoluble saccharide (e.g., having the DP, composition, size, shape or other parameters described herein), such as in a weight ratio of at least 1:10.

In certain embodiments, a composition provided herein comprises any suitable amount of insoluble saccharide (e.g., having the DP, composition, size, shape or other parameters described herein) in a specific pH range, such as between 2 and 9, 2.5 and 8.5, 3 and 8, 3.5 and 7.75, 4 and 7.5, 4.5 and 7.25, 5 and 7. In some specific embodiments, pH-modulating compounds such as acids, bases, acidity regulators and pH buffers may be additionally found in the composition. In some specific embodiments the compositions may comprise organic acids including oxalate, tartrate, malate, succinate, lactate, formate, acetate, sorbic acid, acetic acid, benzoic acid, propionic acid, adipic acid, ammonium aluminum sulfate, ammonium bicarbonate, ammonium carbonate, ammonium citrate, dibasic, ammonium citrate monobasic, ammonium hydroxide, ammonium phosphate, dibasic, ammonium phosphate, monobasic, calcium acetate, calcium acid pyrophosphate, calcium carbonate, calcium chloride, calcium citrate, calcium fumarate, calcium gluconate, calcium hydroxide, calcium lactate, calcium oxide, calcium phosphate (dibasic), calcium phosphate (monobasic), calcium phosphate (tribasic), calcium sulfate, carbon dioxide, citric acid, cream of tartar, fumaric acid, gluconic acid, glucono-delta-lactone, hydrochloric acid, lactic acid, magnesium carbonate, magnesium citrate, magnesium fumarate, magnesium hydroxide, magnesium oxide, magnesium phosphate, magnesium sulfate, malic acid, manganese sulfate, metatartaric acid, phosphoric acid, potassium acid tartrate, potassium aluminum sulfate, potassium bicarbonate, potassium carbonate, potassium chloride, potassium citrate, potassium fumarate, potassium hydroxide, potassium lactate, potassium phosphate (dibasic), potassium phosphate (tribasic), potassium pyrophosphate (tetrabasic), potassium sulfate, potassium tartrate, potassium tripolyphosphate, sodium acetate, sodium acid pyrophosphate, sodium acid tartrate, sodium aluminum phosphate, sodium aluminum, sulfate, sodium bicarbonate, sodium bisulfate, sodium carbonate, sodium citrate, sodium fumarate, sodium gluconate, sodium hexametaphosphate, sodium hydroxide, sodium lactate, sodium phosphate (dibasic), sodium phosphate (monobasic), sodium phosphate (tribasic), sodium potassium hexametaphosphate, sodium potassium tartrate, sodium potassium tripolyphosphate, sodium pyrophosphate (tetrabasic), sodium tripolyphosphate, sulfuric acid, sulfurous acid, tartaric acid, a salt thereof, or a combination thereof.

In certain embodiments, a composition provided herein comprises any suitable amount of insoluble saccharide (e.g., having the DP, composition, size, shape or other parameters described herein), with two or more of the components described above. For example, a composition might comprise insoluble saccharide, protein and soluble polysaccharide. For example, a composition might comprise insoluble saccharide, soluble oligosaccharide and soluble polysaccharide. For example, a composition might comprise insoluble saccharide, protein, surfactant and soluble polysaccharide. In certain embodiments, a composition provided herein comprises five or more of the aforementioned components.

As used in the specification and claims, the singular forms “a,” “an,” and “the” include plural references unless the context clearly dictates otherwise. For example, the term “a sample” includes a plurality of samples, including mixtures thereof.

The term “about,” as used herein, can mean within 1 or more than 1 standard deviation. Alternatively, about can mean a range of up to 10%, up to 5%, or up to 1% of a given value. For example, “about” can mean up to ±10% of a given value. In more targeted instances, “about” can mean±9%, ±8%, ±7%, ±6%, ±5%, ±4%, ±3%, ±2%, or ±1% of a given value.

As used herein, “food” and “foodstuff” generally refer to any item destined for consumption, which may be consumption by a human or by any other animal. It may be food, feed, beverage, or an ingredient to be used in the production of any of the above.

As used herein, “nutraceutical” generally refers to any composition introduced into a human or other animal, whether by ingestion, injection, absorption, or any other method, for the purpose of providing nutrition to the human or other animal. Use of such a nutraceutical may take the form of a drink with added dietary fiber, a prebiotic additive, a pill or other capsule, or any other suitable use.

As used herein, “cosmetic” generally refers to any composition which is intended for use on humans or other animals or on products or materials used by humans or animals to increase the aesthetic appeal or prevent future loss of aesthetic appeal of said humans, animal products or materials, as well as any other compositions known in general parlance as cosmetics. Aesthetic appeal is not limited to visual aesthetics but applies as well to textural or any other appeal. The cosmetic may be mascara, foundation, lip gloss, eyeshadow, eyeliner, primer, lipstick, blush, nail polish, bronzer, or any other makeup; shampoo, conditioner, styling mousse, styling gel, hairspray, hair dye, hair wax, or any other hair product; moisturizer, exfoliant, sun cream, face cream, cleanser, toothpaste, cream, lotion, ointment, or any other composition effective in modifying teeth, skin, hair, or other parts of the body in some aesthetic way. Further, the cosmetic may be a composition used as a component of a face mask, brush, hair roller, other styling device, other solid structure, or any other suitable composition. Further, the cosmetic may be a composition used as a component of all-purpose cleaners, abrasive cleaners, powders, liquids, scouring pads, non-abrasive cleaners, powder cleaners, liquid cleaners, spray cleaners, kitchen cleaners, bathroom cleaners, glass and metal cleaners, bleaches, disinfectants and disinfectant cleaners, drain openers, glass cleaners, glass and multi-surface cleaners, hard water mineral removers, metal cleaners and polishes, oven cleaners, shower cleaners, toilet bowl cleaners, tub cleaners, tile cleaners, sink cleaners, floor cleaners, furniture cleaners, carpet cleaners, rug cleaners, dusting products, floor care products, furniture cleaners, polishes and upholstery cleaners.

As used herein, “ingredient” generally refers to any composition suitable for incorporation into a foodstuff, cosmetic, or nutraceutical product, which may include those which are used directly as the product itself. It may be a dry or liquid ingredient, unless it is specifically referred to as “dry” or “liquid.” This includes compositions that may be deemed to be an intermediate during a method of the disclosure, such as a composition formed after the combining of the one or more oligosaccharides and the one or more soluble polysaccharides prior to any further purification, optimization, drying, dissolving, or any other such steps, as well as including the final composition obtained from the method.

As used herein, “polysaccharide” generally refers to a saccharide polymer of any length greater than 20 residues. Polysaccharides may be highly branched, lightly branched, or unbranched. Polysaccharides may include any manner of glycosidic bond in any combination; any number of, for example, α or β linkages; and any combination of monomer types, such as glucose, glucosamine, mannose, xylose, galactose, fucose, fructose, glucuronic acid, arabinose, or derivatives thereof, such as any combination of the above monomers decorated with acetyl or other groups. The polysaccharide may be a cellulosic or hemicellulosic polymer. Hemicellulosic polymers envisaged include xylan, glucuronoxylan, arabinoxylan, mannan, glucomannan, galactoglucomannan, arabinoglucuronoxylan and xyloglucan. In some embodiments, the cellulosic polymer may be cellulose.

As used herein, “cellulose” generally refers to polysaccharides composed of glucose residues linked by β-1,4-glycosidic bonds, and derivatives thereof. Cellulose can be found in crystalline or amorphous forms and cellulosic aggregates can comprise both crystalline and amorphous parts. Different types of crystallinities can also be found within cellulose, such as cellulose I-alpha, cellulose I-beta and cellulose II.

As used herein, “xylan” generally refers to polysaccharides composed of a backbone of xylose residues and may also contain glucuronic acid residues, arabinose residues and/or acetyl groups and/or any other modification. Derivatives of xylan include arabinoxylan, glucuronoxylan and arabinoglucuronoxylan. Unless otherwise stated, when used herein these types of xylan are used interchangeably to refer to any other.

As used herein, “mixed-linkage glucan” generally refers to polysaccharides composed of glucose residues linked by β-1,3-glycosidic bonds and β-1,4-glycosidic bonds. As used herein, “mannan” generally refers to polysaccharides composed of mannose residues and optionally containing glucose and/or galactose residues. Derivatives of mannan include glucomannan, galactomannan and galactoglucomannan. Unless otherwise stated, when used herein these types of mannan are used interchangeably to refer to any other.

As used herein, “chitin” or “chitosan” generally refer to polysaccharides composed of glucosamine and/or N-acetyl-glucosamine residues. As used herein, “pectin” generally refers to any galacturonic acid-containing saccharide, for example homogalacturonan and rhamnogalacturonan. The polysaccharides of cellulose, xylan, mixed-linkage glucan, mannan, chitin, or chitosan may include chemical variants that have been modified by oxidation, reduction, esterification, epimerization, or another chemical modification.

As used herein, “lignocellulose” generally refers to polysaccharide-comprising aggregates that are, or are derived from, plant cell wall material. For example, they may include lignin and one or more of the following polysaccharides associated together: cellulose, xylan, mannan, and mixed-linkage glucan.

As used herein “highly branched,” “lightly branched,” and “unbranched” generally refer to the number of side-chains per stretch of main chain in a saccharide. Highly branched saccharides have on average from 4 to 10 side chains per 10 main-chain residues, slightly branched saccharides have on average from 1 to 3 side chains per 10 main-chain residues, and unbranched saccharides have only one main chain and no side chains. The average is calculated by dividing the number of side chains in a saccharide by the number of main-chain residues.

As used herein, “saccharide” generally refers to any polysaccharide and/or oligosaccharide, such as a monosaccharide and/or a disaccharide.

As used herein, “oligosaccharide” generally refers to saccharide polymers having chain lengths less than or equal to 20 saccharide residues (e.g., and at least 2 saccharide residues). Oligosaccharides may be highly branched, lightly branched, or unbranched; and may include glycosidic bonds in any combination, any number of α or β linkages, and any combination of monomer types, such as glucose, glucosamine, mannose, xylose, galactose, fucose, fructose, glucuronic acid, arabinose, or derivatives thereof. Suitable derivatives include the above monomers including acetyl or other groups.

As used herein, “monosaccharide” and “disaccharide” generally refer to saccharide compounds consisting of one or 2 residues, respectively. Monosaccharides are compounds such as glucose, glucosamine, xylose, galactose, fucose, fructose, glucuronic acid, arabinose, galacturonic acid, or epimers or other derivatives thereof. Suitable derivatives include acetyl or other groups. Disaccharides are compounds consisting of 2 monosaccharides joined via any glycosidic bond.

As used herein, “cello-oligosaccharides” generally refer to oligosaccharides composed of one or more glucose residues linked by β-1,4-glycosidic bonds, and may be chemically related to that by oxidation, reduction, esterification, epimerization, further glycosylation, or another chemical modification.

As used herein, “xylo-oligosaccharides” generally refer to oligosaccharides composed primarily of xylose residues (typically linked by β-1,4-glycosidic bonds) and may also contain glucuronic acid residues and/or arabinose residues and/or acetyl groups and/or any other modification, and may be chemically related to that by oxidation, reduction, esterification, epimerization, further glycosylation, or another chemical modification.

As used herein, “mixed-linkage glucan-oligosaccharides” generally refer to oligosaccharides composed of one or more glucose residues linked by at least one β-1,3-glycosidic bond and at least one β-1,4-glycosidic bond, and may be chemically related to that by oxidation, reduction, esterification, epimerization, further glycosylation, or another chemical modification.

As used herein, “mannan” generally refers to polysaccharides composed of greater than 40% mannose residues and optionally containing glucose and/or galactose residues. As used herein, “mixed-linkage glucan” generally refers to polysaccharides composed primarily of glucose residues linked primarily by β-1,3-glycosidic bonds and β-1,4-glycosidic bonds. As used herein, “xyloglucan” generally refers to polysaccharides composed of greater than 25% by weight of glucose residues and greater than 10% by weight xylose. As used herein, “fructan” generally refers to polysaccharides composed primarily of fructose residues. As used herein, “galactan” generally refers to polysaccharides composed primarily of galactose residues. As used herein, “pectin” generally refers to polysaccharides composed of greater than 25% by weight galacturonic acid residues. The polysaccharides of cellulose, xylan, mannan, mixed-linkage glucan, xyloglucan, fructan, galactan or pectin may include chemical variants that have been modified by oxidation, reduction, esterification, epimerization, or another chemical modification.

As used herein, “manno-oligosaccharides” or “mannan-oligosaccharides” generally refer to oligosaccharides composed of one or more mannose residues and optionally containing one or more glucose and/or galactose residues, and may be chemically related to that by oxidation, reduction, esterification, epimerization, further glycosylation, or another chemical modification.

As used herein, “chito-oligosaccharides” generally refer to oligosaccharides composed of one or more glucosamine and/or N-acetyl-glucosamine residues, and may be chemically related to that by oxidation, reduction, esterification, epimerization, further glycosylation, or another chemical modification.

As used herein, “fructo-oligosaccharides” (FOS) generally refer to oligosaccharides composed of one or more fructose residues, and may be chemically related to that by oxidation, reduction, esterification, epimerization, or another chemical modification.

As used herein, “galacto-oligosaccharides” (GOS) generally refer to oligosaccharides composed of one or more galactose residues and optionally containing one or more glucose residues, and may be chemically related to that by oxidation, reduction, esterification, epimerization, or another chemical modification.

As used herein, “malto-oligosaccharides” or “maltodextrins” (MD) generally refer to oligosaccharides composed of one or more glucose residues linked by at least one alpha-bond, and may be chemically related to that by oxidation, reduction, esterification, epimerization, or another chemical modification.

As used herein, “lignin” generally refers to polymeric or oligomeric structures composed of aromatic subunits (generally having been constructed within plants via non-enzymatic coupling reactions) such as lignols, or products of lignin thermochemical breakdown/depolymerisation.

As used herein, “soluble” generally refers to a compound that that can be solubilized in a pH-neutral aqueous medium at or below a given concentration. Relevant concentrations are between 10 and 100 g/L. Soluble oligosaccharides can include cello-oligosaccharides of DP 2-6, xylo-oligosaccharides of DP 2-10, mannan-oligosaccharides of DP 2-6 and mixed-linkage glucan oligosaccharides of DP 3-10. Soluble polysaccharides can include hemicellulose, pectin, xylan, mannan, mixed-linkage glucan, inulin, fructan, arabinan and xyloglucan.

As used herein, “insoluble” generally refers to a compound that may not be solubilized in a pH-neutral aqueous medium at or below a given concentration. Relevant concentrations can be between 1 and 10 g/L. It may be the case that a given compound is insoluble in a pH-neutral aqueous medium at any concentration. Compounds that could become soluble in a pH-neutral aqueous medium upon thermochemical treatment can be classified as insoluble until such a thermochemical treatment has enabled their solubility. Insoluble saccharides can include cellulose as well as aggregates containing cellulose complexed with other compounds (including xylan, mannan, mixed-linkage glucan, fructan, xyloglucan, galactan, pectin and lignin) such as lignocellulose.

As used herein, “lipid” generally refers to any substance of biological relevance, composed of carbon, hydrogen, or oxygen, that is insoluble in water but soluble in non-polar solvents. Relevant types of compounds include mono-, di-, and triglycerides, phospholipids (such as lecithin), sterols (such as cholesterol), waxes (such as beeswax), and free fatty acids. In some cases, lipids may be chemically modified by oxidation, reduction, esterification, epimerization, glycosylation, or another chemical modification.

As used herein, “protein” generally refers to full-length proteins or active fragments of proteins (the fragments of proteins may be a fragment containing at least 60% of the full-length protein's amino acid sequence). In some cases, proteins may be chemically modified by oxidation, reduction, esterification, epimerization, glycosylation, or another chemical modification.

As used herein, “surfactant” generally refers to any substance that lowers the surface tension (or interfacial tension) between two liquids, between a gas and a liquid, or between a liquid and a solid. Surfactants may act as detergents, wetting agents, emulsifiers, foaming agents, or dispersants. Relevant surfactant types include anionic surfactants (such as sulfate surfactants, sulfonate surfactants, phosphate surfactants, and carboxylate surfactants), cationic surfactants, zwitterionic surfactants, nonpolar surfactants, alkyl glycosides, alkyl polyglycosides, alkyl glucosides, alkyl polyglucosides, alkyl xylosides, alkyl polyxylosides. In some cases, surfactants may be chemically modified by oxidation, reduction, esterification, epimerization, glycosylation, or another chemical modification.

### I. Compositions Having Soluble Oligosaccharides and Insoluble Saccharides

A composition may comprise a soluble oligosaccharide component and an insoluble saccharide component. The soluble oligosaccharide and the insoluble saccharide components described herein may be used to formulate a food product, baked good, or sweetener. The saccharide components may comprise one or more of any type of saccharide. A saccharide may be a monosaccharide. A saccharide may be a disaccharide. A saccharide may be an oligosaccharide. A saccharide may be a polysaccharide. For example, the saccharide component may comprise one or more monosaccharides, di saccharides, oligosaccharides, polysaccharides, any derivatives thereof, or any combination thereof.

### Insoluble Saccharides

In some embodiments, the insoluble saccharide component of the composition may have a DP of at least 20. The insoluble saccharide may have a DP of 20 to 20,000. The insoluble saccharide may have a DP of 40 to 10,000. In some cases, the insoluble saccharide may have a DP of 50 to 5,000. In other cases, the insoluble saccharide may have a DP of 60 to 2,500. The insoluble saccharide may also have a DP of 70 to 2,000. In some cases, the insoluble saccharide may have a DP of 75 to 1,500. In some embodiments, the insoluble saccharide component of the composition may have a DP of 20 to 200. The insoluble saccharide component of the composition may have a DP of 25 to 500. In some cases, the insoluble saccharide may have a DP of 30 to 500. The insoluble saccharide component of the composition may have a DP of 40 to 600. In some cases, the insoluble saccharide may have a DP of 50 to 700. The insoluble saccharide component of the composition may have a DP of 60 to 1,000. In some cases, the insoluble saccharide may have a DP of 70 to 1,500. The insoluble saccharide component of the composition may have a DP of 80 to 2,000. In some cases, the insoluble saccharide may have a DP of 90 to 5,000. The insoluble saccharide component of the composition may have a DP of 100 to 10,000.

The insoluble saccharide component of the composition may comprise partially hydrolyzed biomass. The biomass may comprise grain, grain chaff, bean pods, seed coats, seed materials, seaweeds, corn cob, corn stover, straw, wheat straw, rice straw, soy stalk, bagasse, sugar cane bagasse, miscanthus, sorghum residue, switch grass, bamboo, monocotyledonous tissue, dicotyledonous tissue, fern tissue, water hyacinth, leaf tissue, roots, vegetative matter, vegetable material, vegetable waste, hardwood, hardwood chips, hardwood pulp, softwood, softwood chips, softwood pulp, paper, paper pulp, cardboard, wood-based feedstocks, crab shells, squid biomass, shrimp shells, marine biomass, other suitable feedstocks, or any combination thereof. In some cases, the biomass may be microcrystalline cellulose (MCC). In some cases, the biomass may comprise plant biomass. The plant biomass may comprise corn. The corn for the biomass may comprise corn or maize. The corn for the biomass may comprise corn stover or corn straw. Corn stover may comprise corn leaves, stalks, or cobs. In other cases, the biomass may comprise lignocellulosic biomass. The plant biomass may comprise wood biomass or grass biomass. In some cases, the plant biomass may comprise bamboo, grass, hardwood stem, nut-shell, rice straw, softwood stem, sugar cane bagasse, switch grass, or wheat straw. In various cases, a plant biomass may comprise sugar cane, wheat, sugar beet, switchgrass, miscanthus, poplar, willow, or sweet potato.

The soluble saccharide and the insoluble saccharide may be obtained from the biomass by hydrolysis, including by partial hydrolysis. In some cases, the method may comprise obtaining the soluble saccharide and the insoluble saccharide from the same biomass. In some cases, the method may comprise obtaining the soluble saccharide and the insoluble saccharide from the same biomass and the same hydrolysis reaction. In some cases, the method may comprise obtaining the soluble saccharide in the form of oligosaccharides by hydrolyzing a portion of a plant biomass and may comprise obtaining the insoluble saccharide in the form of the remaining partially hydrolyzed biomass. In some instances, the partial hydrolysis may be an enzyme-based hydrolysis. In some instances, the partial hydrolysis may be an acid-based hydrolysis. In some instances, the partial hydrolysis may be a combination of one or more hydrolysis methods. In general, partial hydrolysis of the biomass may include any form of hydrolysis of acetyl groups from hemicellulose. It may comprise other methods of digesting biomasses and reduce the average degree of polymerization of the biomass.

In some instances, the hydrolysis of the biomass results in the remaining partially hydrolyzed biomass comprising a ratio of cellulose:hemicellulose greater than the corresponding ratio in the unhydrolyzed biomass.

In some instances, the insoluble saccharide component of the composition may comprise lignin, xylan, or a combination thereof. The insoluble saccharide may comprise lignin. The insoluble saccharide may comprise xylan. The insoluble saccharide may comprise mannan. The insoluble saccharide may comprise mixed-linkage glucan. The insoluble saccharide may also comprise pectin. In some cases, the insoluble saccharide may comprise cellulose. In certain cases, the insoluble saccharide may comprise a multimolecular complex of cellulose and hemicellulose. The insoluble saccharide may comprise hemicellulose. Hemicellulose of the composition, in some cases, may comprise xylan, glucuronoxylan, arabinoxylan, arabinoglucuronoxylan, glucomannan, galactoglucomannan, and/or xyloglucan. The insoluble saccharide may also comprise a polyaromatic compound. A polyaromatic compound may comprise lignin. In other cases, the polyaromatic compound may comprise an aromatic ring. In some cases, the insoluble saccharide may comprise various percentages of cellulose, lignin, hemicellulose, and/or pectin by dry wt. %. In some cases, the plant source of the insoluble saccharide may determine the percentages of cellulose, lignin, hemicellulose, or pectin of the insoluble saccharide by dry weight. For example, corn cob biomass can comprise about 45 dry wt. % of cellulose, about 35 dry wt. % hemicellulose, and/or about 15 dry wt. % lignin. In another example, corn stover biomass can comprise about 35 dry wt. % to 40 dry wt. % of cellulose by dry weight, about 21 dry wt. % to 25 dry wt. % hemicellulose, and/or about 11 dry wt. % to 19 dry wt. % lignin. In another example oat hull biomass can comprise about 23 dry wt. % of cellulose, about 32 dry wt. % hemicellulose, and/or about 20 dry wt. % lignin.

The insoluble saccharide component of the composition may comprise fiber. A fiber may comprise a plant fiber. A plant fiber may comprise a plant stem fiber, a plant leaf fiber, or a plant seed-hair fiber. A plant stem fiber, for example, may be derived from the fibrous materials in the inner bark of the plant stem (e.g., a bast fiber). The plant stem fiber may also comprise a wood fiber. Plant fibers may comprise sugar cane, corn, wheat, sugar beet, switchgrass, miscanthus, poplar, willow, sweet potato, cotton, hemp, jute, flax, ramie, sisal, or bagasse.

The insoluble saccharide component of the composition may comprise cellulose at greater than 40% dry w/w. The insoluble saccharide component of the composition may comprise cellulose at greater than 50% dry w/w. The insoluble saccharide component of the composition may comprise cellulose at greater than 60% dry w/w. The insoluble saccharide component of the composition may comprise cellulose at greater than 70% dry w/w. The insoluble saccharide component of the composition may comprise cellulose at greater than 80% dry w/w. The insoluble saccharide component of the composition may comprise cellulose at greater than 90% dry w/w. The insoluble saccharide component of the composition may comprise cellulose at less than 99% dry w/w. The insoluble saccharide component of the composition may comprise cellulose at less than 97.5% dry w/w. The insoluble saccharide component of the composition may comprise cellulose at less than 95% dry w/w. The insoluble saccharide component of the composition may comprise cellulose at less than 94% dry w/w. The insoluble saccharide component of the composition may comprise cellulose at less than 93% dry w/w. The insoluble saccharide component of the composition may comprise cellulose at less than 92% dry w/w. The insoluble saccharide component of the composition may comprise cellulose at less than 91% dry w/w. The insoluble saccharide component of the composition may comprise cellulose at less than 80% dry w/w. The insoluble saccharide component of the composition may comprise cellulose at less than 70% dry w/w.

The insoluble saccharide component of the composition may comprise hemicellulose at greater than 2.5% dry w/w. The insoluble saccharide component of the composition may comprise hemicellulose at greater than 5% dry w/w. The insoluble saccharide component of the composition may comprise hemicellulose at greater than 7.5% dry w/w. The insoluble saccharide component of the composition may comprise hemicellulose at greater than 10% dry w/w. The insoluble saccharide component of the composition may comprise hemicellulose at less than 50% dry w/w. The insoluble saccharide component of the composition may comprise hemicellulose at less than 40% dry w/w. The insoluble saccharide component of the composition may comprise hemicellulose at less than 30% dry w/w. The insoluble saccharide component of the composition may comprise hemicellulose at less than 20% dry w/w. The insoluble saccharide component of the composition may comprise hemicellulose at less than 15% dry w/w.

The insoluble saccharide component of the composition may comprise xylan at greater than 2.5% dry w/w. The insoluble saccharide component of the composition may comprise xylan at greater than 5% dry w/w. The insoluble saccharide component of the composition may comprise xylan at greater than 7.5% dry w/w. The insoluble saccharide component of the composition may comprise xylan at greater than 10% dry w/w. The insoluble saccharide component of the composition may comprise xylan at less than 50% dry w/w. The insoluble saccharide component of the composition may comprise xylan at less than 40% dry w/w. The insoluble saccharide component of the composition may comprise xylan at less than 30% dry w/w. The insoluble saccharide component of the composition may comprise xylan at less than 20% dry w/w. The insoluble saccharide component of the composition may comprise xylan at less than 15% dry w/w.

The insoluble saccharide component of the composition may comprise mannan at greater than 2.5% dry w/w. The insoluble saccharide component of the composition may comprise mannan at greater than 5% dry w/w. The insoluble saccharide component of the composition may comprise mannan at greater than 7.5% dry w/w. The insoluble saccharide component of the composition may comprise mannan at greater than 10% dry w/w. The insoluble saccharide component of the composition may comprise mannan at less than 50% dry w/w. The insoluble saccharide component of the composition may comprise mannan at less than 40% dry w/w. The insoluble saccharide component of the composition may comprise mannan at less than 30% dry w/w. The insoluble saccharide component of the composition may comprise mannan at less than 20% dry w/w. The insoluble saccharide component of the composition may comprise mannan at less than 15% dry w/w.

The insoluble saccharide component of the composition may comprise mixed-linkage glucan at greater than 0.1% dry w/w. The insoluble saccharide component of the composition may comprise mixed-linkage glucan at greater than 0.5% dry w/w. The insoluble saccharide component of the composition may comprise mixed-linkage glucan at greater than 1% dry w/w. The insoluble saccharide component of the composition may comprise mixed-linkage glucan at greater than 10% dry w/w. The insoluble saccharide component of the composition may comprise mixed-linkage glucan at less than 30% dry w/w. The insoluble saccharide component of the composition may comprise mixed-linkage glucan at less than 20% dry w/w. The insoluble saccharide component of the composition may comprise mixed-linkage glucan at less than 17.5% dry w/w. The insoluble saccharide component of the composition may comprise mixed-linkage glucan at less than 15% dry w/w. The insoluble saccharide component of the composition may comprise mixed-linkage glucan at less than 10% dry w/w.

The insoluble saccharide component may be formulated as particles. The insoluble saccharide component may have a average particle size from 20 microns to 500 microns. In some cases, the average particle size of the insoluble saccharide component is from 30 microns to 300 microns. In some cases, the average particle size of the insoluble saccharide component is from 30 microns to 100 microns. In some cases, the average particle size of the insoluble saccharide component is from 30 microns to 50 microns.

The average particle size of the insoluble saccharide component is from 30 microns to 500 microns. The average particle size of the insoluble saccharide component is from at least 30 microns. The average particle size of the insoluble saccharide component is from at most 500 microns. The average particle size of the insoluble saccharide component is from 30 microns to 50 microns, 30 microns to 80 microns, 30 microns to 100 microns, 30 microns to 150 microns, 30 microns to 200 microns, 30 microns to 250 microns, 30 microns to 300 microns, 30 microns to 350 microns, 30 microns to 400 microns, 30 microns to 450 microns, 30 microns to 500 microns, 50 microns to 80 microns, 50 microns to 100 microns, 50 microns to 150 microns, 50 microns to 200 microns, 50 microns to 250 microns, 50 microns to 300 microns, 50 microns to 350 microns, 50 microns to 400 microns, 50 microns to 450 microns, 50 microns to 500 microns, 80 microns to 100 microns, 80 microns to 150 microns, 80 microns to 200 microns, 80 microns to 250 microns, 80 microns to 300 microns, 80 microns to 350 microns, 80 microns to 400 microns, 80 microns to 450 microns, 80 microns to 500 microns, 100 microns to 150 microns, 100 microns to 200 microns, 100 microns to 250 microns, 100 microns to 300 microns, 100 microns to 350 microns, 100 microns to 400 microns, 100 microns to 450 microns, 100 microns to 500 microns, 150 microns to 200 microns, 150 microns to 250 microns, 150 microns to 300 microns, 150 microns to 350 microns, 150 microns to 400 microns, 150 microns to 450 microns, 150 microns to 500 microns, 200 microns to 250 microns, 200 microns to 300 microns, 200 microns to 350 microns, 200 microns to 400 microns, 200 microns to 450 microns, 200 microns to 500 microns, 250 microns to 300 microns, 250 microns to 350 microns, 250 microns to 400 microns, 250 microns to 450 microns, 250 microns to 500 microns, 300 microns to 350 microns, 300 microns to 400 microns, 300 microns to 450 microns, 300 microns to 500 microns, 350 microns to 400 microns, 350 microns to 450 microns, 350 microns to 500 microns, 400 microns to 450 microns, 400 microns to 500 microns, or 450 microns to 500 microns. In some cases, the average particle size of the insoluble saccharide component is equal to or greater than 30 microns, 50 microns, 80 microns, 100 microns, 150 microns, 200 microns, 250 microns, 300 microns, 350 microns, 400 microns, 450 microns, or 500 microns.

A consumable composition such as a food product or a baked good comprising the insoluble saccharide component may comprise non-enzymatic breakdown products, such as deoxyosone, an osulose, a furan-2-aldehyde, a 2-carbon alpha-dicarbonyl compound, a 2-carbon hydroxycarbonyl compound, a 3-carbon alpha-di carb onyl compound, a 3-carbon hydroxycarbonyl compound, a 4-carbon alpha-dicarbonyl compound, a 4-carbon hydroxycarbonyl compound, a pyrazine, a glycoxal, a glycolaldehyde, a glycosylamine, a deoxyglycosyl amino acid, a deoxyglycosyl peptide, 2-oxopropanal, glyoxal, 3-deoxy-2-hexosulose, glycolaldehyde, 2-oxopropanal, 2-hexosulose, butane-2,3-dione, hydroxy-2-propanone, 2-hydroxy-3-butanone, 5-(hydroxymethyl)furan-2-carboxaldehyde, 3-deoxy-2-pentosulose, 2-xylosulose, furan-2-carboxaldehyde, 2-glucosulose, 2-hydroxy-3-butanone, hydroxy-2-propanone, a caramelan, a caramelen, a caramelin, a volatile compound, a diacetyl, alpha pinene, tetrahydrolinalool, dihydromyrcenol, furfural, menthone, isomenthone, linalool, menthyl acetate, neomenthol, caryophyllene, Isomenthol, menthol, Phenylacetaldehyde, Pulegone, 4-t-butylcyclohexyl acetate, Carvone, dihydroxybenzaldehyde isomer, anethole, guaiacol, verdyl acetate, 2-phenylethyl alcohol, beta ionone, diphenyl ether, phenolicmethoxybenzaldehyde isomer, Thymol, vinyl guaiacol, hexyl salicylate, Myristicin, isoeugenol, alpha hexylcinnamaldehyde, vinyl phenol, vanillin, hexadecanoic acid, or a combination thereof.

### Soluble Oligosaccharides

In some embodiments, the soluble oligosaccharide of the composition may have a degree of polymerization (DP) of 2 to 20. The soluble oligosaccharide may have a DP of 2 to 15. The soluble oligosaccharide may have a DP of 2 to 10. In some cases, the soluble oligosaccharide may have a DP of 2 to 5. In other cases, the soluble oligosaccharide may have a DP of 3 to 20. The soluble oligosaccharide may also have a DP of 3 to 15. In some cases, the soluble oligosaccharide may have a DP of 3 to 10. The soluble oligosaccharide of the composition may have a DP of 4 to 20. In some cases, the soluble oligosaccharide may have a DP of 5 to 20. The soluble oligosaccharide of the composition may have a DP of 6 to 20. In some cases, the soluble oligosaccharide may have a DP of 7 to 20. The soluble oligosaccharide of the composition may have a DP of 8 to 20. In some cases, the soluble oligosaccharide may have a DP of 9 to 20. The soluble oligosaccharide of the composition may have a DP of 10 to 20.

The soluble saccharide of the composition may comprise partially hydrolyzed biomass. The biomass may comprise grain, grain chaff, bean pods, seed coats, seed materials, seaweeds, corn cob, corn stover, straw, wheat straw, rice straw, soy stalk, bagasse, sugar cane bagasse, miscanthus, sorghum residue, switch grass, bamboo, monocotyledonous tissue, dicotyledonous tissue, fern tissue, water hyacinth, leaf tissue, roots, vegetative matter, vegetable material, vegetable waste, hardwood, hardwood chips, hardwood pulp, softwood, softwood chips, softwood pulp, paper, paper pulp, cardboard, wood-based feedstocks, crab shells, squid biomass, shrimp shells, marine biomass, other suitable feedstocks, or any combination thereof. In some cases, the biomass may comprise plant biomass. The plant biomass may comprise corn. The corn for the biomass may comprise corn stover or corn straw. Corn stover may comprise corn leaves, stalks, or cobs. In other cases, the biomass may comprise lignocellulosic biomass. The plant biomass may comprise wood biomass or grass biomass. In some cases, the plant biomass may comprise bamboo, grass, hardwood stem, nut shell, rice straw, softwood stem, sugar cane bagasse, switch grass, or wheat straw. In various cases, a plant biomass may comprise sugar cane, wheat, sugar beet, switchgrass, miscanthus, poplar, willow, or sweet potato.

The soluble saccharide and the insoluble saccharide may be obtained from the biomass by hydrolysis, including by partial hydrolysis. In some cases, the method may comprise obtaining the soluble saccharide and the insoluble saccharide from the same biomass. In some cases, the method may comprise obtaining the soluble saccharide and the insoluble saccharide from the same biomass and the same hydrolysis reaction. In some cases, the method may comprise obtaining the soluble saccharide in the form of oligosaccharides by partial hydrolysis of a plant biomass and may comprise obtaining the insoluble saccharide in the form of the remaining undigested biomass.

The soluble oligosaccharide of the composition may comprise at least one of a: (i) cello-oligosaccharide; (ii) xylo-oligosaccharide; or (iii) mannan-oligosaccharide. In some cases, the soluble oligosaccharide of the composition may comprise at least two of a: (i) cello-oligosaccharide; (ii) xylo-oligosaccharide; or (iii) mannan-oligosaccharide. For example, the soluble oligosaccharide of the composition may include a cello-oligosaccharide and a xylo-oligosaccharide but lack a mannan-oligosaccharide. In other cases, the soluble oligosaccharide may comprise a cello-oligosaccharide, a xylo-oligosaccharide, and a mannan-oligosaccharide. The soluble oligosaccharide may comprise a cello-oligosaccharide and a xylo-oligosaccharide. The soluble oligosaccharide may comprise a cello-oligosaccharide and a mannan-oligosaccharide. The soluble oligosaccharide may comprise a xylo-oligosaccharide and a mannan-oligosaccharide.

The soluble oligosaccharide of the composition may comprise a cello-oligosaccharide and a xylo-oligosaccharide. In certain instances, the weight ratio of the cello-oligosaccharide to the xylo-oligosaccharide may be 2:98 to 50:50, 5:95 to 40:60, 7.5:92.5 to 30:70, or 10:90 to 25:75. In some cases, the weight ratio of the cello-oligosaccharide to the xylo-oligosaccharide may be 2:98 to 50:50. In certain cases, the weight ratio of the cello-oligosaccharide to the xylo-oligosaccharide may be 5:95 to 40:60. In various cases, the weight ratio of the cello-oligosaccharide to the xylo-oligosaccharide may be 7.5:92.5 to 30:70. In some cases, the weight ratio of the cello-oligosaccharide to the xylo-oligosaccharide may be 10:90 to 25:75. In certain embodiments, the weight ratio of the cello-oligosaccharide to the xylo-oligosaccharide may be 10:90 to 25:75, 12.5:87.5 to 20:80, 15:85 to 15:85, 17.5:82.5 to 10:90, or 20:80 to 5:95.

The soluble oligosaccharide of the composition may comprise a cello-oligosaccharide and a mannan-oligosaccharide, the weight ratio of the cello-oligosaccharide to the mannan-oligosaccharide may be 2:98 to 50:50, 5:95 to 40:60, 7.5:92.5 to 30:70, or 10:90 to 25:75. In some cases, the weight ratio of the cello-oligosaccharide to the mannan-oligosaccharide may be 2:98 to 50:50. In some cases, the weight ratio of the cello-oligosaccharide to the mannan-oligosaccharide may be 5:95 to 40:60. In some cases, the weight ratio of the cello-oligosaccharide to the mannan-oligosaccharide may be 7.5:92.5 to 30:70. In some cases, the weight ratio of the cello-oligosaccharide to the mannan-oligosaccharide may be 10:90 to 25:75. In some embodiments, the weight ratio of the cello-oligosaccharide to the mannan-oligosaccharide may be 10:90 to 25:75, 12.5:87.5 to 20:80, 15:85 to 15:85, 17.5:82.5 to 10:90, or 20:80 to 5:95.

In some embodiments, the cello-oligosaccharide of the composition may have a DP of 2 to 6. The cello-oligosaccharide may have a DP of 2 to 9. The cello-oligosaccharide may have a DP of 2 to 8. The cello-oligosaccharide may have a DP of 2 to 7. The cello-oligosaccharide may have a DP of 2 to 5. The cello-oligosaccharide may have a DP of 2 to 4. The cello-oligosaccharide may have a DP of 2. The cello-oligosaccharide may have a DP of 3. The cello-oligosaccharide may have a DP of 4. The cello-oligosaccharide may have a DP of 5. The cello-oligosaccharide may have a DP of 6. The cello-oligosaccharide may also have a degree of 2 to 20, 2 to 19, 2 to 18, 2 to 17, 2 to 16, 2 to 15, 2 to 14, 2 to 13, 2 to 12, 2 to 11, or 2 to 10.

In some embodiments, a sweetener composition may comprise cello-oligosaccharides. The sweetener composition may comprise from 5% to 20% w/w cello-oligosaccharides. The sweetener composition may comprise from at least 5% w/w cello-oligosaccharides. The sweetener composition may comprise from at most 20% w/w cello-oligosaccharides. The sweetener composition may comprise from 5% to 10%, 5% to 15%, 5% to 20%, 10% to 15%, 10% to 20%, or 15% to 20% w/w cello-oligosaccharides. The sweetener composition may comprise from 5%, 10%, 15%, or 20% w/w cello-oligosaccharides.

The cello-oligosaccharide may include a combination of cello-oligosaccharides having different degrees of polymerization. In certain embodiments, the cello-oligosaccharide may comprise two or more of a cello-oligosaccharide having a DP of 2, 3, 4, 5, and 6. In some embodiments, the cello-oligosaccharide may comprise 2 or more of a cello-oligosaccharide having a DP of 2, 3, 4, 5, 6, 7, 8, 9, 10, 11, 12, 13, 14, 15, 16, 17, 18, 19, and 20. For example, the cello-oligosaccharide may comprise a cello-oligosaccharide having a DP of 2, a cello-oligosaccharide having a DP of 3, and a cello-oligosaccharide having a DP of 4.

The cello-oligosaccharide of the composition may comprise greater than 30%, 40%, 50%, 60%, or 70% cellobiose. In some cases, the cello-oligosaccharide may comprise greater than 30% cellobiose. In some cases, the cello-oligosaccharide may comprise greater than 40% cellobiose. In some cases, the cello-oligosaccharide may comprise greater than 50% cellobiose. In some cases, the cello-oligosaccharide may comprise greater than 60% cellobiose. In some cases, the cello-oligosaccharide may comprise greater than 70% cellobiose.

The cello-oligosaccharide of the composition may comprise less than 10%, 5%, or 1% cellotriose. In some cases, the cello-oligosaccharide may comprise less than 10% cellotriose. In some cases, the cello-oligosaccharide may comprise less than 5% cellotriose. In some cases, the cello-oligosaccharide may comprise less than 1% cellotriose. In some embodiments, the cello-oligosaccharide may comprise less than 9%, 8%, 7%, 6%, 5%, 4%, 3%, or 2% cellotriose.

The cello-oligosaccharide of the composition may comprise less than 15%, 10%, or 5% cellotetraose. In some cases, the cello-oligosaccharide may comprise less than 15% cellotetraose. In some cases, the cello-oligosaccharide may comprise less than 10% cellotetraose. In some cases, the cello-oligosaccharide may comprise less than 5% cellotetraose. In some embodiments, the cello-oligosaccharide may comprise less than 14%, 13%, 12%, 11%, 10%, 9%, 8%, 7%, or 6% cellotetraose.

In some embodiments, the xylo-oligosaccharide of the composition may have a DP of 2 to 12. The xylo-oligosaccharide may have a DP of 2 to 11. The xylo-oligosaccharide may have a DP of 2 to 10. The xylo-oligosaccharide may have a DP of 2 to 9. The xylo-oligosaccharide may have a DP of 2 to 8. The xylo-oligosaccharide may have a DP of 2 to 7. The xylo-oligosaccharide may have a DP of 2 to 6. The xylo-oligosaccharide may have a DP of 2 to 5. The xylo-oligosaccharide may have a DP of 2 to 4. The xylo-oligosaccharide may have a DP of 2 to 3. The xylo-oligosaccharide may have a DP of 2. The xylo-oligosaccharide may have a DP of 3. The xylo-oligosaccharide may have a DP of 4. The xylo-oligosaccharide may have a DP of 5. The xylo-oligosaccharide may have a DP of 6. The xylo-oligosaccharide may have a DP of 7. The xylo-oligosaccharide may have a DP of 8. The xylo-oligosaccharide may have a DP of 9. The xylo-oligosaccharide may have a DP of 10. The xylo-oligosaccharide may have a DP of 11. The xylo-oligosaccharide may also have a DP of 2 to 20, 2 to 19, 2 to 18, 2 to 17, 2 to 16, 2 to 15, 2 to 14, or 2 to 13.

The xylo-oligosaccharide may include a combination of xylo-oligosaccharides having different degrees of polymerization. In certain embodiments, the xylo-oligosaccharide may comprise two or more of a xylo-oligosaccharide having a DP of 2, 3, 4, 5, 6, 7, 8, 9, 10, 11, and 12. In some embodiments, the xylo-oligosaccharide may comprise 2 or more of a xylo-oligosaccharide having a DP of 2, 3, 4, 5, 6, 7, 8, 9, 10, 11, 12, 13, 14, 15, 16, 17, 18, 19, and 20. For example, the xylo-oligosaccharide may comprise a xylo-oligosaccharide having a DP of 2, a xylo-oligosaccharide having a DP of 3, a xylo-oligosaccharide having a DP of 4, a xylo-oligosaccharide having a DP of 5, a xylo-oligosaccharide having a DP of 6, and a xylo-oligosaccharide having a DP of 7.

In some embodiments, a sweetener composition may comprise xylo-oligosaccharides. The sweetener composition may comprise from 40% to 80% w/w xylo-oligosaccharides. The sweetener composition may comprise from 50% to 70% w/w xylo-oligosaccharides. The sweetener composition may comprise from 50% to 80% w/w xylo-oligosaccharides. The sweetener composition may comprise from at least 50% w/w xylo-oligosaccharides. The sweetener composition may comprise from at most 80% w/w xylo-oligosaccharides. The sweetener composition may comprise from 50% to 60%, 50% to 70%, 50% to 80%, 60% to 70%, 60% to 80%, or 70% to 80% w/w xylo-oligosaccharides. The sweetener composition may comprise from 50%, 60%, 70%, or 80% w/w xylo-oligosaccharides.

The xylo-oligosaccharide of the composition may comprise less than 70%, 60%, or 50% xylobiose. In some cases, the xylo-oligosaccharide may comprise less than 70% xylobiose. In some cases, the xylo-oligosaccharide may comprise less than 60% xylobiose. In some cases, the xylo-oligosaccharide may comprise less than 50% xylobiose. In some embodiments, the xylo-oligosaccharide may comprise less than 69%, 68%, 67%, 65%, 64%, 63%, 62%, 61%, 60%, 59%, 58%, 57%, 56%, 55%, 54%, 53%, 52%, or 51% xylobiose. The xylo-oligosaccharide may comprise less than 45%, 40%, 35%, or 30% xylobiose.

The xylo-oligosaccharide of the composition may comprise less than 60%, 50%, or 40% xylotriose. In some cases, the xylo-oligosaccharide may comprise less than 60% xylotriose. In some cases, the xylo-oligosaccharide may comprise less than 50% xylotriose. In some cases, the xylo-oligosaccharide may comprise less than 40% xylotriose. In some embodiments, the xylo-oligosaccharide may comprise less than 59%, 58%, 57%, 56%, 55%, 54%, 53%, 52%, 51%, 40%, 49%, 48%, 47%, 46%, 44%, 44%, 43%, 42%, or 41% xylotriose. The xylo-oligosaccharide may comprise less than 35%, 30%, 25%, or 20% xylotriose.

The xylo-oligosaccharide of the composition may comprise less than 50%, 40%, or 30% xylotetraose. In some cases, the xylo-oligosaccharide may comprise less than 50% xylotetraose. In some cases, the xylo-oligosaccharide may comprise less than 40% xylotetraose. In some cases, the xylo-oligosaccharide may comprise less than 30% xylotetraose. In some embodiments, the xylo-oligosaccharide may comprise less than 49%, 48%, 47%, 46%, 45%, 44%, 43%, 42%, 41%, 40%, 39%, 38%, 37%, 36%, 35%, 34%, 33%, 32%, or 31% xylotetraose. The xylo-oligosaccharide may comprise less than 25%, 20%, 15%, or 10% xylotetraose.

The xylo-oligosaccharide may comprise at least 10% substituted xylo-oligosaccharide.

In some embodiments, the mannan-oligosaccharide of the composition may have a DP of 2 to 12. The mannan-oligosaccharide may have a DP of 2 to 11. The mannan-oligosaccharide may have a DP of 2 to 10. The mannan-oligosaccharide may have a DP of 2 to 9. The mannan-oligosaccharide may have a DP of 2 to 8. The mannan-oligosaccharide may have a DP of 2 to 7. The mannan-oligosaccharide may have a DP of 2 to 6. The mannan-oligosaccharide may have a DP of 2 to 5. The mannan-oligosaccharide may have a DP of 2 to 4. The mannan-oligosaccharide may have a DP of 2 to 3. The mannan-oligosaccharide may have a DP of 2. The mannan-oligosaccharide may have a DP of 3. The mannan-oligosaccharide may have a DP of 4. The mannan-oligosaccharide may have a DP of 5. The mannan-oligosaccharide may have a DP of 6. The mannan-oligosaccharide may have a DP of 7. The mannan-oligosaccharide may have a DP of eight. The mannan-oligosaccharide may have a DP of 9. The mannan-oligosaccharide may have a DP of 10. The mannan-oligosaccharide may have a DP of 11. The mannan-oligosaccharide may also have a degree of 2 to 20, 2 to 19, 2 to 18, 2 to 17, 2 to 16, 2 to 15, 2 to 14, or 2 to 13.

The mannan-oligosaccharide may include a combination of mannan-oligosaccharides having different degrees of polymerization. In certain embodiments, the mannan-oligosaccharide may comprise two or more of a mannan-oligosaccharide having a DP of 2, 3, 4, 5, 6, 7, 8, 9, 10, 11, and 12. In some embodiments, the mannan-oligosaccharide may comprise two or more of a mannan-oligosaccharide having a DP of 2, 3, 4, 5, 6, 7, 8, 9, 10, 11, 12, 13, 14, 15, 16, 17, 18, 19, and 20. For example, the mannan-oligosaccharide may comprise a mannan-oligosaccharide having a DP of 2, a mannan-oligosaccharide having a DP of 3, a mannan-oligosaccharide having a DP of 4, a mannan-oligosaccharide having a DP of 5, a mannan-oligosaccharide having a DP of 6, and a mannan-oligosaccharide having a DP of 7.

In some embodiments, the mannan-oligosaccharide of the composition may comprise less 70%, 60%, or 50% of a mannan-oligosaccharide having a DP of 2. The mannan-oligosaccharide may comprise less 70% of a mannan-oligosaccharide having a DP of 2. The mannan-oligosaccharide may comprise less 60% of a mannan-oligosaccharide having a DP of 2. The mannan-oligosaccharide may comprise less 50% of a mannan-oligosaccharide having a DP of 2. The mannan-oligosaccharide may comprise less than 69%, 68%, 67%, 66%, 65%, 64%, 63%, 62%, 61%, 60%, 59%, 58%, 57%, 56%, 55%, 54%, 53%, 52%, or 51% of a mannan-oligosaccharide having a DP of 2. The mannan-oligosaccharide may comprise less than 45%, 40%, 35%, or 30% of a mannan-oligosaccharide having a DP of 2.

In some embodiments, the mannan-oligosaccharide of the composition may comprise less 60%, 50%, or 40% of a mannan-oligosaccharide having a DP of 3. The mannan-oligosaccharide may comprise less 60% of a mannan-oligosaccharide having a DP of 3. The mannan-oligosaccharide may comprise less 50% of a mannan-oligosaccharide having a DP of 3. The mannan-oligosaccharide may comprise less 40% of a mannan-oligosaccharide having a DP of 3. The mannan-oligosaccharide may comprise less than 59%, 58%, 57%, 56%, 55%, 54%, 53%, 52%, 51%, 50%, 49%, 48%, 47%, 46%, 45%, 44%, 43%, 42%, or 41% of a mannan-oligosaccharide having a DP of 3. The mannan-oligosaccharide may comprise less than 35%, 30%, 25%, or 20% of a mannan-oligosaccharide having a DP of 3.

In some embodiments, the mannan-oligosaccharide of the composition may comprise less 50%, 40%, or 30% of a mannan-oligosaccharide having a DP of 4. The mannan-oligosaccharide may comprise less 50% of a mannan-oligosaccharide having a DP of 4. The mannan-oligosaccharide may comprise less 40% of a mannan-oligosaccharide having a DP of 4. The mannan-oligosaccharide may comprise less 30% of a mannan-oligosaccharide having a DP of 4. The mannan-oligosaccharide may comprise less than 49%, 48%, 47%, 46%, 45%, 44%, 43%, 42%, 41%, 40%, 39%, 38%, 37%, 36%, 35%, 34%, 33%, 32%, or 31% of a mannan-oligosaccharide having a DP of 4. The mannan-oligosaccharide may comprise less than 35%, 30%, 25%, or 20% of a mannan-oligosaccharide having a DP of 4.

In some embodiments, a sweetener composition may comprise mannan-oligosaccharides. The sweetener composition may comprise from 40% to 80% w/w mannan-oligosaccharides. The sweetener composition may comprise from 50% to 70% w/w mannan-oligosaccharides. The sweetener composition may comprise from 50% to 80% w/w mannan-oligosaccharides. The sweetener composition may comprise from at least 50% w/w mannan-oligosaccharides. The sweetener composition may comprise from at most 80% w/w mannan-oligosaccharides. The sweetener composition may comprise from 50% to 60%, 50% to 70%, 50% to 80%, 60% to 70%, 60% to 80%, or 70% to 80% w/w mannan-oligosaccharides. The sweetener composition may comprise from 50%, 60%, 70%, or 80% w/w mannan-oligosaccharides.

The mannan-oligosaccharide may comprise at least 5% substituted mannan-oligosaccharide. In some cases, the composition may include galactomannan trisaccharides, tetrasaccharides and pentasaccharides. In some cases, the composition may include Man-β-1,4-(Gal-α-1,6-)Man-β-1,4-Man, Glc-β-1,4-(Gal-α-1,6-)Man-β-1,4-Man, Man-β-1,4-(Gal -α-1,6-)Glc-β-1,4-Man, Man-β-1,4-(Gal-α-1,6-)Man-β-1,4-Glc, Man-β-1,4-(Gal-α-1,6-)Glc-β-1,4-Glc, Glc-β-1,4-(Gal-α-1,6-)Man-β-1,4-Glc, Glc-β-1,4-(Gal-α-1,6-)Glc-β-1,4-Man, Gal-α-1,6-Man-β-1,4-Man-β-1,4-Man-β-1,4-Man, Man-β-1,4-(Gal-α-1,6-)Man-β-1,4-Man-β-1,4-Man, Man-β-1,4-Man-β-1,4-(Gal-α-1,6-)Man-β-1,4-Man, Man-β-1,4-Man-β-1,4-Man-β-1,4-(Gal-α-1,6-)Man, Gal-α-1,6-Glc-β-1,4-Man-β-1,4-Man-β-1,4-Man, Glc-β-1,4-(Gal-α-1,6-)Man-β-1,4-Man-β-1,4-Man, Glc-β-1,4-Man-β-1,4-(Gal-α-1,6-)Man-β-1,4-Man, Glc-β-1,4-Man-β-1,4-Man-β-1,4-(Gal-α-1,6-)Man, Gal-α-1,6-Man-β-1,4-Man-β-1,4-Man-β-1,4-Glc, Man-β-1,4-(Gal-α-1,6-)Man-β-1,4-Man-β-1,4-Glc, Man-β-1,4-Man-β-1,4-(Gal-α-1,6-)Man-β-1,4-Glc, Man-β-1,4-Man-β-1,4-Man-β-1,4-(Gal-α-1,6-)Glc,

In some cases, the composition may comprise less than 30 dry wt. %, 20 dry wt. %, or 10 dry wt. % of monosaccharide. The composition may comprise less than 30 dry wt. % of monosaccharide. The composition may comprise less than 20 dry wt. % of monosaccharide. The composition may comprise less than 10 dry wt. % of monosaccharide. In some cases, the composition may comprise less than 20 dry wt. %, 10 dry wt. %, 5 dry wt. %, 4 dry wt. %, 3 dry wt. %, 2 dry wt. %, or 1 dry wt. % of monosaccharide. The composition may comprise less than 5 dry wt. % of monosaccharide. The composition may comprise less than 4 dry wt. % of monosaccharide. The composition may comprise less than 3 dry wt. % of monosaccharide. The composition may comprise less than 2 dry wt. % of monosaccharide. The composition may comprise less than 1 dry wt. % of monosaccharide. The composition may comprise less than 29 dry wt. %, 28 dry wt. % 27 dry wt. %, 26 dry wt. %, 25 dry wt. %, 24 dry wt. %, 23 dry wt. %, 22 dry wt. %, 21 dry wt. %, 19 dry wt. %, 18 dry wt. %, 17 dry wt. %, 16 dry wt. %, 15 dry wt. %, 14 dry wt. %, 13 dry wt. %, 12 dry wt. %, 11 dry wt. %, 9 dry wt. %, 8 dry wt. %, 7 dry wt. %, or 6 dry wt. % of monosaccharide.

In some cases, the composition may comprise less than 70 dry wt. %, 60 dry wt. %, 50 dry wt. %, 40 dry wt. %, 30 dry wt. % of monosaccharide and disaccharides. The composition may comprise less than 70 dry wt. % of monosaccharide and disaccharides. The composition may comprise less than 60 dry wt. % of monosaccharide and disaccharides. The composition may comprise less than 50 dry wt. % of monosaccharide and disaccharides. The composition may comprise less than 40 dry wt. % of monosaccharide and disaccharides. The composition may comprise less than 30 dry wt. % of monosaccharide and disaccharides. The composition may also comprise less than 69 dry wt. %, 68 dry wt. %, 67 dry wt. %, 66 dry wt. %, 65 dry wt. %, 64 dry wt. %, 63 dry wt. %, 62 dry wt. %, 61 dry wt. %, 59 dry wt. %, 58 dry wt. %, 57 dry wt. %, 56 dry wt. %, 55 dry wt. %, 54 dry wt. %, 53 dry wt. %, 52 dry wt. %, 51 dry wt. %, 49 dry wt. %, 48 dry wt. %, 47 dry wt. %, 46 dry wt. %, 45 dry wt. %, 44 dry wt. %, 43 dry wt. %, 42 dry wt. %, 41 dry wt. %, 39 dry wt. %, 38 dry wt. %, 37 dry wt. %, 36 dry wt. %, 35 dry wt. %, 34 dry wt. %, 33 dry wt. %, 32 dry wt. %, or 31 dry wt. % of monosaccharide and disaccharides. Preferably, the composition comprises less than 30% dry wt. % of monosaccharides and disaccharides.

In some cases, the composition may comprise at least 20 dry wt. % of monosaccharide. The composition may comprise at least 10 dry wt. % of monosaccharide. In some cases, the composition may comprise at least 5 dry wt. %, 4 dry wt. %, 3 dry wt. %, 2 dry wt. %, or 1 dry wt. % of monosaccharide. The composition may comprise at least 5 dry wt. % of monosaccharide. The composition may comprise at least 4 dry wt. % of monosaccharide. The composition may comprise at least 3 dry wt. % of monosaccharide. The composition may comprise at least 2 dry wt. % of monosaccharide. The composition may comprise at least 1 dry wt. % of monosaccharide.

In certain cases, the composition may comprise 10 dry wt. % to 30 dry wt. %, 10 dry wt. % to 20 dry wt. %, or 5 dry wt. % to 10 dry wt. % of monosaccharide. In some cases, the composition may comprise 5 dry wt. % to 20 dry wt. %, 5 dry wt. % to 10 dry wt. %, 1 dry wt. % to 5 dry wt. %, 1 dry wt. % to 4 dry wt. %, 1 dry wt. % to 3 or 1 dry wt. % to 2 dry wt. % of monosaccharide.

### Combinations of Soluble Oligosaccharides and Insoluble Saccharides

The composition may comprise various soluble oligosaccharides. The composition may include the soluble oligosaccharides at varying amounts, for example, depending on the desired properties of the composition. In some instances, the composition may comprise at least 50 dry wt. % soluble oligosaccharide having a DP of from 3 to 20, insoluble saccharide having a DP of at least 20, and the weight ratio of the insoluble saccharide to the soluble oligosaccharide may be 1:99 to 50:50.

In some cases, the composition may comprise at least 50 dry wt. % a soluble oligosaccharide having a DP of from 3 to 20; an insoluble saccharide having a DP of at least 20; and the weight ratio of the insoluble saccharide to the soluble oligosaccharide may be 2:98 to 30:70. In some cases, the composition may comprise at least 50 dry wt. % a soluble oligosaccharide having a DP of from 3 to 20; an insoluble saccharide having a DP of at least 20; and the weight ratio of the insoluble saccharide to the soluble oligosaccharide may be 3:97 to 25:75. In some cases, the composition may comprise at least 50 dry wt. % a soluble oligosaccharide having a DP of from 3 to 20; an insoluble saccharide having a DP of at least 20; and the weight ratio of the insoluble saccharide to the soluble oligosaccharide may be 4:96 to 20:80. In some cases, the composition may comprise at least 50 dry wt. % a soluble oligosaccharide having a DP of from 3 to 20; an insoluble saccharide having a DP of at least 20; and the weight ratio of the insoluble saccharide to the soluble oligosaccharide may be 5:95 to 17.5:82.5. The composition may also comprise at least 50 dry wt. % a soluble oligosaccharide having a DP of from 3 to 20; an insoluble saccharide having a DP of at least 20; and the weight ratio of the insoluble saccharide to the soluble oligosaccharide may be 2:98 to 30:70, 3:97 to 25:75, 4:96 to 20:80, 5:95 to 17.5:82.5, 6:94 to 15:85, 7:93 to 12.5:87.5, 8:92 to 10:90, 9:91 to 7.5:92.5, 10:90 to 5:95, 11:89 to 2.5:97.5, 12:88 to 2:98, 13:87 to 1.5:98.5, 14:86 to 1:99, or 15:85 to 0.5:99.5.

The composition may comprise at least 50 dry wt. % soluble oligosaccharides and at least 90 dry wt. %, 95 dry wt. %, 96 dry wt. %, 97 dry wt. %, 98 dry wt. %, 99 dry wt. %, or 100 dry wt. % of the soluble oligosaccharide having a DP of 3 to 20; an insoluble saccharide having a DP of at least 20; and the weight ratio of the insoluble saccharide to the soluble oligosaccharide may be 1:99 to 50:50. The composition may comprise at least 50 dry wt. % soluble oligosaccharide and at least 90 dry wt. % of the soluble oligosaccharide may have a DP of 3 to 20; an insoluble saccharide having a DP of at least 20; and the weight ratio of the insoluble saccharide to the soluble oligosaccharide may be 1:99 to 50:50. The composition may comprise at least 50 dry wt. % soluble oligosaccharide and at least 95 dry wt. % of the soluble oligosaccharide may have a DP of 3 to 20; an insoluble saccharide having a DP of at least 20; and the weight ratio of the insoluble saccharide to the soluble oligosaccharide may be 1:99 to 50:50. The composition may comprise at least 50 dry wt. % soluble oligosaccharide and at least 96 dry wt. % of the soluble oligosaccharide may have a DP of 3 to 20; an insoluble saccharide having a DP of at least 20; and the weight ratio of the insoluble saccharide to the soluble oligosaccharide may be 1:99 to 50:50. The composition may comprise at least 50 dry wt. %, soluble oligosaccharide and at least 97 dry wt. % of the soluble oligosaccharide may have a DP of 3 to 20; an insoluble saccharide having a DP of from at least 20; and the weight ratio of the insoluble saccharide to the soluble oligosaccharide may be 1:99 to 50:50. The composition may comprise at least 50 dry wt. % soluble oligosaccharide and at least 98 dry wt. % of the soluble oligosaccharide may have a DP from 3 to 20; an insoluble saccharide having a DP of at least 20; and the weight ratio of the insoluble saccharide to the soluble oligosaccharide may be 1:99 to 50:50. The composition may comprise at least 50 dry wt. % soluble oligosaccharide and at least 99 dry wt. % of the soluble oligosaccharide may have a DP of 3 to 20; an insoluble saccharide having a DP of at least 20; and the weight ratio of the insoluble saccharide to the soluble oligosaccharide may be 1:99 to 50:50. The composition may comprise at least 50 dry wt. % soluble oligosaccharide and at least 100 dry wt. % of the soluble oligosaccharide may have a DP of 3 to 20; an insoluble saccharide having a DP of at least 20; and the weight ratio of the insoluble saccharide to the soluble oligosaccharide may be 1:99 to 50:50. The composition may comprise at least 50 dry wt. % soluble oligosaccharide and at least 50 dry wt. %, 55 dry wt. %, 60 dry wt. %, 65 dry wt. %, 70 dry wt. %, 75 dry wt. %, 80 dry wt. %, or 85 dry wt. % of the soluble oligosaccharide may have a DP of 3 to 20; an insoluble saccharide having a DP of at least 20; and the weight ratio of the insoluble saccharide to the soluble oligosaccharide may be 1:99 to 50:50.

In some cases, the soluble oligosaccharide and the insoluble saccharide may be in a combined amount of at least 50 dry wt. % of the total amount of the composition. In various cases, the soluble oligosaccharide and the insoluble saccharide may be in a combined amount of at least 15 dry wt. %, at least 20 dry wt. %, at least 25 dry wt. %, at least 30 dry wt. %, at least 35 dry wt. %, at least 40 dry wt. %, at least 45 dry wt. %, at least 55 dry wt. %, at least 60 dry wt. %, at least 65 dry wt. %, at least 70 dry wt. %, at least 75 dry wt. %, or at least 80 dry wt. % of the total amount of the composition.

The composition may be a consumable composition. A consumable composition may be an edible composition. In some cases, the composition may be ingested by a subject (e.g., a human). In some cases, the subject is may be a human. The subject may be a mammal. The subject may be any suitable animal.

The composition may be a sweetener. In some cases, the composition may be a fibrous sweetener. A sweetener, in some instances, may also be a bulking agent. A sweetener, in some instances, may also be a sweetening agent. A sweetener, when ingested by a subject, may provide a sensation of sweetness to the subject. The sweetener may substitute sugar. The sweetener may provide no calories. In various cases, the sweetener may provide a minimal number of calories. In some cases, the sweetener may provide at least about 10%, 20%, 30%, 40%, 50%, 60%, 70%, 80%, or 90% fewer calories than sugar (e.g., table sugar or sucrose).

A sweetener composition may be a mixture of a soluble oligosaccharide component and insoluble saccharide component. The soluble oligosaccharide component and the insoluble saccharide component may form 100% of the sweetener composition. The sweetener composition may comprise from 50% to 90% of the soluble oligosaccharide component w/w. The sweetener composition may comprise from 70% to 90% of the soluble oligosaccharide component w/w. The sweetener composition may comprise from 50% to 90% of the soluble oligosaccharide component w/w. The sweetener composition may comprise from at least 50% of the soluble oligosaccharide component w/w. The sweetener composition may comprise from at most 90% of the soluble oligosaccharide component w/w. The sweetener composition may comprise from 50% to 60%, 50% to 70%, 50% to 80%, 50% to 90%, 60% to 70%, 60% to 80%, 60% to 90%, 70% to 80%, 70% to 90%, or 80% to 90% of the soluble oligosaccharide component w/w. The sweetener composition may comprise from 50%, 60%, 70%, 80%, or 90% of the soluble oligosaccharide component w/w. It should be understood that in this case where the sweetener composition comprises only the soluble oligosaccharide component and the insoluble saccharide component; the remainder of the sweetener composition (excluding the soluble oligosaccharide component) is the insoluble saccharide component.

The sweetener composition may comprise from 5% to 50% of the insoluble saccharide component w/w. Preferably, the sweetener composition may comprise from 10% to 30% of the insoluble saccharide component w/w. The sweetener composition may comprise from at least 10% of the insoluble saccharide component w/w. The sweetener composition may comprise from at most 50% of the insoluble saccharide component w/w. The sweetener composition may comprise from 10% to 15%, 10% to 20%, 10% to 25%, 10% to 30%, 10% to 40%, 10% to 50%, 15% to 20%, 15% to 25%, 15% to 30%, 15% to 40%, 15% to 50%, 20% to 25%, 20% to 30%, 20% to 40%, 20% to 50%, 25% to 30%, 25% to 40%, 25% to 50%, 30% to 40%, 30% to 50%, or 40% to 50% of the insoluble saccharide component w/w. The sweetener composition may comprise from 10%, 15%, 20%, 25%, 30%, 40%, or 50% of the insoluble saccharide component w/w. It should be understood that in this case where the sweetener composition comprises only the insoluble saccharide component and the soluble oligosaccharide component; the remainder of the sweetener composition (excluding the insoluble saccharide component) is the soluble oligosaccharide component.

A food, cosmetic or nutraceutical product may comprise any suitable combination of the soluble oligosaccharide and the insoluble saccharide as described herein (e.g., the soluble oligosaccharides and the insoluble saccharides of the compositions provided herein). In some cases, a baked good may comprise any suitable combination of the soluble oligosaccharide and the insoluble saccharide as described herein (e.g., the soluble oligosaccharides and the insoluble saccharides of the compositions provided here). In some cases, a sweetening agent may comprise any suitable combination of the soluble oligosaccharide and the insoluble saccharide as described herein (e.g., the soluble oligosaccharides and the insoluble saccharides of the compositions provided herein). In some instances, the food product, the baked good, or the sweetening agent may comprise any combinations of the soluble oligosaccharides and the insoluble saccharides provided herein. In some cases, the food product, the baked good, or the sweetening agent may comprise any configurations of the soluble oligosaccharides and the insoluble saccharides described herein. The food product, the baked good, and the sweetening agent may be consumable (e.g., by a human).

### Combinations of Lipids and Insoluble Saccharides

The composition may comprise various lipids. The composition may include the lipids at varying amounts, for example, depending on the desired properties of the composition. In some instances, the composition may comprise at least 50 dry wt. % lipids. In some instances, the weight ratio of the insoluble saccharide to the lipid may be 1:99 to 50:50.

In some cases, the composition may comprise at least 50 dry wt. % lipid; an insoluble saccharide having a DP of at least 20; and the weight ratio of the insoluble saccharide to the lipid may be 2:98 to 30:70. In some cases, the composition may comprise at least 50 dry wt. % lipid; an insoluble saccharide having a DP of at least 20; and the weight ratio of the insoluble saccharide to the lipid may be 3:97 to 25:75. In some cases, the composition may comprise at least 50 dry wt. % lipid; an insoluble saccharide having a DP of at least 20; and the weight ratio of the insoluble saccharide to the lipid may be 4:96 to 20:80. In some cases, the composition may comprise at least 50 dry wt. % lipid; an insoluble saccharide having a DP of at least 20; and the weight ratio of the insoluble saccharide to the lipid may be 5:95 to 17.5:82.5. The composition may also comprise at least 50 dry wt. % lipid; an insoluble saccharide having a DP of at least 20; and the weight ratio of the insoluble saccharide to the lipid may be 2:98 to 30:70, 3:97 to 25:75, 4:96 to 20:80, 5:95 to 17.5:82.5, 6:94 to 15:85, 7:93 to 12.5:87.5, 8:92 to 10:90, 9:91 to 7.5:92.5, 10:90 to 5:95, 11:89 to 2.5:97.5, 12:88 to 2:98, 13:87 to 1.5:98.5, 14:86 to 1:99, or 15:85 to 0.5:99.5.

In some cases, the lipid and the insoluble saccharide may be in a combined amount of at least 50 dry wt. % of the total amount of the composition. In various cases, the lipid and the insoluble saccharide may be in a combined amount of at least 15 dry wt. %, at least 20 dry wt. %, at least 25 dry wt. %, at least 30 dry wt. %, at least 35 dry wt. %, at least 40 dry wt. %, at least 45 dry wt. %, at least 55 dry wt. %, at least 60 dry wt. %, at least 65 dry wt. %, at least 70 dry wt. %, at least 75 dry wt. %, or at least 80 dry wt. % of the total amount of the composition.

The lipid may be coupled to a portion of the insoluble saccharide while the rest comprises lipids. For example, the lipid may be disposed around a portion of the insoluble saccharide. In some instances, the lipid may be coated around a portion of the insoluble saccharide. In various instances, the lipid may be coated around all of the insoluble saccharide. In some cases, the lipid may be dried onto a portion of the insoluble saccharide. A portion of the insoluble saccharide may comprise 5% to 90% by surface area of the insoluble saccharide while the rest comprises lipids. A portion of the insoluble saccharide may comprise 10% to 85% by surface area of the insoluble saccharide while the rest comprises lipids. A portion of the insoluble saccharide may comprise 15% to 80% by surface area of the insoluble saccharide while the rest comprises lipids. A portion of the insoluble saccharide may comprise 20% to 75% by surface area of the insoluble saccharide while the rest comprises lipids. A portion of the insoluble saccharide may comprise 25% to 70% by surface area of the insoluble saccharide while the rest comprises lipids. A portion of the insoluble saccharide may comprise 30% to 65% by surface area of the insoluble saccharide while the rest comprises lipids. A portion of the insoluble saccharide may comprise 35% to 60% by surface area of the insoluble saccharide while the rest comprises lipids. A portion of the insoluble saccharide may comprise 40% to 55% by surface area of the insoluble saccharide while the rest comprises lipids. A portion of the insoluble saccharide may comprise 45% to 50% by surface area of the insoluble saccharide while the rest comprises lipids. The lipid may be coupled to the insoluble saccharide. For example, the lipid may be disposed around the insoluble saccharide. In one case, the lipid may be coated around the insoluble saccharide. In some cases, the lipid may be dried onto the insoluble saccharide. The lipid may be coupled to a portion of the insoluble saccharide via a chemical bond. The lipid may also be coupled to the insoluble saccharide via a chemical bond. The chemical bond may comprise a covalent or a noncovalent bond. In some cases, the lipid may ensheath a portion of the insoluble saccharide. The lipid may also ensheath the insoluble saccharide.

The composition may be a sweetener. In some cases, the composition may be a fibrous sweetener. A sweetener, in some instances, may also be a sweetening agent. A sweetener, when ingested by a subject, may provide a sensation of sweetness to the subject. The sweetener may substitute sugar. The sweetener may provide no calories. In various cases, the sweetener may provide a minimal number of calories. In some cases, the sweetener may provide at least about 10%, 20%, 30%, 40%, 50%, 60%, 70%, 80%, or 90% fewer calories than sugar (e.g., table sugar or sucrose).

A food, cosmetic or nutraceutical product may comprise any suitable combination of the lipid and the insoluble saccharide as described herein (e.g., the lipid s and the insoluble saccharides of the compositions provided herein). In some cases, a baked good may comprise any suitable combination of the lipid and the insoluble saccharide as described herein (e.g., the lipid s and the insoluble saccharides of the compositions provided here). In some cases, a sweetening agent may comprise any suitable combination of the lipid and the insoluble saccharide as described herein (e.g., the lipid s and the insoluble saccharides of the compositions provided herein). In some instances, the food product, the baked good, or the sweetening agent may comprise any combinations of the lipid and the insoluble saccharides provided herein. In some cases, the food product, the baked good, or the sweetening agent may comprise any configurations of the lipid s and the insoluble saccharides described herein. The food product, the baked good, and the sweetening agent may be consumable (e.g., by a human).

### Combinations of Proteins and Insoluble Saccharides

The composition may comprise various proteins. The composition may include the proteins at varying amounts, for example, depending on the desired properties of the composition. In some instances, the composition may comprise at least 50 dry wt. % protein, insoluble saccharide having a DP of at least 20, and the weight ratio of the insoluble saccharide to the protein may be 1:99 to 50:50.

In some cases, the composition may comprise at least 50 dry wt. % a protein; an insoluble saccharide having a DP of at least 20; and the weight ratio of the insoluble saccharide to the protein may be 2:98 to 30:70. In some cases, the composition may comprise at least 50 dry wt. % a protein having a DP of from 3 to 20; an insoluble saccharide having a DP of at least 20; and the weight ratio of the insoluble saccharide to the protein may be 3:97 to 25:75. In some cases, the composition may comprise at least 50 dry wt. % a protein; an insoluble saccharide having a DP of at least 20; and the weight ratio of the insoluble saccharide to the protein may be 4:96 to 20:80. In some cases, the composition may comprise at least 50 dry wt. % a protein; an insoluble saccharide having a DP of at least 20; and the weight ratio of the insoluble saccharide to the protein may be 5:95 to 17.5:82.5. The composition may also comprise at least 50 dry wt. % a protein; an insoluble saccharide having a DP of at least 20; and the weight ratio of the insoluble saccharide to the protein may be 2:98 to 30:70, 3:97 to 25:75, 4:96 to 20:80, 5:95 to 17.5:82.5, 6:94 to 15:85, 7:93 to 12.5:87.5, 8:92 to 10:90, 9:91 to 7.5:92.5, 10:90 to 5:95, 11:89 to 2.5:97.5, 12:88 to 2:98, 13:87 to 1.5:98.5, 14:86 to 1:99, or 15:85 to 0.5:99.5.

In some cases, the protein and the insoluble saccharide may be in a combined amount of at least 50 dry wt. % of the total amount of the composition. In various cases, the protein and the insoluble saccharide may be in a combined amount of at least 15 dry wt. %, at least 20 dry wt. %, at least 25 dry wt. %, at least 30 dry wt. %, at least 35 dry wt. %, at least 40 dry wt. %, at least 45 dry wt. %, at least 55 dry wt. %, at least 60 dry wt. %, at least 65 dry wt. %, at least 70 dry wt. %, at least 75 dry wt. %, or at least 80 dry wt. % of the total amount of the composition.

The protein may be coupled to a portion of the insoluble saccharide while the rest comprises one or more proteins. For example, the protein may be disposed around a portion of the insoluble saccharide. In some instances, the protein may be coated around a portion of the insoluble saccharide. In various instances, the protein may be coated around all of the insoluble saccharide. In some cases, the protein may be dried onto a portion of the insoluble saccharide. A portion of the insoluble saccharide may comprise 5% to 90% by surface area of the insoluble saccharide while the rest comprises one or more proteins. A portion of the insoluble saccharide may comprise 10% to 85% by surface area of the insoluble saccharide while the rest comprises one or more proteins. A portion of the insoluble saccharide may comprise 15% to 80% by surface area of the insoluble saccharide while the rest comprises one or more proteins. A portion of the insoluble saccharide may comprise 20% to 75% by surface area of the insoluble saccharide while the rest comprises one or more proteins. A portion of the insoluble saccharide may comprise 25% to 70% by surface area of the insoluble saccharide while the rest comprises one or more proteins. A portion of the insoluble saccharide may comprise 30% to 65% by surface area of the insoluble saccharide while the rest comprises one or more proteins. A portion of the insoluble saccharide may comprise 35% to 60% by surface area of the insoluble saccharide while the rest comprises one or more proteins. A portion of the insoluble saccharide may comprise 40% to 55% by surface area of the insoluble saccharide while the rest comprises one or more proteins. A portion of the insoluble saccharide may comprise 45% to 50% by surface area of the insoluble saccharide while the rest comprises one or more proteins. The protein may be coupled to the insoluble saccharide. For example, the protein may be disposed around the insoluble saccharide. In one case, the protein may be coated around the insoluble saccharide. In some cases, the protein may be dried onto the insoluble saccharide. The protein may be coupled to a portion of the insoluble saccharide via a chemical bond. The protein may also be coupled to the insoluble saccharide via a chemical bond. The chemical bond may comprise a covalent or a noncovalent bond. In some cases, the protein may ensheath a portion of the insoluble saccharide. The protein may also ensheath the insoluble saccharide.

The composition may be a sweetener. In some cases, the composition may be a fibrous sweetener. A sweetener, in some instances, may also be a sweetening agent. A sweetener, when ingested by a subject, may provide a sensation of sweetness to the subject. The sweetener may substitute sugar. The sweetener may provide no calories. In various cases, the sweetener may provide a minimal number of calories. In some cases, the sweetener may provide at least about 10%, 20%, 30%, 40%, 50%, 60%, 70%, 80%, or 90% fewer calories than sugar (e.g., table sugar or sucrose).

A food, cosmetic or nutraceutical product may comprise any suitable combination of the protein and the insoluble saccharide as described herein (e.g., the proteins and the insoluble saccharides of the compositions provided herein). In some cases, a baked good may comprise any suitable combination of the protein and the insoluble saccharide as described herein (e.g., the proteins and the insoluble saccharides of the compositions provided here). In some cases, a sweetening agent may comprise any suitable combination of the protein and the insoluble saccharide as described herein (e.g., the proteins and the insoluble saccharides of the compositions provided herein). In some instances, the food product, the baked good, or the sweetening agent may comprise any combinations of the proteins and the insoluble saccharides provided herein. In some cases, the food product, the baked good, or the sweetening agent may comprise any configurations of the proteins and the insoluble saccharides described herein. The food product, the baked good, and the sweetening agent may be consumable (e.g., by a human).

### Combinations of Soluble Polysaccharides and Insoluble Saccharides

The composition may comprise various soluble polysaccharides. The composition may include the soluble polysaccharides at varying amounts, for example, depending on the desired properties of the composition. In some instances, the composition may comprise at least 50 dry wt. % soluble polysaccharide, insoluble saccharide having a DP of at least 20, and the weight ratio of the insoluble saccharide to the soluble polysaccharide may be 1:99 to 50:50.

In some cases, the composition may comprise at least 50 dry wt. % a soluble polysaccharide having a DP of at least 20; an insoluble saccharide having a DP of at least 20; and the weight ratio of the insoluble saccharide to the soluble polysaccharide may be 2:98 to 30:70. In some cases, the composition may comprise at least 50 dry wt. % a soluble polysaccharide having a DP of at least 20; an insoluble saccharide having a DP of at least 20; and the weight ratio of the insoluble saccharide to the soluble polysaccharide may be 3:97 to 25:75. In some cases, the composition may comprise at least 50 dry wt. % a soluble polysaccharide having a DP of at least 20; an insoluble saccharide having a DP of at least 20; and the weight ratio of the insoluble saccharide to the soluble polysaccharide may be 4:96 to 20:80. In some cases, the composition may comprise at least 50 dry wt. % a soluble polysaccharide having a DP of at least 20; an insoluble saccharide having a DP of at least 20; and the weight ratio of the insoluble saccharide to the soluble polysaccharide may be 5:95 to 17.5:82.5. The composition may also comprise at least 50 dry wt. % a soluble polysaccharide having a DP of at least 20; an insoluble saccharide having a DP of at least 20; and the weight ratio of the insoluble saccharide to the soluble polysaccharide may be 2:98 to 30:70, 3:97 to 25:75, 4:96 to 20:80, 5:95 to 17.5:82.5, 6:94 to 15:85, 7:93 to 12.5:87.5, 8:92 to 10:90, 9:91 to 7.5:92.5, 10:90 to 5:95, 11:89 to 2.5:97.5, 12:88 to 2:98, 13:87 to 1.5:98.5, 14:86 to 1:99, or 15:85 to 0.5:99.5.

In some cases, the soluble polysaccharide and the insoluble saccharide may be in a combined amount of at least 50 dry wt. % of the total amount of the composition. In various cases, the soluble polysaccharide and the insoluble saccharide may be in a combined amount of at least 15 dry wt. %, at least 20 dry wt. %, at least 25 dry wt. %, at least 30 dry wt. %, at least 35 dry wt. %, at least 40 dry wt. %, at least 45 dry wt. %, at least 55 dry wt. %, at least 60 dry wt. %, at least 65 dry wt. %, at least 70 dry wt. %, at least 75 dry wt. %, or at least 80 dry wt. % of the total amount of the composition.

The soluble polysaccharide may be coupled to a portion of the insoluble saccharide while the rest comprises soluble polysaccharides. For example, the soluble polysaccharide may be disposed around a portion of the insoluble saccharide. In some instances, the soluble polysaccharide may be coated around a portion of the insoluble saccharide. In various instances, the soluble polysaccharide may be coated around all of the insoluble saccharide. In some cases, the soluble polysaccharide may be dried onto a portion of the insoluble saccharide. A portion of the insoluble saccharide may comprise 5% to 90% by surface area of the insoluble saccharide while the rest comprises soluble polysaccharides. A portion of the insoluble saccharide may comprise 10% to 85% by surface area of the insoluble saccharide while the rest comprises soluble polysaccharides. A portion of the insoluble saccharide may comprise 15% to 80% by surface area of the insoluble saccharide while the rest comprises soluble polysaccharides. A portion of the insoluble saccharide may comprise 20% to 75% by surface area of the insoluble saccharide while the rest comprises soluble polysaccharides. A portion of the insoluble saccharide may comprise 25% to 70% by surface area of the insoluble saccharide while the rest comprises soluble polysaccharides. A portion of the insoluble saccharide may comprise 30% to 65% by surface area of the insoluble saccharide while the rest comprises soluble polysaccharides. A portion of the insoluble saccharide may comprise 35% to 60% by surface area of the insoluble saccharide while the rest comprises soluble polysaccharides. A portion of the insoluble saccharide may comprise 40% to 55% by surface area of the insoluble saccharide while the rest comprises soluble polysaccharides. A portion of the insoluble saccharide may comprise 45% to 50% by surface area of the insoluble saccharide while the rest comprises soluble polysaccharides. The soluble polysaccharide may be coupled to the insoluble saccharide. For example, the soluble polysaccharide may be disposed around the insoluble saccharide. In one case, the soluble polysaccharide may be coated around the insoluble saccharide. In some cases, the soluble polysaccharide may be dried onto the insoluble saccharide. The soluble polysaccharide may be coupled to a portion of the insoluble saccharide via a chemical bond. The soluble polysaccharide may also be coupled to the insoluble saccharide via a chemical bond. The chemical bond may comprise a covalent or a noncovalent bond. In some cases, the soluble polysaccharide may ensheath a portion of the insoluble saccharide. The soluble polysaccharide may also ensheath the insoluble saccharide.

The composition may be a sweetener. In some cases, the composition may be a fibrous sweetener. A sweetener, in some instances, may also be a sweetening agent. A sweetener, when ingested by a subject, may provide a sensation of sweetness to the subject. The sweetener may substitute sugar. The sweetener may provide no calories. In various cases, the sweetener may provide a minimal number of calories. In some cases, the sweetener may provide at least about 10%, 20%, 30%, 40%, 50%, 60%, 70%, 80%, or 90% fewer calories than sugar (e.g., table sugar or sucrose).

A food, cosmetic or nutraceutical product may comprise any suitable combination of the soluble polysaccharide and the insoluble saccharide as described herein (e.g., the soluble polysaccharides and the insoluble saccharides of the compositions provided herein). In some cases, a baked good may comprise any suitable combination of the soluble polysaccharide and the insoluble saccharide as described herein (e.g., the soluble polysaccharides and the insoluble saccharides of the compositions provided here). In some cases, a sweetening agent may comprise any suitable combination of the soluble polysaccharide and the insoluble saccharide as described herein (e.g., the soluble polysaccharides and the insoluble saccharides of the compositions provided herein). In some instances, the food product, the baked good, or the sweetening agent may comprise any combinations of the soluble polysaccharides and the insoluble saccharides provided herein. In some cases, the food product, the baked good, or the sweetening agent may comprise any configurations of the soluble polysaccharides and the insoluble saccharides described herein. The food product, the baked good, and the sweetening agent may be consumable (e.g., by a human).

### Combinations of Surfactants and Insoluble Saccharides

The composition may comprise various surfactants. The composition may include the surfactants at varying amounts, for example, depending on the desired properties of the composition. In some instances, the composition may comprise at least 50 dry wt. % surfactant having a DP of from 3 to 20, insoluble saccharide having a DP of at least 20, and the weight ratio of the insoluble saccharide to the surfactant may be 1:99 to 50:50.

In some cases, the composition may comprise at least 50 dry wt. % a surfactant; an insoluble saccharide having a DP of at least 20; and the weight ratio of the insoluble saccharide to the surfactant may be 2:98 to 30:70. In some cases, the composition may comprise at least 50 dry wt. % a surfactant; an insoluble saccharide having a DP of at least 20; and the weight ratio of the insoluble saccharide to the surfactant may be 3:97 to 25:75. In some cases, the composition may comprise at least 50 dry wt. % a surfactant; an insoluble saccharide having a DP of at least 20; and the weight ratio of the insoluble saccharide to the surfactant may be 4:96 to 20:80. In some cases, the composition may comprise at least 50 dry wt. % a surfactant; an insoluble saccharide having a DP of at least 20; and the weight ratio of the insoluble saccharide to the surfactant may be 5:95 to 17.5:82.5. The composition may also comprise at least 50 dry wt. % a surfactant; an insoluble saccharide having a DP of at least 20; and the weight ratio of the insoluble saccharide to the surfactant may be 2:98 to 30:70, 3:97 to 25:75, 4:96 to 20:80, 5:95 to 17.5:82.5, 6:94 to 15:85, 7:93 to 12.5:87.5, 8:92 to 10:90, 9:91 to 7.5:92.5, 10:90 to 5:95, 11:89 to 2.5:97.5, 12:88 to 2:98, 13:87 to 1.5:98.5, 14:86 to 1:99, or 15:85 to 0.5:99.5.

In some cases, the surfactant and the insoluble saccharide may be in a combined amount of at least 50 dry wt. % of the total amount of the composition. In various cases, the surfactant and the insoluble saccharide may be in a combined amount of at least 15 dry wt. %, at least 20 dry wt. %, at least 25 dry wt. %, at least 30 dry wt. %, at least 35 dry wt. %, at least 40 dry wt. %, at least 45 dry wt. %, at least 55 dry wt. %, at least 60 dry wt. %, at least 65 dry wt. %, at least 70 dry wt. %, at least 75 dry wt. %, or at least 80 dry wt. % of the total amount of the composition.

The surfactant may be coupled to a portion of the insoluble saccharide while the rest comprises one or more surfactants. For example, the surfactant may be disposed around a portion of the insoluble saccharide. In some instances, the surfactant may be coated around a portion of the insoluble saccharide. In various instances, the surfactant may be coated around all of the insoluble saccharide. In some cases, the surfactant may be dried onto a portion of the insoluble saccharide. A portion of the insoluble saccharide may comprise 5% to 90% by surface area of the insoluble saccharide while the rest comprises one or more surfactants. A portion of the insoluble saccharide may comprise 10% to 85% by surface area of the insoluble saccharide while the rest comprises one or more surfactants. A portion of the insoluble saccharide may comprise 15% to 80% by surface area of the insoluble saccharide while the rest comprises one or more surfactants. A portion of the insoluble saccharide may comprise 20% to 75% by surface area of the insoluble saccharide while the rest comprises one or more surfactants. A portion of the insoluble saccharide may comprise 25% to 70% by surface area of the insoluble saccharide while the rest comprises one or more surfactants. A portion of the insoluble saccharide may comprise 30% to 65% by surface area of the insoluble saccharide while the rest comprises one or more surfactants. A portion of the insoluble saccharide may comprise 35% to 60% by surface area of the insoluble saccharide while the rest comprises one or more surfactants. A portion of the insoluble saccharide may comprise 40% to 55% by surface area of the insoluble saccharide while the rest comprises one or more surfactants. A portion of the insoluble saccharide may comprise 45% to 50% by surface area of the insoluble saccharide while the rest comprises one or more surfactants. The surfactant may be coupled to the insoluble saccharide. For example, the surfactant may be disposed around the insoluble saccharide. In one case, the surfactant may be coated around the insoluble saccharide. In some cases, the surfactant may be dried onto the insoluble saccharide. The surfactant may be coupled to a portion of the insoluble saccharide via a chemical bond. The surfactant may also be coupled to the insoluble saccharide via a chemical bond. The chemical bond may comprise a covalent or a noncovalent bond. In some cases, the surfactant may ensheath a portion of the insoluble saccharide. The surfactant may also ensheath the insoluble saccharide.

A food, cosmetic or nutraceutical product may comprise any suitable combination of the surfactant and the insoluble saccharide as described herein (e.g., the surfactants and the insoluble saccharides of the compositions provided herein).

### Characteristics of the Compositions and Products Including the Compositions

In some instances, at least one of the firmness, springiness, and water retention of the product may be within 10% of the same characteristic of a control product (e.g., wherein the control product comprises a soluble oligosaccharide, a lipid, a protein, a soluble polysaccharide and/or a surfactant and lacks an insoluble saccharide). At least one of the firmness, springiness, and water retention of the product may be within 9% of the same characteristic of a control product. At least one of the firmness, springiness, and water retention of the product may be within 8% of the same characteristic of a control product. At least one of the firmness, springiness, and water retention of the product may be within 7% of the same characteristic of a control product. At least one of the firmness, springiness, and water retention of the product may be within 6% of the same characteristic of a control product. At least one of the firmness, springiness, and water retention of the product may be within 5% of the same characteristic of a control product. At least one of the firmness, springiness, and water retention of the product may be within 4% of the same characteristic of a control product. At least one of the firmness, springiness, and water retention of the product may be within 3% of the same characteristic of a control product. At least one of the firmness, springiness, and water retention of the product may be within 2% of the same characteristic of a control product. At least one of the firmness, springiness, and water retention of the product may be within 7% of the same characteristic of a control product. At least one of the firmness, springiness, and water retention of the product may be within 1% of the same characteristic of a control product. At least one of the firmness, springiness, and water retention of the product may have at least one of the firmness, springiness, and water retention as the same characteristic of a control product. At least one of the firmness, springiness, and water retention of the product may be within 20% of the same characteristic of a control product. At least one of the firmness, springiness, and water retention of the product may be within 19% of the same characteristic of a control product. At least one of the firmness, springiness, and water retention of the product may be within 18% of the same characteristic of a control product. At least one of the firmness, springiness, and water retention of the product may be within 17% of the same characteristic of a control product. At least one of the firmness, springiness, and water retention of the product may be within 16% of the same characteristic of a control product. At least one of the firmness, springiness, and water retention of the product may be within 15% of the same characteristic of a control product. At least one of the firmness, springiness, and water retention of the product may be within 14% of the same characteristic of a control product. At least one of the firmness, springiness, and water retention of the product may be within 13% of the same characteristic of a control product. At least one of the firmness, springiness, and water retention of the product may be within 12% of the same characteristic of a control product. At least one of the firmness, springiness, and water retention of the product may be within 11% of the same characteristic of a control product.

In some instances, the firmness of the product may be within 10% of the firmness of a control product (e.g., wherein the control product comprises a soluble oligosaccharide, a lipid, a protein, a soluble polysaccharide and/or a surfactant and lacks an insoluble saccharide). The firmness of the product may be within 9% of the firmness of a control product. The firmness of the product may be within 8% of the firmness of a control product. The firmness of the product may be within 7% of the firmness of a control product. The firmness of the product may be within 6% of the firmness of a control product. The firmness of the product may be within 5% of the firmness of a control product. The firmness of the product may be within 4% of the firmness of a control product. The firmness of the product may be within 3% of the firmness of a control product. The firmness of the product may be within 2% of the firmness of a control product. The firmness of the product may be within 7% of the firmness of a control product. The firmness of the product may be within 1% of the firmness of a control product. The firmness of the product may have the firmness as that of a control product. The firmness of the product may be within 20% of the firmness of a control product. The firmness of the product may be within 19% of the firmness of a control product. The firmness of the product may be within 18% of the firmness of a control product. The firmness of the product may be within 17% of the firmness of a control product. The firmness of the product may be within 16% of the firmness of a control product. The firmness of the product may be within 15% of the firmness of a control product. The firmness of the product may be within 14% of the firmness of a control product. The firmness of the product may be within 13% of the firmness of a control product. The firmness of the product may be within 12% of the firmness of a control product. The firmness of the product may be within 11% of the firmness of a control product.

In some instances, the springiness of the product may be within 10% of the springiness of a control product (e.g., wherein the control product comprises a soluble oligosaccharide, a lipid, a protein, a soluble polysaccharide and/or a surfactant and lacks an insoluble saccharide). The springiness of the product may be within 9% of the springiness of a control product. The springiness of the product may be within 8% of the springiness of a control product. The springiness of the product may be within 7% of the springiness of a control product. The springiness of the product may be within 6% of the springiness of a control product. The springiness of the product may be within 5% of the springiness of a control product. The springiness of the product may be within 4% of the springiness of a control product. The springiness of the product may be within 3% of the springiness of a control product. The springiness of the product may be within 2% of the springiness of a control product. The springiness of the product may be within 7% of the springiness of a control product. The springiness of the product may be within 1% of the springiness of a control product. The springiness of the product may have the springiness as that of a control product. The springiness of the product may be within 20% of the springiness of a control product. The springiness of the product may be within 19% of the springiness of a control product. The springiness of the product may be within 18% of the springiness of a control product. The springiness of the product may be within 17% of the springiness of a control product. The springiness of the product may be within 16% of the springiness of a control product. The springiness of the product may be within 15% of the springiness of a control product. The springiness of the product may be within 14% of the springiness of a control product. The springiness of the product may be within 13% of the springiness of a control product. The springiness of the product may be within 12% of the springiness of a control product. The springiness of the product may be within 11% of the springiness of a control product.

In some instances, the water retention of the product may be within 10% of the water retention of a control product (e.g., wherein the control product comprises a soluble oligosaccharide, a lipid, a protein, a soluble polysaccharide and/or a surfactant and lacks an insoluble saccharide). The water retention of the product may be within 9% of the water retention of a control product. The water retention of the product may be within 8% of the water retention of a control product. The water retention of the product may be within 7% of the water retention of a control product. The water retention of the product may be within 6% of the water retention of a control product. The water retention of the product may be within 5% of the water retention of a control product. The water retention of the product may be within 4% of the water retention of a control product. The water retention of the product may be within 3% of the water retention of a control product. The water retention of the product may be within 2% of the water retention of a control product. The water retention of the product may be within 7% of the water retention of a control product. The water retention of the product may be within 1% of the water retention of a control product. The water retention of the product may have the water retention as that of a control product. The water retention of the product may be within 20% of the water retention of a control product. The water retention of the product may be within 19% of the water retention of a control product. The water retention of the product may be within 18% of the water retention of a control product. The water retention of the product may be within 17% of the water retention of a control product. The water retention of the product may be within 16% of the water retention of a control product. The water retention of the product may be within 15% of the water retention of a control product. The water retention of the product may be within 14% of the water retention of a control product. The water retention of the product may be within 13% of the water retention of a control product. The water retention of the product may be within 12% of the water retention of a control product. The water retention of the product may be within 11% of the water retention of a control product.

In some instances, the firmness, springiness, and water retention of the product may be within 10% of the firmness, springiness, and water retention of a control product (e.g., wherein the control product comprises a soluble oligosaccharide, a lipid, a protein, a soluble polysaccharide and/or a surfactant and lacks an insoluble saccharide). The firmness, springiness, and water retention of the product may be within 9% of the firmness, springiness, and water retention of a control product. The firmness, springiness, and water retention of the product may be within 8% of the firmness, springiness, and water retention of a control product. The firmness, springiness, and water retention of the product may be within 7% of the firmness, springiness, and water retention of a control product. The firmness, springiness, and water retention of the product may be within 6% of the firmness, springiness, and water retention of a control product. The firmness, springiness, and water retention of the product may be within 5% of the firmness, springiness, and water retention of a control product. The firmness, springiness, and water retention of the product may be within 4% of the firmness, springiness, and water retention of a control product. The firmness, springiness, and water retention of the product may be within 3% of the firmness, springiness, and water retention of a control product. The firmness, springiness, and water retention of the product may be within 2% of the firmness, springiness, and water retention of a control product. The firmness, springiness, and water retention of the product may be within 7% of the firmness, springiness, and water retention of a control product. The firmness, springiness, and water retention of the product may be within 1% of the firmness, springiness, and water retention of a control product. The firmness, springiness, and water retention of the product may have the firmness, springiness, and water retention as that of a control product. The firmness, springiness, and water retention of the product may be within 20% of the firmness, springiness, and water retention of a control product. The firmness, springiness, and water retention of the product may be within 19% of the firmness, springiness, and water retention of a control product. The firmness, springiness, and water retention of the product may be within 18% of the firmness, springiness, and water retention of a control product. The firmness, springiness, and water retention of the product may be within 17% of the firmness, springiness, and water retention of a control product. The firmness, springiness, and water retention of the product may be within 16% of the firmness, springiness, and water retention of a control product. The firmness, springiness, and water retention of the product may be within 15% of the firmness, springiness, and water retention of a control product. The firmness, springiness, and water retention of the product may be within 14% of the firmness, springiness, and water retention of a control product. The firmness, springiness, and water retention of the product may be within 13% of the firmness, springiness, and water retention of a control product. The firmness, springiness, and water retention of the product may be within 12% of the firmness, springiness, and water retention of a control product. The firmness, springiness, and water retention of the product may be within 11% of the firmness, springiness, and water retention of a control product.

In some instances, at least two of the firmness, springiness, and water retention of the product may be within 10% of the same characteristics of a control product (e.g., wherein the control product comprises a soluble oligosaccharide, a lipid, a protein, a soluble polysaccharide and/or a surfactant and lacks an insoluble saccharide). At least two of the firmness, springiness, and water retention of the product may be within 9% of the same characteristics of a control product. At least two of the firmness, springiness, and water retention of the product may be within 8% of the same characteristics of a control product. At least two of the firmness, springiness, and water retention of the product may be within 7% of the same characteristics of a control product. At least two of the firmness, springiness, and water retention of the product may be within 6% of the same characteristics of a control product. At least two of the firmness, springiness, and water retention of the product may be within 5% of the same characteristics of a control product. At least two of the firmness, springiness, and water retention of the product may be within 4% of the same characteristics of a control product. At least two of the firmness, springiness, and water retention of the product may be within 3% of the same characteristics of a control product. At least two of the firmness, springiness, and water retention of the product may be within 2% of the same characteristics of a control product. At least two of the firmness, springiness, and water retention of the product may be within 7% of the same characteristics of a control product. At least two of the firmness, springiness, and water retention of the product may be within 1% of the same characteristics of a control product. At least two of the firmness, springiness, and water retention of the product may have at least two of the firmness, springiness, and water retention as that of a control product. At least two of the firmness, springiness, and water retention of the product may be within 20% of the same characteristics of a control product. At least two of the firmness, springiness, and water retention of the product may be within 19% of the same characteristics of a control product. At least two of the firmness, springiness, and water retention of the product may be within 18% of the same characteristics of a control product. At least two of the firmness, springiness, and water retention of the product may be within 17% of the same characteristics of a control product. At least two of the firmness, springiness, and water retention of the product may be within 16% of the same characteristics of a control product. At least two of the firmness, springiness, and water retention of the product may be within 15% of the same characteristics of a control product. At least two of the firmness, springiness, and water retention of the product may be within 14% of the same characteristics of a control product. At least two of the firmness, springiness, and water retention of the product may be within 13% of the same characteristics of a control product. At least two of the firmness, springiness, and water retention of the product may be within 12% of the same characteristics of a control product. At least two of the firmness, springiness, and water retention of the product may be within 11% of the same characteristics of a control product.

In some instances, at least one of the color, texture, smell, sweetness, mouthfeel, and overall acceptance may be comparable to the same characteristic of a control product (e.g., wherein the control product comprises a soluble oligosaccharide, a lipid, a protein, a soluble polysaccharide and/or a surfactant and lacks an insoluble saccharide). At least two of the color, texture, smell, sweetness, mouthfeel, and overall acceptance may be comparable to the same characteristics of a control product. At least three of the color, texture, smell, sweetness, mouthfeel, and overall acceptance may be comparable to the same characteristics of a control product. At least four of the color, texture, smell, sweetness, mouthfeel, and overall acceptance may be comparable to the same characteristics of a control product. In some instances, a product may comprise at least five of the color, texture, smell, sweetness, mouthfeel, and overall acceptance may be comparable to the same characteristics of a control product. In some cases, the color, texture, smell, sweetness, mouthfeel, and overall acceptance may be comparable to the same characteristics of a control product.

In some instances, the color of the product may be comparable to the color of a control product (e.g., wherein the control product comprises a soluble oligosaccharide, a lipid, a protein, a soluble polysaccharide and/or a surfactant and lacks an insoluble saccharide). In some cases, the texture of the product may be comparable to the texture of a control product. The smell of the product may be comparable to the smell of a control product. In some cases, the sweetness of the product may be comparable to the sweetness of a control product. In other cases, the overall acceptance of the product may be comparable to the overall acceptance of a control product.

A baked good may comprise any one of the characteristics of the products as described herein, wherein when compared to a control baked good (e.g., the control baked good comprising a soluble oligosaccharide and lacking an insoluble saccharide). The characteristics of the sweetening agents, products, or baked goods as described herein may be assayed or measured by any suitable method (e.g., the methods described in Examples 1-11).

A baked good, in some cases, may comprise any sweetening agents described herein. The baked good may comprise the sweetening agent in a total amount of at least 5%, 10%, 15%, 20%, 25%, 30%, or 35%. The baked good may comprise the sweetening agent in a total amount of at least 10%. The baked good may comprise the sweetening agent in a total amount of at least 25%. The baked good may comprise the sweetening agent in a total amount of at least 35%. In some cases, the baked good may comprise the sweetening agent in a total amount of at least 12.5%, 15%, 17.5%, 20%, 22.5%, 25%, 27.5%, 30%, or 32.5%.

In some instances, the baked good may be selected from the group consisting of a cookie, cake, biscuit, pastry, or scone. In some cases, the baked good may be a cookie. In certain cases, the baked good may be a cake. In various cases, the baked good may be a biscuit. In some cases, the baked good may be a pastry. In certain cases, the baked good may be a scone. In various cases, the baked good may be a muffin. The baked good may be a bread. In some cases, the baked good may be a pie. The baked good may be a tart. The baked good may also be a bagel. The baked good may be a cracker. The baked good, in some cases, may be selected from the group consisting of a cookie, cake, biscuit, pastry, scone, muffin, bread, pie, tart, bagel, or cracker.

A food product, in some cases, may comprise any sweetening agents described herein. The food product may comprise the sweetening agent in a total amount of at least 5%, 10%, 20%, 30%, or 40%. The food product may comprise the sweetening agent in a total amount of at least 10%. The food product may comprise the sweetening agent in a total amount of at least 20%. The food product may comprise the sweetening agent in a total amount of at least 30%. The food product may comprise the sweetening agent in a total amount of at least 50%. In some cases, the food product may comprise the sweetening agent in a total amount of at least 12.5%, 15%, 17.5%, 20%, 22.5%, 25%, 27.5%, 30%, 32.5%, 35%, 37.5%, 40%, 42.5%, 45% or 47.5%.

In some cases, a food product may be a fat-based food product. For example, the fat-based food product may be selected from the group consisting chocolate and ice cream. The fat-based food product may be chocolate. The fat-based food product may be ice cream. In some cases, the fat-based food product may be cream. The fat-based food product may be whipped cream. In other cases, the fat-based food product may be condensed milk. In some cases, the fat-based food product may be butter. In some cases, the fat-based food product may be a sweetened milk (e.g., chocolate milk). In some cases, the fat-based food product may be selected from the group consisting chocolate, ice cream, cream, whipped cream, condensed milk, butter, or sweetened milk.

In some instances, a food product may comprise a water-based food product. For example, the water-based food product may be selected from the group consisting jam, jelly, icing, and candy. In some cases, the water-based food product may be jam. In some cases, the water-based food product may be jelly. In various cases, the water-based food product may be icing. In certain cases, the water-based food product may be candy. In some instances, the water-based food product may be syrup. The water-based food product may be molasses. In some cases, the water-based food product may be selected from the group consisting jam, jelly, icing, candy, syrup, and molasses.

In some instances, the composition may be configured to be incorporated into a foodstuff, a cosmetic, or a nutraceutical. The foodstuff, a cosmetic, or a nutraceutical incorporated with the composition may comprise any foodstuff, a cosmetic, or nutraceutical described herein.

### Methods of Obtaining Saccharides

In some cases, the method may comprise obtaining the soluble oligosaccharide from a partially hydrolyzed biomass. Partially hydrolyzing the biomass may comprise using enzymes from a fungus. In some cases, partially hydrolyzing the biomass may comprise converting the polysaccharides in the biomass into one or more other forms of oligosaccharides. For example, a higher order form of polysaccharide may be converted to a lower order form of oligosaccharide. In some cases, the partial hydrolysis of the biomass may result in saccharides in forms other than monosaccharides. For example, partially hydrolyzing the biomass may result in disaccharides or oligosaccharides. The disaccharides or oligosaccharides may comprise any disaccharides or oligosaccharides described herein. The polysaccharides present in the biomass, which includes, but is not limited to, hemicellulose, cellulose, xylan (e.g., glucuronoxylan, arabinoxylan, or glucuronoarabinoxylan), mannan (e.g., glucomannan, galactomannan, or galactoglucomannan), mixed-linkage glucan, xyloglucan chitin, chitosan, or lignocellulose may be cleaved into monosaccharides, disaccharides, or other forms of lower forms of oligosaccharides. The polysaccharides present in the biomass, which includes, but is not limited to, hemicellulose, cellulose, xylan (e.g., glucuronoxylan, arabinoxylan, or glucuronoarabinoxylan), mannan (e.g., glucomannan, galactomannan, or galactoglucomannan), mixed-linkage glucan, xyloglucan chitin, chitosan, or lignocellulose may also be reduced to a lower amount in the partially hydrolyzed biomass compared to unhydrolyzed biomass. The resulting higher forms of oligosaccharides in the partially hydrolyzed biomass may comprise any soluble oligosaccharides described herein. The resulting cello-oligosaccharide, xylo-oligosaccharide, or mannan-oligosaccharide may comprise any cello-oligosaccharides, xylo-oligosaccharides, or mannan-oligosaccharides described herein. In certain cases, the enzyme may convert the biomass into any soluble oligosaccharides described herein.

In some cases, the enzyme may be a crude enzyme. In a crude enzyme, the enzyme molecules may comprise at least 5 dry wt. %, 10 dry wt. %, 20 dry wt. %, 30 dry wt. %, 40 dry wt. %, 45 dry wt. %, 49 dry wt. %, or 49.5 dry wt. % of the molecules present in the crude enzyme. The crude enzyme may comprise substances other than the enzyme molecules. The substances other than the enzyme molecules may comprise 50.5 dry wt. %, 51 dry wt. %, 55 dry wt. %, 60 dry wt. %, 70 dry wt. %, 80 dry wt. %, 90 dry wt. %, or 95 dry wt. % of the crude enzyme. In some cases, the crude enzyme may be obtained as a lysate of a fungus. The crude enzyme may comprise a lysate of a fungus. In some cases, the crude enzyme may have a comparable enzymatic activity level of a purified enzyme as described herein. In some cases, the crude enzyme may have an enzymatic activity level of at least 50%, 60%, 70%, 80%, 90%, 95%, 99%, or 99.5% of the purified enzyme. In some cases, the crude enzyme may have an enzymatic activity level of at least 100%, 150%, 200%, 250%, 500%, 750%, 1000%, or 10000% of the purified enzyme.

A purified enzyme may have less than 0.5 dry wt. %, 0.3 dry wt. %, or 0.1 dry wt. % of other substances. In some cases, the enzyme may be a purified enzyme. In a purified enzyme, the enzyme molecules may comprise at least 50 dry wt. %, 60 dry wt. %, 70 dry wt. %, 80 dry wt. %, 90 dry wt. %, 95 dry wt. %, 99 dry wt. %, or 99.5 dry wt. % of the molecules present in the purified enzyme. The purified enzyme may consist essentially of enzyme molecules. For example, the purified enzyme may have less than 0.5 dry wt. %, 0.3 dry wt. %, or 0.1 dry wt. % of other substances.

The enzyme in the crude enzyme or the purified enzyme may comprise a cellulase or a hemicellulase. The enzyme in the crude enzyme or the purified enzyme may comprise a cellulase. The enzyme in the crude enzyme or the purified enzyme may comprise a hemicellulase. The enzyme in the crude enzyme or the purified enzyme may comprise an enzyme that can hydrolyze hemicellulose, cellulose, xylan (e.g., glucuronoxylan, arabinoxylan, or glucuronoarabinoxylan), mannan (e.g., glucomannan, galactomannan, or galactoglucomannan), mixed-linkage glucan, xyloglucan chitin, chitosan, or lignocellulose.

The fungus may comprise a filamentous fungus. The filamentous fungus may synthesize an enzyme that can hydrolyze or at least partially hydrolyze the biomass. The filamentous fungus may secrete the enzyme that can hydrolyze the biomass. The filamentous fungus may synthesize an enzyme that can partially hydrolyze the biomass. The fungus may be a teleomorph. In other cases, the fungus may be an anamorph. In some cases, the fungus may comprise a non-filamentous fungus. In some cases, the fungus may be a yeast. The fungus may be a mold. In some cases, the fungus may be isolated from the environment. In other cases, the fungus may be cultured in a laboratory environment.

The method may comprise a Trichoderma species. The fungus may be Trichoderma reesei. The fungus may also be Trichoderma reesei RUT-C30. The fungus may be Aspergillus niger. In some cases, the fungus may also be a Pachybasium species, a Longibrachiatum species, a Saturnisporum species, or a Hypocreanum species. In some cases, the Trichoderma species may synthesize a cellulase and hemicellulase. In some cases, the Trichoderma species may secrete a cellulase and hemicellulase. In some cases, Trichoderma reesei may synthesize a cellulase and hemicellulase. In some cases, Trichoderma reesei may secrete a cellulase and hemicellulase. In some cases, the Trichoderma species may be isolated from the environment. In some cases, the Trichoderma species may be cultured in a laboratory environment. In some cases, Trichoderma reesei may be isolated from the environment. In some cases, Trichoderma reesei may be cultured in a laboratory environment. In some cases, the Trichoderma species may be obtained from a frozen stock. In other cases, the Trichoderma species may be lyophilized. The Trichoderma species may be in a powder form. In some cases, Trichoderma reesei may be cultured in a laboratory environment. In some cases, Trichoderma reesei may be obtained from a frozen stock. In other cases, Trichoderma reesei may be lyophilized. Trichoderma reesei may be in a powder form.

In some cases, the composition may include at least 1% w/w, 2% w/w, 3% w/w, 4% w/w, 5% w/w, 10% w/w, 15% w/w, 20% w/w, 25% w/w, 30% w/w, or more of cellobiose, xylobiose, mannobiose (e.g., Man-β-1,4-Man), Glc-β-1,4-Man, Man-β-1,4-Glc, maltose, lactose, or sucrose. In certain cases, the composition may include at least 1% w/w, 2% w/w, 3% w/w, 4% w/w, 5% w/w, 10% w/w, 15% w/w, 20% w/w, 25% w/w, 30% w/w, or more of cellotriose, xylotriose, monoarabinosylated xylobiose, monoglucuronosylated xylobiose, maltotriose, mannotriose (e.g., Man-β-1,4-Man-β-1,4-Man), Glc-β-1,4-Man-β-1,4-Man, Man-β-1,4-Glc-β-1,4-Man, Man-β-1,4-Man-β-1,4-Glc, Man-β-1,4-Glc-β-1,4-Glc, Glc-β-1,4-Man-β-1,4-Glc, Glc-β-1,4-Glc-β-1,4-Man, Glc-β-1,3-Glc-β-1,4-Glc, or Glc-β-1,4-Glc-β-1,3-Glc. In certain instances, the composition may include at least 1% w/w, 2% w/w, 3% w/w, 4% w/w, 5% w/w, 10% w/w, 15% w/w, 20% w/w, 25% w/w, 30% w/w, or more of xylotetraose, cellotetraose, monoarabinosylated xylotriose, monoglucuronosylated xylotriose, diarabinosylated xylobiose, diglucuronosylated xylobiose, maltotetraose, mannotetraose (e.g., Man-β-1,4-Man-β-1,4-Man-β-1,4-Man), Glc-β-1,4-Man-β-1,4-Man-β-1,4-Man, Man-β-1,4-Glc-β-1,4-Man-β-1,4-Man, Man-β-1,4-Man-β-1,4-Glc-β-1,4-Man, Man-β-1,4-Man-β-1,4-Man-β-1,4-Glc, Glc-β-1,4-Glc-β-1,4-Man-β-1,4-Man, Man-β-1,4-Glc-β-1,4-Glc-β-1,4-Man, Man-β-1,4-Man-β-1,4-Glc-β-1,4-Glc, Glc-β-1,4-Man-β-1,4-Glc-β-1,4-Man, Glc-β-1,4-Man-β-1,4-Man-β-1,4-Glc, Man-β-1,4-Glc-β-1,4-Man-β-1,4-Glc, Glc-β-1,3-Glc-β-1,4-Glc-1,4-Glc, Glc-β-1,4-Glc-β-1,3-Glc-1,4-Glc, Glc-β-1,4-Glc-β-1,4-Glc-1,3-Glc, or Glc-β-1,3-Glc-β-1,4-Glc-1,3-Glc. In certain cases, the composition or the ingredient may include at least 0.01% w/w, 0.05% w/w, 0.1% w/w, 0.5% w/w, 1% w/w, 2% w/w, 5% w/w, 10% w/w, 15% w/w, 20% w/w, or more of xylopentaose, cellopentaose, monoarabinosylated xylotetraose, monoglucuronosylated xylotetraose, diarabinosylated xylotriose, diglucuronosylated xylotriose, maltopentaose, mannopentaose (e.g., Man-β-1,4-Man-β-1,4-Man-β-1,4-Man-β-1,4-Man), mixed-linkage glucan-derived pentasaccharide, or mannan-derived pentasaccharide

The composition may comprise from 1% to 50%, 5% to 40%, 10% to 30%, or 15% to 25% w/w of cellobiose. The composition may comprise from 2.5% to 90%, 5% to 80%, 10% to 70%, or 20% to 60% w/w of xylobiose. The composition may comprise from 2.5% to 75%, 5% to 50%, 10% to 40%, or 20% to 30% w/w of xylotriose.

The average DP of the oligosaccharides in the composition may be from 1 to 50, 1.5 to 25, 2 to 15, 2.1 to 10, 2.1 to 7, or 2.2 to 5.

Oligosaccharide consumption can cause gastrointestinal distress, including diarrhea, discomfort, and bloating. The compositions described herein may have an improved gastrointestinal tolerance such as, less or no discomfort, bloating, diarrhea, or gastrointestinal distress as compared to a saccharide composition available commercially or a saccharide composition comprising primarily monosaccharides and/or disaccharides. For example, a subject who ingests one or more of the compositions provided herein may have an improved gastrointestinal tolerance such as, less or no discomfort, bloating, diarrhea, or gastrointestinal distress as compared to if, or when, the subject ingests a saccharide composition available commercially or a saccharide composition comprising primarily monosaccharides and/or disaccharides.

In some embodiments, the composition may comprise less than 1%, 5%, 10%, 15%, 20%, 25%, 30%, or 40% w/w monosaccharides. For example, the composition may comprise less than 20% w/w monosaccharides. The composition may include from 10% to 40%, 15% to 30%, 18% to 25%, or about 20% w/w monosaccharides. In some embodiments, the composition may comprise less than 1%, 5%, 10%, 15%, 20%, 25%, 30%, or 40% w/w glucose. For example, the composition may comprise less than 10% w/w glucose. The composition may include from 10% to 40%, 15% to 30%, 18% to 25%, or about 20% w/w glucose. In some embodiments, the composition may comprise less than 1%, 5%, 10%, 15%, 20%, 25%, 30%, or 40% w/w xylose. For example, the composition may comprise less than 10% w/w xylose. The composition may include from 10% to 40%, 15% to 30%, 18% to 25%, or about 20% w/w xylose.

In certain cases, the ratio of glucose residues to xylose residues (e.g., glucose:xylose) within the composition may be from 1:1 to 1:9, 1:1 to 1:7, 1:1 to 1:5, 1:1 to 1:3, or 1:1 to 1:2.

In certain embodiments, the composition may comprise less than 30%, 40%, 50%, 60%, 65%, 70%, 75%, or 80% w/w disaccharides. For example, the composition may comprise less than 70% w/w disaccharides. The composition may include from 10% to 95%, 15% to 90%, 20% to 80%, 30% to 70%, or 40% to 60% w/w disaccharides. The composition may comprise from 5% to 95%, 10% to 92.5%, 15% to 90%, 20% to 70%, 30% to 60%, or 40% to 50% disaccharides. In various embodiments, the composition may comprise at least 0.5%, 1%, 2.5%, 5%, 7.5%, 10%, 15%, or 20% w/w trisaccharides. For example, the composition may comprise at least 5% w/w trisaccharides. In various embodiments, the composition may comprise at least 0.5%, 1%, 2.5%, 5%, 7.5%, 10%, 15%, or 20% w/w trisaccharides. For example, the composition may comprise at least 5% w/w trisaccharides. The composition may comprise from 1% to 75%, 2.5% to 60%, 5% to 50%, 10% to 40%, or 20% to 30% trisaccharides. In some cases, the composition may comprise at least 0.1%, 0.5%, 1%, 2.5%, 5%, 7.5%, 10%, 15%, or 20% w/w tetrasaccharides. For example, the composition may comprise at least 1% w/w tetrasaccharides. In various cases, the composition may comprise at least 0.01%, 0.05%, 0.1%, 0.2%, 0.3%, 0.5%, 0.5%, 1%, 2.5%, 5%, 7.5%, or w/w pentasaccharides. For example, the composition may comprise at least 0.1% w/w pentasaccharides.

Compositions are provided here may be used to prepare finished products. The composition may also be treated in some physical or chemical way before or during incorporation into a foodstuff, cosmetic, or nutraceutical. The composition may be directly incorporated into a product, or the composition may be incorporated into, for example, a dough, cake mixture, chocolate mixture, or other foodstuff precursor; a cosmetic base composition; or a nutraceutical, and, for example, be cooked or otherwise treated in a way which may cause chemical modification, a change of texture, a change of color, or other modification.

A foodstuff, cosmetic, or nutraceutical may be produced from a composition described herein. For example, in the food industry, the saccharide formulations produced by the current method may be used as sweeteners, bulking agents, added dietary fiber, or humectants. The ingredient may be used as a sugar substitute. The ingredient may be incorporated into cakes, breads, or other baked goods, or into chocolate or other confectionery such as toffee, fudge, meringue, jam, jelly, or caramel; or drinks, for example, to provide favorable taste or color characteristics or to increase dietary fiber content. In certain instances, the ingredient may be incorporated into animal feed, for example, either as an isolated ingredient or by utilizing the enzymatic reaction mixture directly as feed.

In the cosmetics industry, saccharides can be useful as ingredients, as they may improve texture and moisture retention, act as UV-absorbing molecules, maintain a gel or cream structure, and/or serve as bulking agents. The compositions described herein can be incorporated into nutraceutical compositions, as the dietary fiber they provide can encourage digestive health, well-regulated gut flora, and other benefits to wellbeing. In this context, they may also function as an ingredient in a probiotic drink or other prebiotic or probiotic formulation.

Compositions as described herein may be used to alter one or more properties of the finished product. Such properties include, but are not limited to, sweetness, texture, mouthfeel, binding, glazing, smoothness, moistness, viscosity, color, hygroscopicity, flavor, bulking, water-retention, caramelization, surface texture, crystallization, structural properties, and dissolution.

In some cases, the compositions described herein may provide a property to a finished product which is comparable to or better than the same property as provided by a saccharide mixture comprising primarily monosaccharides and/or disaccharides. The control composition may be a saccharide used commonly in consumables, for instance, a monosaccharide composition such as glucose, fructose, etc, a disaccharide composition such as sucrose or an artificial sugar composition. The control composition may be table sugar, corn syrup, high-fructose corn syrup, or any other suitable composition. The term “comparable,” as used herein, generally means that the two compositions may be up to 100%, up to 95%, up to 90%, or up to 80% identical. For instance, comparable can mean that the composition is up to 90% identical to the control composition.

In some cases, the compositions described herein may be used as sweetener compositions. Sweetener compositions may be used by themselves or as an ingredient in a finished product. The compositions described herein may provide about the same level of sweetness or greater sweetness than an identical amount of a control composition wherein the control composition comprises primarily monosaccharides and/or disaccharides. The compositions described herein may be used to replace the control composition as the sweetener in a finished product. In some cases, the sweetness of a composition may be 5%, 10%, 15%, 20%, 30%, 40%, 50%, 70%, 80%, 90%, or 100% more than an identical amount of the control composition.

The compositions described herein may provide a comparable flavor profile or better flavor profile than an identical amount of a control composition wherein the control composition comprises primarily monosaccharides and/or disaccharides. The compositions described herein may be used to replace the control composition as a flavor enhancer in a finished product. In some cases, the flavor of a composition may be 5%, 10%, 15%, 20%, 30%, 40%, 50%, 70%, 80%, 90%, or 100% more than an identical amount of the control composition.

The compositions described herein may provide a comparable texture profile or better texture profile than an identical amount of a control composition wherein the control composition comprises primarily monosaccharides and/or disaccharides. The compositions described herein may be used to replace the control composition as a texture enhancer in a finished product.

The compositions described herein may provide a comparable binding profile or better binding profile than an identical amount of a control composition wherein the control composition comprises primarily monosaccharides and/or disaccharides. The compositions described herein may be used to replace the control composition as a binding enhancer in a finished product.

The compositions described herein may provide a comparable glazing profile or better glazing profile than an identical amount of a control composition wherein the control composition comprises primarily monosaccharides and/or disaccharides. The compositions described herein may be used to replace the control composition as a glazing enhancer in a finished product.

The compositions described herein may provide a comparable moistness or better moistness than an identical amount of a control composition wherein the control composition comprises primarily monosaccharides and/or disaccharides. The compositions described herein may be used to replace the control composition to provide moistness in a finished product.

The compositions described herein may provide a comparable color profile or better color profile than an identical amount of a control composition wherein the control composition comprises primarily monosaccharides and/or disaccharides. The compositions described herein may be used to replace the control composition as a color enhancer in a finished product.

The compositions described herein may provide a comparable dissolution profile or better dissolution profile than an identical amount of a control composition wherein the control composition comprises primarily monosaccharides and/or disaccharides. The compositions described herein may be used to replace the control composition as a dissolution enhancer in a finished product. In some cases, the dissolution of a composition may be 5%, 10%, 15%, 20%, 30%, 40%, 50%, 70%, 80%, 90%, or 100% more than an identical amount of the control composition.

The compositions described herein may provide a comparable mouthfeel or better mouthfeel than an identical amount of a control composition wherein the control composition comprises primarily monosaccharides and/or disaccharides.

The compositions described herein may provide a comparable viscosity or better viscosity than an identical amount of a control composition wherein the control composition comprises primarily monosaccharides and/or disaccharides.

The compositions described herein may provide a comparable hygroscopicity or better hygroscopicity than an identical amount of a control composition wherein the control composition comprises primarily monosaccharides and/or disaccharides. In some cases, the hygroscopicity of a composition may be 5%, 10%, 15%, 20%, 30%, 40%, 50%, 70%, 80%, 90%, or 100% more than an identical amount of the control composition.

The compositions described herein may provide a comparable water-retention or better water-retention than an identical amount of a control composition wherein the control composition comprises primarily monosaccharides and/or disaccharides. In some cases, the water-retention of a composition may be 5%, 10%, 15%, 20%, 30%, 40%, 50%, 70%, 80%, 90%, or 100% more than an identical amount of the control composition.

The compositions described herein may provide a lower calorie composition than an identical amount of a control composition wherein the control composition comprises primarily monosaccharides and/or disaccharides. In some cases, the calorie count of a composition may be 5%, 10%, 15%, 20%, 30%, 40%, 50%, 70%, 80%, 90%, or 100% less than an identical amount of the control composition.

The compositions described herein may provide a lower glycemic index than an identical amount of a control composition wherein the control composition comprises primarily monosaccharides and/or disaccharides. In some cases, the glycemic index of a composition may be 5%, 10%, 15%, 20%, 30%, 40%, 50%, 70%, 80%, 90%, or 100% less than an identical amount of the control composition.

The compositions described herein may provide a comparable bulking or better bulking than an identical amount of a control composition wherein the control composition comprises primarily monosaccharides and/or disaccharides.

The compositions described herein may provide a comparable caramelization or better caramelization than an identical amount of a control composition wherein the control composition comprises primarily monosaccharides and/or disaccharides.

The compositions described herein may provide a comparable surface texture or better surface texture than an identical amount of a control composition wherein the control composition comprises primarily monosaccharides and/or disaccharides.

The compositions described herein may provide a comparable crystallization or better crystallization than an identical amount of a control composition wherein the control composition comprises primarily monosaccharides and/or disaccharides.

The compositions described herein may provide comparable structural properties as an identical amount of a control composition wherein the control composition comprises primarily monosaccharides and/or disaccharides.

The compositions described herein may provide less aftertaste compared to an identical amount of a control composition wherein the control composition comprises primarily monosaccharides and/or disaccharides.

Different compositions of oligosaccharides may have improved dissolution profiles, hygroscopicity profiles, and taste profiles compared to the oligosaccharides used alone.

The compositions as described herein may be used to increase the fiber content of a finished product such as a foodstuff or a nutraceutical. The compositions may provide a higher level of fiber in the finished product as compared to an identical amount of a control composition wherein the control composition comprises primarily monosaccharides and/or disaccharides. In some cases, the compositions may improve the fiber content of the finished product without negatively, or substantially negatively, affecting any other properties such as taste, sweetness, mouthfeel, texture, binding, or any other properties described herein. In some cases, the fiber content of a composition may be 5%, 10%, 15%, 20%, 30%, 40%, 50%, 70%, 80%, 90%, or 100% more than an identical amount of the control composition.

Ingredients may be used to alter the properties of a finished product such as foodstuff or nutraceutical or cosmetic. In order to alter the properties of the finished products, the finished products may additionally comprise a polysaccharide, for example, a cellulosic polysaccharide, such as cellulose, or a polysaccharide derivative, for example, a cellulose derivative, such as carboxymethylcellulose, or a polysaccharide aggregate, for example, a portion of lignocellulosic biomass. In some instances, the finished products can comprise from greater than 0 dry wt. % to 40 dry wt. % of polysaccharide, polysaccharide derivative, or polysaccharide aggregate, for example, from greater than 1 dry wt. % to 30 dry wt. % of polysaccharide, polysaccharide derivative, or polysaccharide aggregate, for example, from greater than 5 dry wt. % to 25 dry wt. % of polysaccharide, polysaccharide derivative, or polysaccharide aggregate, for example, from greater than 10 dry wt. % to 20 dry wt. % of polysaccharide, polysaccharide derivative, or polysaccharide aggregate.

### EMBODIMENTS

[Embodiment 1]: A composition comprising: an insoluble saccharide component, the insoluble saccharide component comprising insoluble saccharide having a DP of at least 20; and a soluble oligosaccharide component, the soluble oligosaccharide component comprising soluble oligosaccharide having a degree of polymerization (DP) of two to 20; the composition comprising the soluble oligosaccharide component and the insoluble saccharide component in a combined total amount of at least 50 dry wt. %, the weight ratio of the insoluble saccharide component to the soluble oligosaccharide component being 1:99 to 50:50.

[Embodiment 2]: The composition of embodiment 1, the weight ratio of the soluble oligosaccharide component to the insoluble saccharide component being 2:98 to 30:70.

[Embodiment 3]: The composition of embodiment 1, the soluble oligosaccharide comprising at least 90 dry wt. % soluble oligosaccharides having a DP of two to 20.

[Embodiment 4]: The composition of any one of embodiments 1 to 3, the insoluble saccharide comprising partially hydrolyzed biomass.

[Embodiment 5]: The composition of embodiment 4, the partially hydrolyzed biomass comprising partially hydrolyzed biomass from corn cob, wheat straw, rice straw, corn stover, sugar cane bagasse or wood.

[Embodiment 6]: The composition of embodiment 4, the partially hydrolyzed biomass comprising lignan or xylan.

[Embodiment 7]: The composition of any one of embodiments 1 to 7, the insoluble saccharide comprising at least one of: (i) a cellulose; (ii) a xylan; or (iii) a mannan.

[Embodiment 8]: The composition of any one of embodiments 1 to 7, the insoluble saccharide comprising at least two of: (i) a cellulose; (ii) a xylan; or (iii) a mannan.

[Embodiment 9]: The composition of any one of the embodiments above, the insoluble saccharide comprising greater than 20% cellulose.

[Embodiment 10]: The composition of any one of the embodiments above, the insoluble saccharide comprising greater than 1% xylan.

[Embodiment 11]: The composition of any one of the embodiments above, the insoluble saccharide comprising less than 70% xylan.

[Embodiment 12]: The composition of any one of the embodiments above, the insoluble saccharide comprising greater than 1% mannan.

[Embodiment 13]: The composition of any one of the embodiments above, the insoluble saccharide comprising less than 70% mannan.

[Embodiment 14]: The composition of any one of the embodiments above, the insoluble saccharide comprising greater than 0.1% mixed-linkage glucan.

[Embodiment 15]: The composition of any one of the embodiments above, the insoluble saccharide comprising less than 17.5% mixed-linkage glucan.

[Embodiment 16]: The composition of any one of embodiments 1 to 15, the composition comprising less than 20% w/v glucose, fructose, galactose, sucrose, maltose, or lactose.

[Embodiment 17]: The composition of any one of embodiments 1 to 16, the composition comprising less than 20% w/v monosaccharides.

[Embodiment 18]: The composition of any one of embodiments 1 to 17, the insoluble saccharide comprising a multimolecular complex of cellulose and hemicellulose.

[Embodiment 19]: The composition of any one of embodiments 1 to 18, the insoluble saccharide comprising a polyaromatic compound.

[Embodiment 20]: The composition of embodiment 19, the polyaromatic compound comprising lignin.

[Embodiment 21]: The composition of any one of embodiments 1 to 20, the composition further comprising lignocellulose thermochemical breakdown products, such as alpha pinene, tetrahydrolinalool, dihydromyrcenol, furfural, menthone, isomenthone, linalool, menthyl acetate, neomenthol, caryophyllene, Isomenthol, menthol, Phenylacetaldehyde, Pulegone, 4-t-butylcyclohexyl acetate, Carvone, dihydroxybenzaldehyde isomer, anethole, guaiacol, verdyl acetate, 2-phenylethyl alcohol, beta ionone, diphenyl ether, phenolicmethoxybenzaldehyde isomer, Thymol, vinyl guaiacol, hexyl salicylate, Myristicin, isoeugenol, alpha hexylcinnamaldehyde, vinyl phenol, vanillin, hexadecanoic acid at greater than 10 ppb.

[Embodiment 22]: The composition of any one of the embodiments above, the soluble oligosaccharide comprising at least one of: (i) a cello-oligosaccharide; (ii) a xylo-oligosaccharide; or (iii) a mannan-oligosaccharide.

[Embodiment 23]: The composition of any one of the embodiments above, the soluble oligosaccharide comprising at least two of: (i) a cello-oligosaccharide; (ii) a xylo-oligosaccharide; or (iii) a mannan-oligosaccharide.

[Embodiment 24]: The composition of any one of the embodiments above, the soluble oligosaccharide comprising a cello-oligosaccharide and a xylo-oligosaccharide, the weight ratio of the cello-oligosaccharide to the xylo-oligosaccharide being 2:98 to 50:50.

[Embodiment 25]: The composition of any one of the embodiments above, the soluble oligosaccharide comprising a cello-oligosaccharide and a mannan-oligosaccharide, the weight ratio of the cello-oligosaccharide to the mannan-oligosaccharide being 2:98 to 50:50.

[Embodiment 26]: The composition of any one of the embodiments above, the cello-oligosaccharide having a DP of two to six.

[Embodiment 27]: The composition of any one of the embodiments above, the cello-oligosaccharide comprising greater than 30% cellobiose.

[Embodiment 28]: The composition of any one of the embodiments above, the cello-oligosaccharide comprising less than 15% cellotriose.

[Embodiment 29]: The composition of any one of the embodiments above, the cello-oligosaccharide comprising less than 15% cellotetraose.

[Embodiment 30]: The composition of any one of the embodiments above, the xylo-oligosaccharide having a DP of 2 to 12.

[Embodiment 31]: The composition of embodiment 30, the xylo-oligosaccharide comprising less than 70% xylobiose.

[Embodiment 32]: The composition of embodiment 30, the xylo-oligosaccharide comprising less than 60% xylotriose.

[Embodiment 33]: The composition of embodiment 30, the xylo-oligosaccharide comprising less than 50% xylotetraose.

[Embodiment 34]: The composition of any one of embodiments 30 to 33, the xylo-oligosaccharide comprising at least 5% substituted xylo-oligosaccharide.

[Embodiment 35]: The composition of embodiments 4, 23, or 25, the mannan-oligosaccharide having a DP of 2 to 12.

[Embodiment 36]: The composition of embodiment 35, the mannan-oligosaccharide comprising less than 70% of a mannan-oligosaccharide having a DP of 2.

[Embodiment 37]: The composition of embodiment 35, the mannan-oligosaccharide comprising less than 60% of a mannan-oligosaccharide having a DP of 3.

[Embodiment 38]: The composition of embodiment 35, the mannan-oligosaccharide comprising less than 50% of a mannan-oligosaccharide having a DP of 4.

[Embodiment 39]: The composition of any one of embodiments 35 to 38, the mannan-oligosaccharide comprising at least 1% substituted mannan-oligosaccharide.

[Embodiment 40]: The composition of any one of embodiments 4, 23, or 25, the mixed-linkage glucan-oligosaccharide having a DP of 2 to 12.

[Embodiment 41]: The composition of embodiment 35, the mixed-linkage glucan-oligosaccharide comprising less than 70% of a mixed-linkage glucan-oligosaccharide having a DP of 2.

[Embodiment 42]: The composition of embodiment 35, the mixed-linkage glucan-oligosaccharide comprising less than 60% of a mixed-linkage glucan-oligosaccharide having a DP of 3.

[Embodiment 43]: The composition of embodiment 35, the mixed-linkage glucan-oligosaccharide comprising less than 50% of a mixed-linkage glucan-oligosaccharide having a DP of 4.

[Embodiment 44]: The composition of any one of embodiments 1 to 39, comprising less than 30 dry wt. %, of monosaccharide.

[Embodiment 45]: The composition of any one of embodiments 1 to 40, comprising less than 20 dry wt. %, of sucrose.

[Embodiment 46]: The composition of any one of embodiments 1 to 45, comprising less the 70 dry wt. % of disaccharides.

[Embodiment 47]: The composition of any one of embodiments 1 to 47 wherein the composition is a consumable composition.

[Embodiment 48]: The composition of embodiment 47, wherein the composition is consumable by a human.

[Embodiment 49]: The composition of any one of embodiments 1 to 48, wherein the composition is configured to be incorporated into a foodstuff, a cosmetic, or a nutraceutical.

[Embodiment 50]: The composition of any one of embodiments 1 to 48, wherein the composition is a sweetener.

[Embodiment 51]: The composition of embodiment 50, wherein the composition is a fibrous sweetener.

[Embodiment 52]: A food product comprising: a soluble oligosaccharide component, the soluble oligosaccharide component comprising soluble oligosaccharide having a degree of polymerization (DP) of 2 to 60; and an insoluble saccharide component, the insoluble saccharide component comprising an insoluble saccharide having a DP of at least 20, the weight ratio of the insoluble saccharide component to the soluble oligosaccharide component being 1:99 to 50:50 and at least one characteristic of the food product selected of the group consisting of firmness, springiness, and water retention being within 10% of the same characteristic of a control food product, the control food product comprising a soluble oligosaccharide and lacking an insoluble saccharide.

[Embodiment 53]: A food product comprising: a soluble oligosaccharide component, the soluble oligosaccharide component comprising soluble oligosaccharide having a degree of polymerization (DP) of 2 to 60; and an insoluble saccharide component, the insoluble saccharide component comprising an insoluble saccharide having a DP of at least 20, the weight ratio of the insoluble saccharide component to the soluble oligosaccharide component being 1:99 to 50:50; and at least one characteristic of the food product selected of the group consisting of color, texture, smell, sweetness, mouthfeel, and overall acceptance being comparable to the same characteristic of a control food product, the control food product comprising a soluble oligosaccharide and lacking an insoluble saccharide.

[Embodiment 54]: A baked good comprising: a sweetening agent comprising: a soluble oligosaccharide component, the soluble oligosaccharide component comprising a soluble oligosaccharide having a degree of polymerization (DP) of 2 to 20; and an insoluble saccharide component, the insoluble saccharide component comprising an insoluble saccharide having a DP of at least 20, the weight ratio of the insoluble saccharide component to the soluble oligosaccharide component being 1:99 to 50:50, and the bakery product comprising the sweetening agent in a total amount of at least 5%, 10%, 25%, or 35%.

[Embodiment 55]: The baked good of embodiment 54, the baked good selected from the group consisting of a cookie, cake, biscuit, pastry, or scone.

[Embodiment 56]: A food product comprising: a sweetening agent comprising: a soluble oligosaccharide component, the soluble oligosaccharide component comprising a soluble oligosaccharide having a degree of polymerization (DP) of 2 to 20; and an insoluble saccharide component, the insoluble saccharide component comprising an insoluble saccharide having a DP of at least 20, the weight ratio of the insoluble saccharide component to the soluble oligosaccharide component being 1:99 to 50:50, and the food product comprising the sweetening agent in a total amount of at least 5%.

[Embodiment 57]: The food product of embodiment 56, the food product being a fat-based food product.

[Embodiment 58]: The food product of embodiment 57, the fat-based food product selected from the group consisting of chocolate and ice cream.

[Embodiment 59]: The food product of embodiment 56, the food product being a water-based food product.

[Embodiment 60]: The food product of embodiment 59, the water-based food product selected from the group consisting of j am, jelly, icing, and candy.

[Embodiment 61]: A composition comprising: a soluble oligosaccharide component, the soluble oligosaccharide component comprising soluble oligosaccharide having a degree of polymerization (DP) of 2 to 20; and an insoluble saccharide component, the insoluble saccharide component comprising an insoluble saccharide having a DP of at least 20, the composition comprising at least 50% dry wt. % of the soluble oligosaccharide component and the insoluble saccharide component; the weight ratio of the insoluble saccharide component to the soluble oligosaccharide component being 1:99 to 50:50, and the soluble oligosaccharide component comprising at least one type of oligosaccharide selected from the group consisting of: i) a cello-oligosaccharide having a degree of polymerization (DP) of 2 to 6; ii) a xylo-oligosaccharide having a DP of 2 to 12; and iii) a mannan-oligosaccharide having a DP of 2 to 12.

[Embodiment 62]: The method of forming a composition comprising: providing a plant biomass, the plant biomass comprising cellulose and hemicellulose; and incubating the plant biomass with at least one enzyme, thereby yielding a composition comprising: i. a soluble oligosaccharide component, the soluble oligosaccharide component comprising soluble oligosaccharide having a degree of polymerization (DP) of 3 to 20; and ii. an insoluble saccharide component, the insoluble saccharide component comprising insoluble saccharide having a DP of at least 20, the composition comprising the soluble oligosaccharide component and the insoluble saccharide component in a combined total amount of at least 50 dry wt. %, the weight ratio of the insoluble saccharide component to the soluble saccharide component being 1:99 to 50:50.

[Embodiment 63]: The method of embodiment 62, further comprising thermochemically treating the plant biomass.

[Embodiment 64]: The method of embodiment 62 or embodiment 63, the weight ratio of the soluble saccharide component to the insoluble saccharide component being 2:98 to 50:50.

In an embodiment, the invention provides a sweetener composition consisting essentially of:
a. a soluble oligosaccharide component, wherein the soluble oligosaccharide component is a mixture of cello-oligosaccharides and xylo-oligosaccharides; and
b. an insoluble saccharide component, wherein the insoluble saccharide component is a partially hydrolyzed fiber; wherein the insoluble saccharide component has a particle size from 30 microns to 300 microns;
   wherein the sweetener composition comprises from 10% to 30% w/w of the insoluble saccharide component.

In this embodiment, the preferred features of the sweetener composition are as described above.

A sweetener composition consisting essentially of components a. and b. may contain other ingredients but substantially no further saccharide component. Thus, in this embodiment is provided a sweetener composition comprising:
a. a soluble oligosaccharide component, wherein the soluble oligosaccharide component is a mixture of cello-oligosaccharides and xylo-oligosaccharides; and
b. an insoluble saccharide component, wherein the insoluble saccharide component is a partially hydrolyzed fiber; wherein the insoluble saccharide component has a particle size from 30 microns to 300 microns;
   wherein the sweetener composition comprises from 10% to 30% w/w of the insoluble saccharide component; and
   wherein the sweetener composition comprises no more than 20% of a saccharide other than said soluble oligosaccharide component or said insoluble saccharide component.

Preferably in this embodiment, the sweetener composition comprises no more than 10% of a saccharide other than said soluble oligosaccharide component or said insoluble saccharide component, more preferably no more than 5%, still more preferably no more than 2%, yet more preferably no more than 1%, and most preferably no other saccharide component.

In one embodiment, the sweetener composition consists of:
a. a soluble oligosaccharide component, wherein the soluble oligosaccharide component is a mixture of cello-oligosaccharides and xylo-oligosaccharides; and
b. an insoluble saccharide component, wherein the insoluble saccharide component is a partially hydrolyzed fiber; wherein the insoluble saccharide component has a particle size from 30 microns to 300 microns;
   wherein the sweetener composition comprises from 10% to 30% w/w of the insoluble saccharide component.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

### EXAMPLES

The following illustrative examples are representative of embodiments of the compositions and methods described herein and are not meant to be limiting in any way.

### Example 1—Production of Baked Goods with Sucrose-Like Aesthetics Using Partially Hydrolyzed Corn Cob Fiber

Adding partially hydrolyzed corn cob fiber produces baked products with sucrose-like aesthetics.

Muffin batter mixes were prepared according to the formulation in Table 1.

TABLE 1
Recipe of Muffin Batter Mixes

| Ingredients | Weight (g) |
|---|---|
| Soluble saccharide and insoluble | 105.75 |
| saccharide/fiber mixture | |
| Unsalted butter | 105.75 |
| Eggs | 94.5 |
| Self-rising flour | 74.25 |
| Baking Powder | 2.25 |
| Vanilla Extract | 9 |

Xylo-oligosaccharides/cellobiose (7:1) was used as the soluble oligosaccharide. Partially hydrolyzed corn cob biomass/fiber was used as the insoluble saccharide/fiber. Corn cob biomass containing lignin and xylan (see table 14 for cellulose, hemicellulose and lignin components of different biomasses) with various sizes and shapes were ground to defined particle size. The residual material from the manufacturing process was termed partially hydrolyzed fiber. Various ratios of soluble oligosaccharide and partially hydrolyzed fiber were prepared by mixing xylo-oligosaccharides/cellobiose (7:1) with partially hydrolyzed corn cob fiber according to Table 2A.

TABLE 2A
Ratios of Xylo-Oligosaccharides/Cellobiose and Partially
Hydrolyzed Corn Cob Fiber for the Muffin Batter Mix

| | | Insoluble saccharide/ | |
|---|---|---|---|
| | Soluble saccharide: Xylo- | fiber:Partially | |
| % of | oligosaccharides:cellobiose | Hydrolyzed Corn | Total % |
| Fiber | (7:1) (g) | Cob Fiber (g) | of Fiber |
| 0 | 105.8 | 0 | 0 |
| 5 | 100.5 | 5.3 | 1.4 |
| 10 | 95.2 | 10.6 | 2.7 |
| 15 | 89.9 | 15.9 | 4.1 |
| 20 | 84.7 | 21.1 | 5.4 |
| 25 | 79.3 | 26.5 | 6.8 |
| 30 | 74 | 31.8 | 8.1 |
| 35 | 68.8 | 37.0 | 9.5 |
| 40 | 63.5 | 42.3 | 10.8 |
| 45 | 58.2 | 47.6 | 12.2 |
| 50 | 52.9 | 52.9 | 13.5 |

To prepare the muffin batter mix, all ingredients except for the soluble and insoluble saccharide/fiber were combined to form a base. 3134.25 g base was prepared to allow for 11 individual muffin batter mixes. For each muffin batter mix, 285.7 g base was mixed with 105.75 soluble oligosaccharide and insoluble saccharide/fiber mixture. Each muffin batter mix was then divided for 6 muffin cups (each muffin weighed 50 g) and was baked for 20 minutes at 170° C.

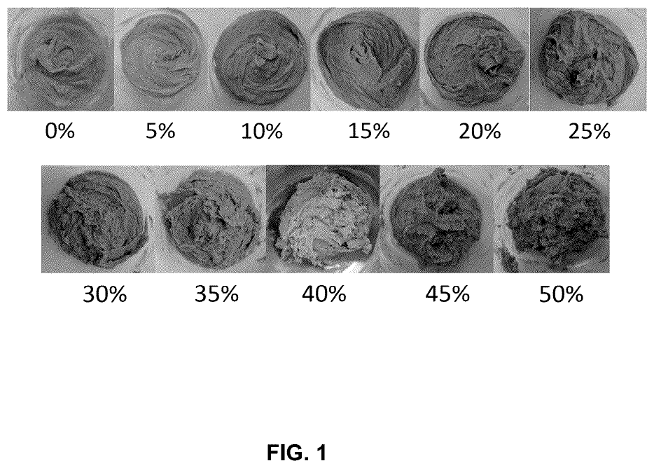

As shown in FIG. 1, increasing the amount of partially hydrolyzed corn cob fiber in the muffin batter mix produced increasingly dark mixes. Increasing the amount of fiber also made the consistency of the batter more difficult to mix. The amount of partially hydrolyzed corn cob fiber did not cause the batter to become gummy. The muffin batter mixes with 0 dry wt. % to 20 dry wt. % of partially hydrolyzed corn cob fiber were softer and thinner than mixes with higher amounts of partially hydrolyzed corn cob fiber. Further, the batter mixes with ≥25 dry wt. % of partially hydrolyzed corn cob fiber were significantly thicker, darker, and less airy than other mixes.

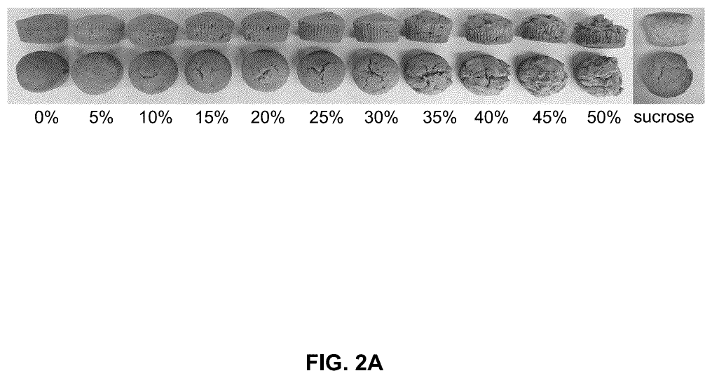

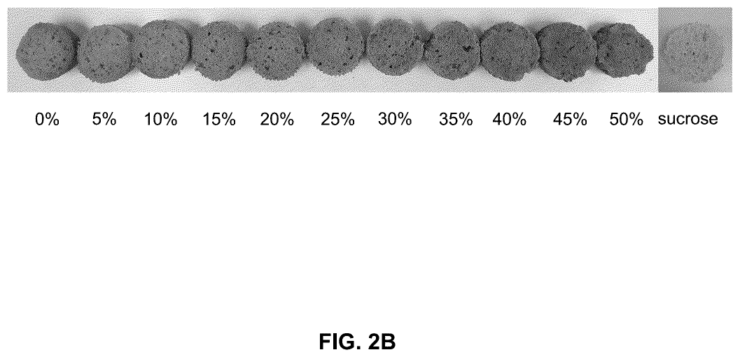

As shown in FIG. 2A and FIG. 2B, the baked muffins with 10 dry wt. % to 25 dry wt. % of partially hydrolyzed corn cob fiber were visually very similar to a regular baked muffin made with sucrose (i.e., a control muffin). The baked muffins with ≥25 dry wt. % of fiber had distorted shapes compared to that of a control muffin. The baked muffins with ≥40 dry wt. % of fiber did not rise during baking and appeared significantly different from a control muffin. The baked muffins with higher amounts of partially hydrolyzed corn cob fiber were increasingly dense and not as airy as the muffins with lower amounts of partially hydrolyzed corn cob fiber. Furthermore, the surfaces of the muffins with 10 dry wt. % to 30 dry wt. % of partially hydrolyzed corn cob fiber began to crack to various degrees, similar to a regular muffin with sucrose (a control muffin).

TABLE 2B
Nutritional values of muffins containing varying amounts of fiber in sweetener composition.

| | Values per 100 g | | | | | | | | | | |
|---|---|---|---|---|---|---|---|---|---|---|---|
| | 0% | 5% | 10% | 15% | 20% | 25% | 30% | 35% | 40% | 45% | 50% |
| | fiber * | fiber * | fiber * | fiber * | fiber * | fiber * | fiber * | fiber * | fiber * | fiber * | fiber * |
| kcal | 353 | 350 | 347 | 344 | 342 | 339 | 336 | 334 | 331 | 328 | 326 |
| Total fat | 25 | 25 | 25 | 25 | 25 | 25 | 25 | 25 | 25 | 25 | 25 |
| Saturated fat | 15 | 15 | 15 | 15 | 15 | 15 | 15 | 15 | 14.8 | 14.8 | 14.8 |
| Total | 42.2 | 42.2 | 42.2 | 42.2 | 42.2 | 42.2 | 42.2 | 42.2 | 42.2 | 42.2 | 42.2 |
| carbohydrate | | | | | | | | | | | |
| Dietary fiber | 0.76 | 2.1 | 3.5 | 4.8 | 6.1 | 7.5 | 8.9 | 10.2 | 11.6 | 12.9 | 14.3 |
| Total sugars | 27.4 | 26.1 | 24.7 | 23.4 | 22 | 20.7 | 19.3 | 18 | 16.6 | 15.3 | 13.9 |
| Protein | 4.9 | 4.9 | 4.9 | 4.9 | 4.9 | 4.9 | 4.9 | 4.9 | 4.9 | 4.9 | 4.9 |

* In sweetener composition

The addition of partially hydrolyzed corn cob fiber can help reduce the calorific content per 100 g of the finished product as well as increase the amount of dietary fiber in the diet (Table 2B), that is known to have beneficial health effects. However, at a certain level of fiber inclusion in a sweetener composition that will be used to make a finished product, the finished product is unlikely to be accepted by a consumer due to product aesthetics. Example 1 demonstrates that the threshold for fiber inclusion in a sweetener composition that will be used to make a finished product, while maintaining consumer acceptance, is around 25% w/w.

### Example 2—Water Retention in Baked Goods with Partially Hydrolyzed Insoluble Fiber

Adding partially hydrolyzed fibers aids water retention in baked products.

To measure water retention in the baked goods, 6 muffin cups per percent of fiber, as outlined in Table 2A, were filled with 50 g of muffin batter mixes according to Table 1. The average of the weight loss (WL) per condition after baking was used to measure the water loss in the baked goods. The weights of the baked muffins were measured 10 minutes after baking was complete. The WL was calculated using the following formula: WL (%)=(Wi−Wf)/Wi×100%, wherein Wi and Wf are the initial weight and weight of the muffin 10 minutes post-baking, respectively.

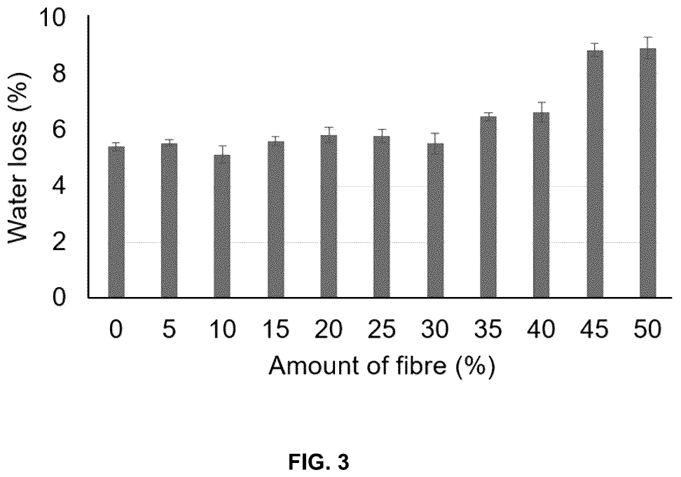

As shown in FIG. 3, on average, about 5.1% to 8.9% water was lost from the baked muffins 10 minutes after the muffins were taken out of the oven. A similar water loss, about 5.1%, was observed for baked muffins with 0 dry wt. % to 30 dry wt. % of partially hydrolyzed fiber. Increasing amounts of water loss were observed when the amount of partially hydrolyzed fiber reached 35 dry wt. % in the baked muffin. The highest amount of water loss was observed in the baked muffin with 45 dry wt. % or 50 dry wt. % of partially hydrolyzed fiber.

### Example 3—Maintenance of Texture in Baked Goods with Partially Hydrolyzed Corn Cob Fiber

Adding partially hydrolyzed corn cob fiber allows baked products to maintain texture.

To measure texture in the baked goods, the firmness and springiness of the baked muffins were measured with a probe pressing the baked muffins from the top. Firmness is defined as the force (in grams, kilograms, or Newtons) required to compress the product by a pre-set distance. Springiness, or percent recovery, is the force (F) exerted on the probe after 30 seconds divided by the maximum force. Springiness is given by the following formula:

% recovery=F(30 seconds)/F(max)×100%.

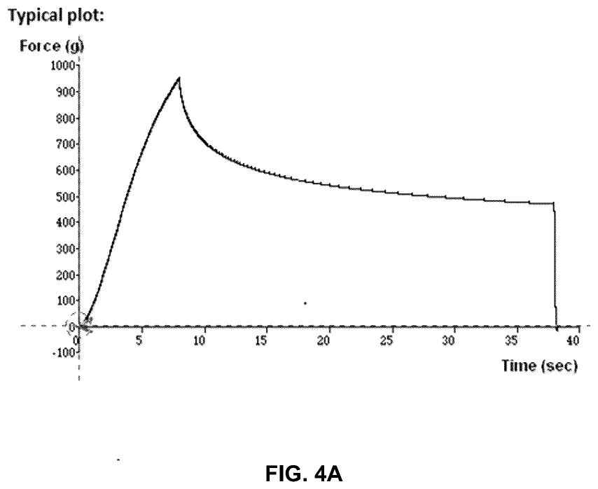

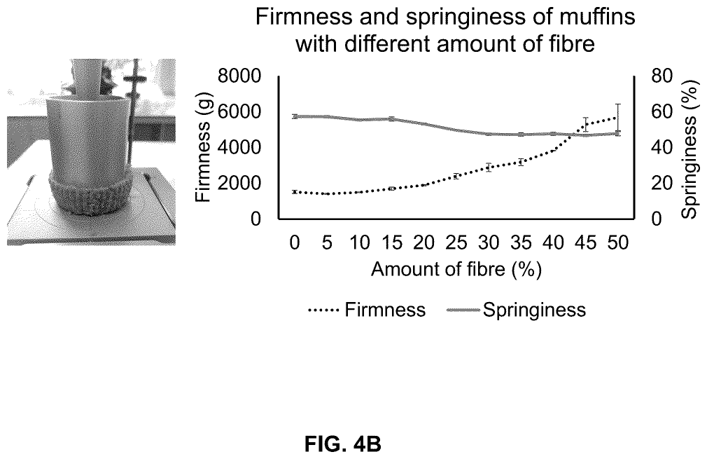

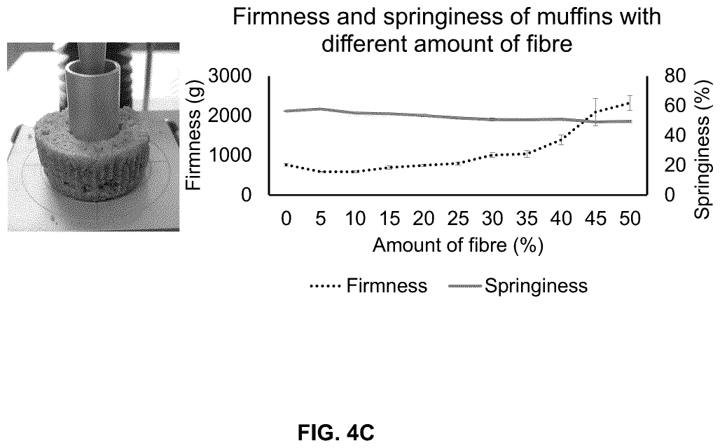

The higher the percent recovery, the more spring-like a product is. A typical force analysis plot is shown in FIG. 4A. The firmness and springiness of each baked muffin was derived from the plot for each muffin.

Before the analysis, muffin cases were removed. All the muffins assayed had the top part cut out to ensure a flat surface and uniform height for each muffin. To ensure the uniform height, the cut muffin was measured with a caliper. During the analysis, the cut muffin was positioned centrally under the probe. Each condition, or percent inclusion of partially hydrolyzed corn cob fiber, was assayed and measured in triplicate. The data acquisition rate was set at 500 points per second (PPS). The strain of the target was set to be 25%. The probe compressed the sample until it had compressed 25% of the product height (15 mm). The probe was held at this distance for 30 seconds and then withdrawn from the sample to return to the starting position. Two examples of the probes used are shown in FIGS. 4B and 4C. The probe shown in FIG. 4B is a P/2″ (2-inch) probe.

Muffins made according to the methods described in Example 1 were tested. As shown in FIGS. 4B and 4C, there was no significant difference in the firmness between the muffins with 0 dry wt. % to 15 dry wt. % of partially hydrolyzed corn cob fiber. A slight increase of firmness was observed for the muffin with 20 dry wt. % of partially hydrolyzed corn cob fiber. Further increasing the amount of partially hydrolyzed corn cob fiber from 25 dry wt. % to 50 dry wt. % significantly increased the firmness of the muffin. For springiness, there was no significant difference between the muffins with 0 dry wt. % to 15 dry wt. % of fiber. Slight decreases of springiness were observed for the muffins with 20 dry wt. % and 25 dry wt. % of partially hydrolyzed corn cob fiber. Further increasing the amount of partially hydrolyzed corn cob fiber to 30 dry wt. % significantly decreased the springiness of the muffin. There was no significant difference in the springiness for muffins with 30 dry wt. % to 50 dry wt. % partially hydrolyzed corn cob fiber. Similar measurements were made using a probe with a smaller size. Under these test conditions, the muffins with 0 dry wt. % to 25 dry wt. % of partially hydrolyzed corn cob fiber had a similar firmness.

### Example 4—Maintenance of Sensation in Baked Goods with Partially Hydrolyzed Corn Cob Fiber

Adding partially hydrolyzed corn cob fibers allows baked goods to maintain a sensory profile similar to that of a regular baked good (i.e., a control baked good).

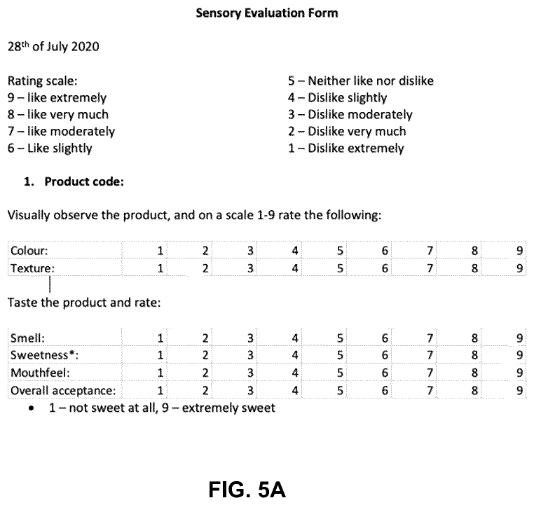

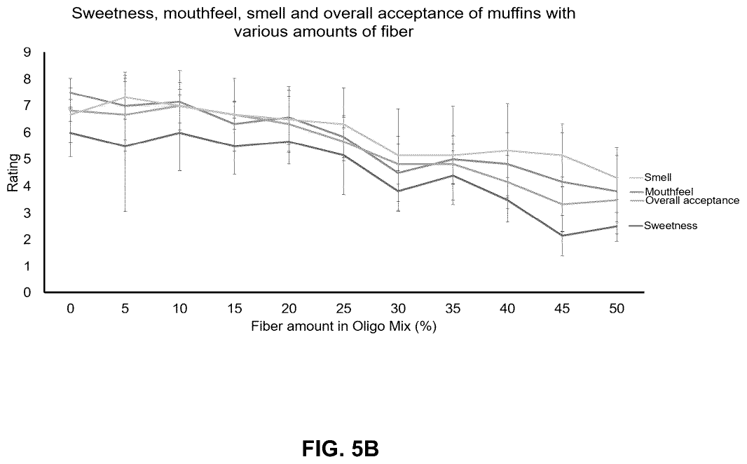

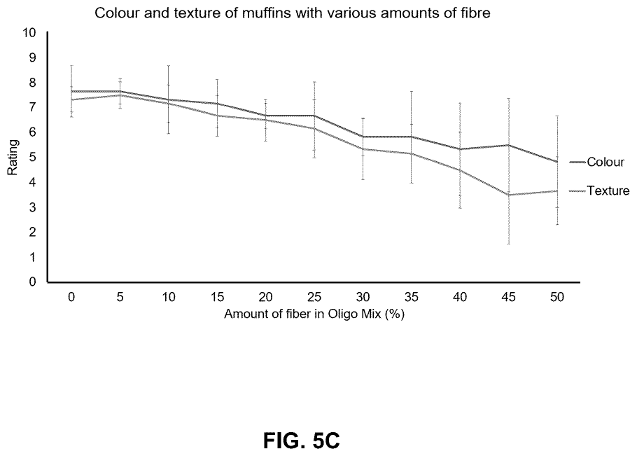

To measure sensory profile of a baked good, 13 people were given baked muffins with different percent inclusion of partially hydrolyzed corn cob fiber for consumption. They then ranked the color, texture, smell, sweetness, mouthfeel, and overall acceptance of the muffins on a scale of 1-9 (from least to most preferred). For sweetness, the scale of 1-9 is from not sweet at all to most sweet. Color and texture were evaluated visually. Overall acceptance was ranked after the tasting. A sensory evaluation form is shown in FIG. 5A.

The average ranking of each parameter is shown in FIGS. 5B and 5C. Overall, there was no impact to the muffin with 15 dry wt. % to 25 dry wt. % of insoluble saccharide/fiber. For sweetness, smell, mouthfeel, and overall acceptance, no significant difference in ratings was observed for muffins with 0% to 15% (0% to 20% for sweetness) of partially hydrolyzed corn cob fiber. Further increasing the amount of partially hydrolyzed corn cob fiber decreased every rating. For color and texture, no significant difference in ratings was observed for muffins with 0 dry wt. % and 5 dry wt. % of partially hydrolyzed corn cob fiber. Further increasing the amount of partially hydrolyzed corn cob fiber decreased the rating. Muffins with lighter color were preferred over those with darker color.

### Example 5—Production of Baked Goods with Sucrose-Like Aesthetics Using Microcrystalline Cellulose (MCC) as Partially Hydrolyzed Fiber

Adding MCC fiber as partially hydrolyzed fiber produces baked products with sucrose-like aesthetics.

Cookie dough mixes were prepared according to the formulation in Table 3.

TABLE 3
Recipe of a 25-g Cookie Dough Mix

| Ingredients | Weight (g) |
|---|---|
| Soluble saccharide and insoluble | 9.7 |
| saccharide/fiber mixture | |
| Unsalted butter | 5.2 |
| Eggs | 2.3 |
| Vanilla Bean Paste | 0.5 |
| Plain Flour | 7.2 |
| Baking Soda | 0.2 |

Xylo-oligosaccharide/cellobiose (7:1) was used as the soluble oligosaccharide. MCC fiber was used as the partially hydrolyzed fiber. Various ratios of soluble oligosaccharide and partially hydrolyzed fiber were prepared by mixing xylo-oligosaccharides/cellobiose (7:1) with MCC fiber according to Table 4A.

TABLE 4A
Ratios of Xylo-Oligosaccharides/Cellobiose and MCC Partially
Hydrolyzed Fiber for a 25-g Cookie Dough Mix

| | Soluble saccharide: Xylo- | Insoluble Saccharide/ |
|---|---|---|
| % of | oligosaccharides:cellobiose | Fiber:MCC Partially |
| Fiber | (7:1) (g) | Hydrolyzed Fiber (g) |
| 0 | 9.7 | 0 |
| 5 | 9.21 | 0.49 |
| 10 | 8.73 | 0.97 |
| 15 | 8.24 | 1.46 |
| 20 | 7.76 | 1.94 |
| 25 | 7.28 | 2.43 |
| 30 | 6.79 | 2.91 |
| 35 | 6.30 | 3.40 |
| 40 | 5.82 | 3.88 |
| 45 | 5.33 | 4.37 |
| 50 | 4.85 | 4.85 |

To prepare a cookie dough mix, the soluble saccharides and partially hydrolyzed fiber were mixed in a blender. The butter, eggs, vanilla bean paste, flour, and baking soda were added to the mixture. Materials enough for 10 cookies were prepared for each sample set. 25 g of the resultant cookie dough mix was placed on a baking tray. The diameter and height of the 25 g cookie dough were measured. The cookies were baked for 12 minutes at 180° C.

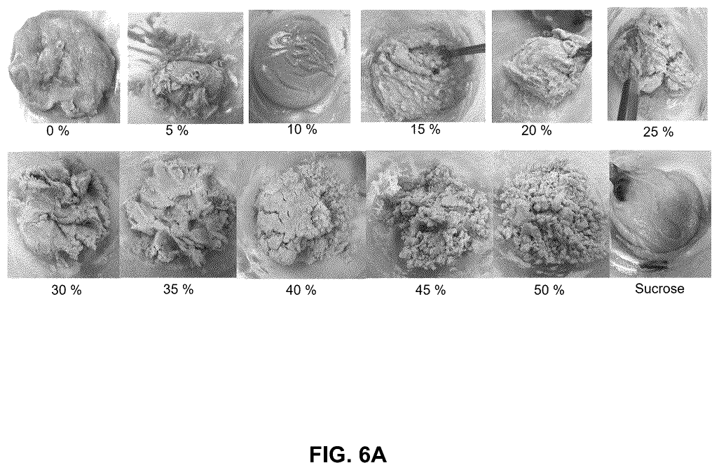

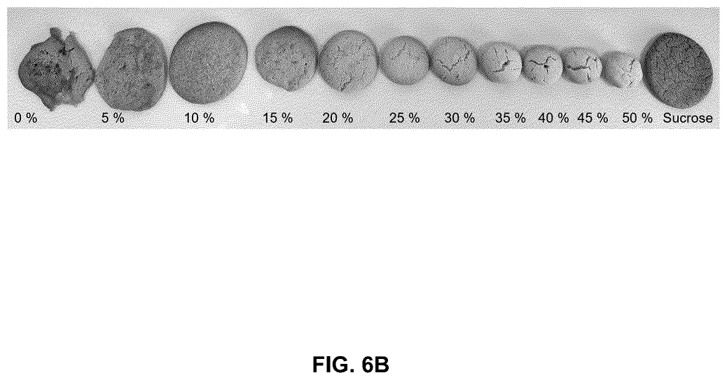

As shown in FIG. 6A, cookie dough mixes with less than 20 dry wt. % of MCC partially hydrolyzed fiber looked similar to those cookies made with sucrose. The cookie dough mixes with more than 35 dry wt. % of MCC partially hydrolyzed fiber were visibly crumbly. Example whole baked cookies from the dough mixes depicted in FIG. 6A are shown in FIG. 6B. The cookies obtained with 10 dry wt. % to 20 dry wt. % of MCC partially hydrolyzed fiber were most similar to those obtained with sucrose. The cookies with 0 dry wt. % and 5 dry wt. % of MCC partially hydrolyzed fiber had an irregular shape and spread excessively. With more than 20 dry wt. % of MCC partially hydrolyzed fiber, the dispersibility of chewy cookies decreased. Increasing the amount of MCC partially hydrolyzed fiber in the cookie dough also lightened the color of the cookies. With more than 30 dry wt. % of MCC partially hydrolyzed fiber, the surfaces of the final cookies began to crack.

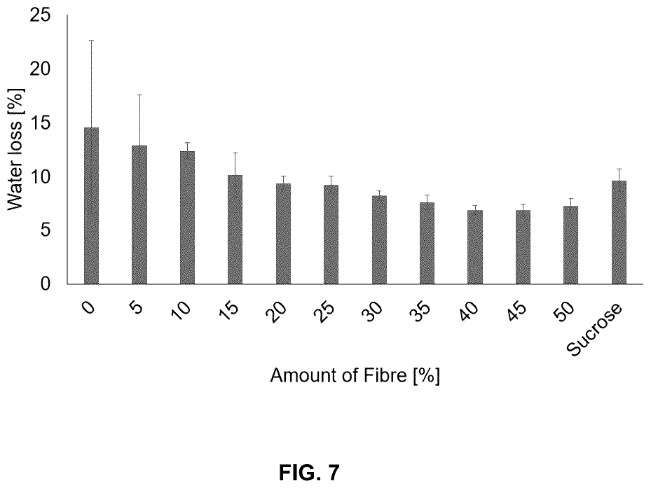

The water loss of the baked cookies was measured using the method of Example 2. As shown in FIG. 7, increasing the amount of MCC partially hydrolyzed fiber in the cookie dough decreased the water loss. Cookies with 10 dry wt. % to 25 dry wt. % MCC partially hydrolyzed fiber lost a similar amount of water as that of the cookie obtained with sucrose, while the cookie without any fiber lost the most water.

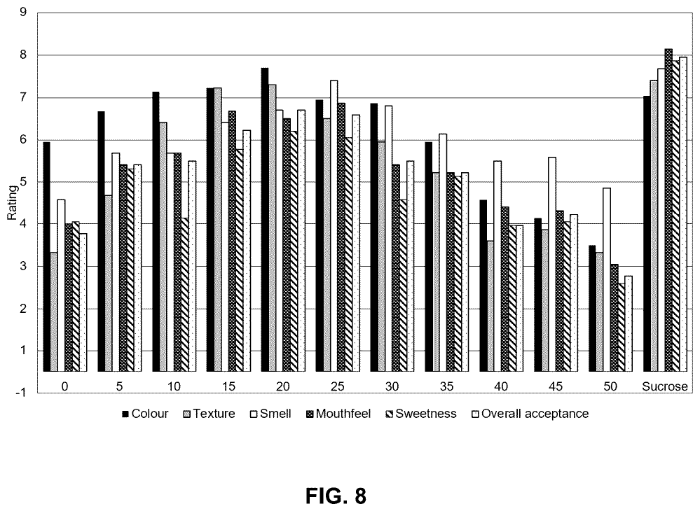

The sensory profiles of the cookies were examined using the method of Example 4. As shown in FIG. 8, the cookies with 10% to 25% fiber had consumer acceptance ratings most similar to those obtained with sucrose.

TABLE 4B
Nutritional values of muffins containing varying amounts of fiber in sweetener composition.

| | Values per 100 g | | | | | | | | | | |
|---|---|---|---|---|---|---|---|---|---|---|---|
| | 0% | 5% | 10% | 15% | 20% | 25% | 30% | 35% | 40% | 45% | 50% |
| | fiber * | fiber * | fiber * | fiber * | fiber * | fiber * | fiber * | fiber * | fiber * | fiber * | fiber * |
| kcal | 349 | 345 | 341 | 337 | 333 | 329 | 326 | 322 | 318 | 314 | 310 |
| Total fat | 18 | 18 | 18 | 18 | 18 | 18 | 18 | 18 | 18 | 18 | 18 |
| Saturated fat | 11.2 | 11.2 | 11.2 | 11.2 | 11.2 | 11.2 | 11.2 | 11.2 | 11.2 | 11.2 | 11.2 |
| Total | 62.6 | 62.6 | 62.6 | 62.6 | 62.6 | 62.6 | 62.6 | 62.6 | 62.6 | 62.6 | 62.6 |
| carbohydrate | | | | | | | | | | | |
| Dietary fiber | 1.1 | 3.1 | 5 | 7 | 8.9 | 10.8 | 12.7 | 14.7 | 16.6 | 18.6 | 20.5 |
| Total sugars | 40 | 38.2 | 36.3 | 34.4 | 32.5 | 30.5 | 28.6 | 26.6 | 24.7 | 22.8 | 20.9 |
| Protein | 4.1 | 4.1 | 4.1 | 4.1 | 4.1 | 4.1 | 4.1 | 4.1 | 4.1 | 4.1 | 4.1 |

* In sweetener composition

The addition of partially hydrolyzed MCC fiber can help reduce the calorific content per 100 g of the finished product as well as increase the amount of dietary fiber in the diet (Table 4B), that is known to have beneficial health effects. However, at a certain level of fiber inclusion in a sweetener composition that will be used to make a finished product, the finished product is unlikely to be attractive to a consumer due to product aesthetics. Example 5 demonstrates that the threshold for fiber inclusion in a sweetener composition that will be used to make a finished product, while maintaining consumer acceptance, was between around 10%-25% w/w.

### Example 6—Production of Baked Goods Using Unhydrolyzed Ground Corn Cob Fiber

Adding unhydrolyzed ground corn cob fiber produces baked products whose aesthetics deviate significantly from the same product made with sucrose.

Cookie dough mixes were prepared according to the formulation in Table 3.

Xylo-oligosaccharides/Cellobiose (7:1) was used as the soluble oligosaccharide. Corn cobs ground to defined particle size were used as unhydrolyzed corn cob fiber (UHF). Various ratios of soluble oligosaccharide and unhydrolyzed ground corn cob fiber were prepared by mixing xylo-oligosaccharides/cellobiose (7:1) with UHF as shown in Table 5A.

TABLE 5A
Ratios of Xylo-Oligosaccharide/Cellobiose
and UHF for a 25-g Cookie Dough Mix

| | | | Total Weight |
|---|---|---|---|
| | | | of the Soluble |
| | | | Oligosaccharide |
| | Soluble saccharide: Xylo- | Insoluble | and Insoluble |
| % of | oligosaccharide:cellobiose | Saccharide/ | Saccharide/Fiber |
| Fiber | (7:1) (g) | Fiber:UHF (g) | Mixture (g) |
| 0 | 9.7 | 0 | 9.7 |
| 10 | 8.73 | 0.97 | 9.7 |
| 15 | 8.24 | 1.46 | 9.7 |
| 20 | 7.76 | 1.94 | 9.7 |
| 40 | 5.82 | 3.88 | 9.7 |

To prepare a cookie dough mix, the soluble and unhydrolyzed ground corn cob fiber were mixed with butter, eggs, vanilla bean paste, flour, and baking soda. Materials enough for 10 cookies were prepared for each sample set. 25 g of the resultant cookie dough mix was placed on a baking tray. The diameter and height of the 25 g cookie dough was measured. The cookies were baked for 12 minutes at 180° C.

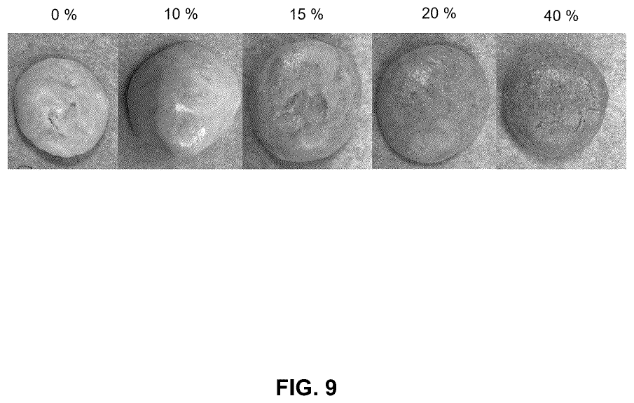

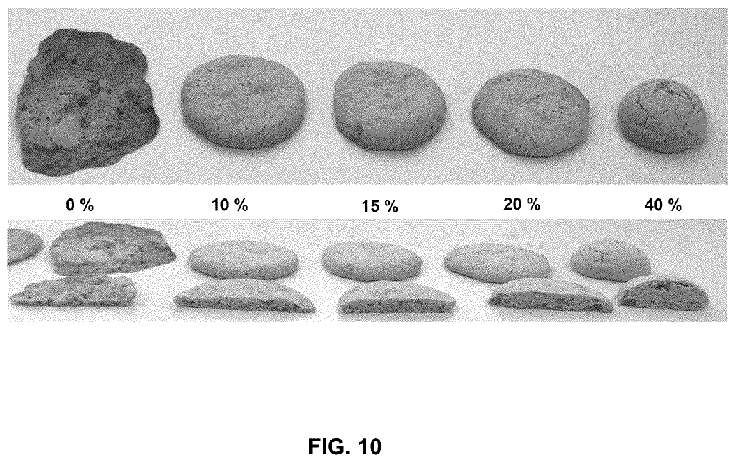

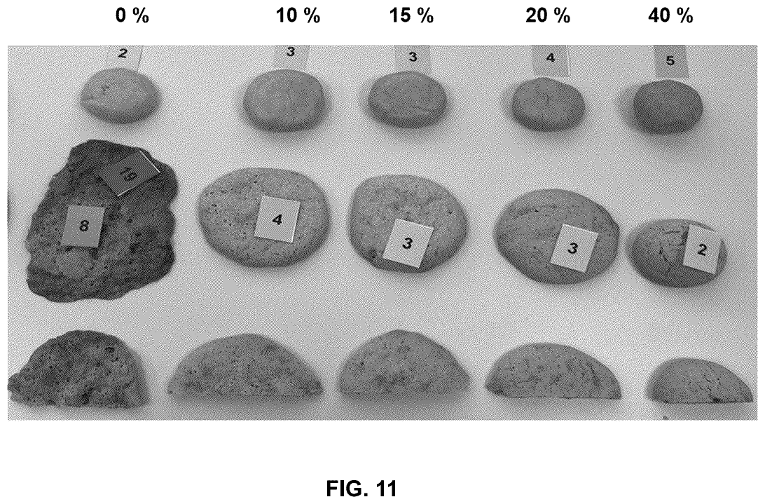

As shown in FIG. 9, the fiber particles could be seen in the cookie dough mix prior to baking. FIG. 10 shows the whole baked cookies with various amounts of UHF. The cookies with 10 dry wt. % to 20 dry wt. % UHF were most similar to those with MCC partially hydrolyzed fiber and sucrose, as described in Example 5. However, unlike the cookies with MCC partially hydrolyzed fiber and sucrose, the UHF was visible in the final cookie, a feature that would not be attractive to a consumer. As shown in FIG. 11, increasing the amount of UHF increased the lightness/paleness of the whole baked cookie. The opposite trend was observed with the unbaked cookie dough mix.

### Example 7—Comparing Baked Products with Different Types of Fiber

Cookies made with partially hydrolyzed corn cob fiber, MCC partially hydrolyzed fiber, and UHF were compared.

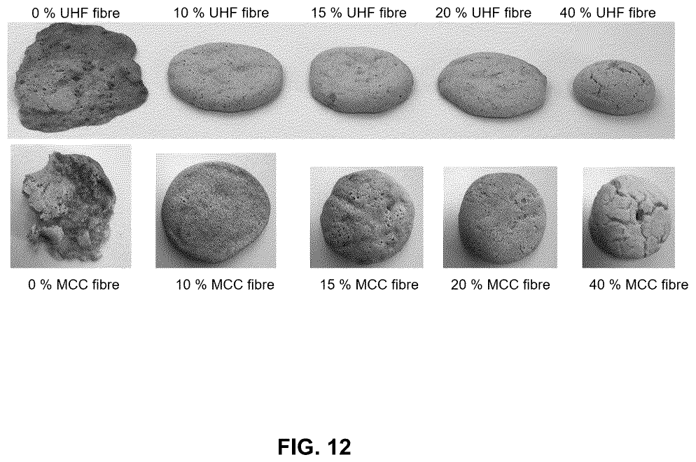

FIG. 12 compares the whole baked cookies with different amounts of UHF and MCC partially hydrolyzed fiber. In both cases, the spreadability of the baked cookie decreased with an increasing amount of fiber.

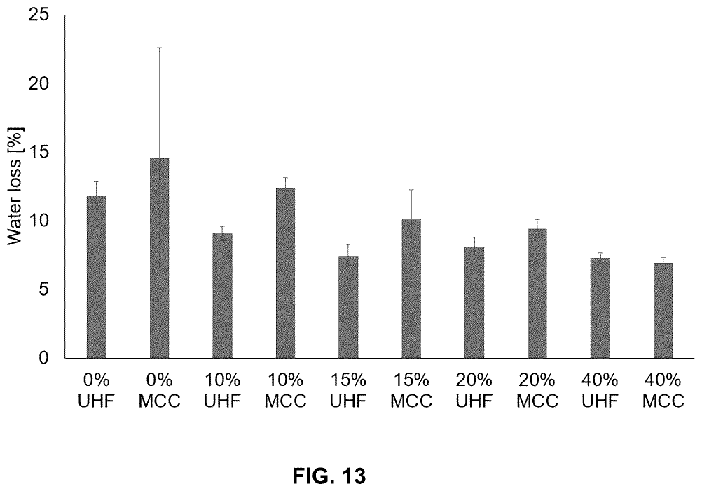

The water loss of the baked cookies was measured using the method of Example 2. As shown in FIG. 13, increasing the amount of either fiber (UHF or MCC fiber) in the cookie decreased the water loss. Water loss was greater in cookies made with MCC partially hydrolyzed fiber than those made with UHF. The appropriate amount of water loss is important during the baking process to prevent the final product from being too dry or too moist, that may affect shelf life.

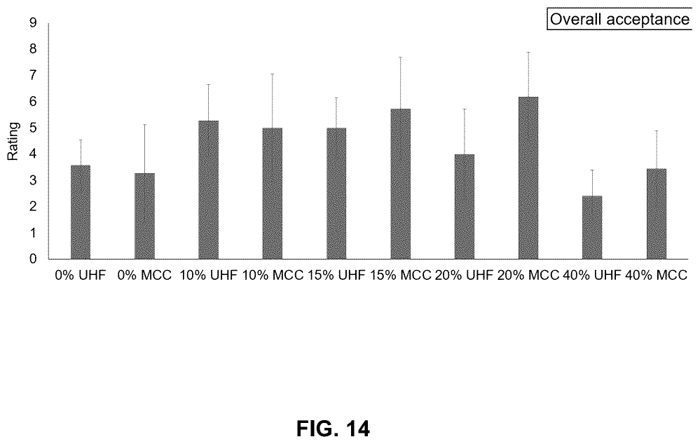

The sensory profiles of the cookies were examined using the method of Example 4. As shown in FIG. 14, the cookies made with at least 15 dry wt. % of MCC partially hydrolyzed fiber had improved consumer acceptance over those made with UHF.

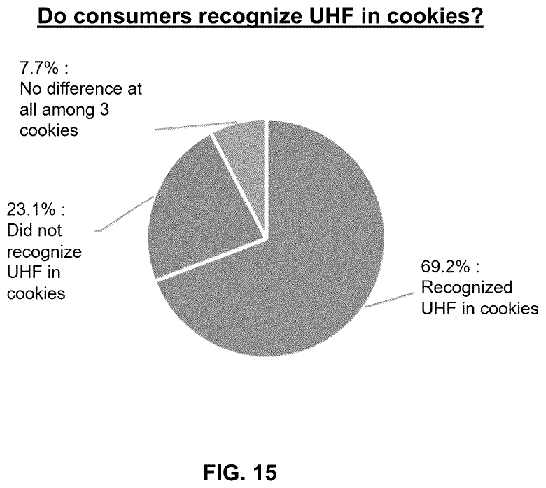

Cookies made with (a) 20 dry wt. % of UHF; (b) 20 dry wt. % of partially hydrolyzed corn cob fiber; and (c) 20 dry wt. % of MCC partially hydrolyzed fiber were compared. As shown in FIG. 15, 69.2% of respondents could recognize UHF in the baked cookies. 23.1% of respondents could not recognize UHF in the cookies, and 7.7% of respondents could not notice a different between the three different cookies.

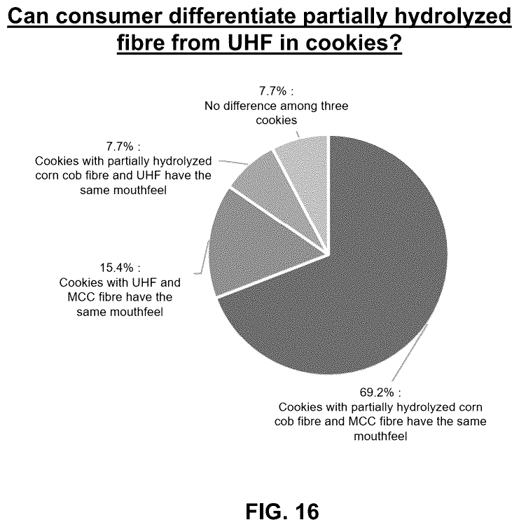

As shown in FIG. 16, when asked if they could differentiate partially hydrolyzed corn cob fiber or MCC partially hydrolyzed fiber from UHF in the baked cookies, only 23% (n=3/13) of respondents could not differentiate between cookies made with MCC partially hydrolyzed fiber or partially hydrolyzed corn cob fiber. 69.2% of respondents noticed that the two cookies with partially hydrolyzed corn cob fiber and MCC partially hydrolyzed fiber had the same mouthfeel and described them as smooth and soft. Only 15.4% of respondents suggested that cookies made with UHF fiber had the same mouthfeel as those made with MCC partially hydrolyzed fiber and described them as sticky and crumbly. 7.7% of respondents indicated that cookies made with UHF had the same mouthfeel as those made with partially hydrolyzed corn cob fiber. 7.7% of respondents indicated that all cookies had the same mouthfeel.

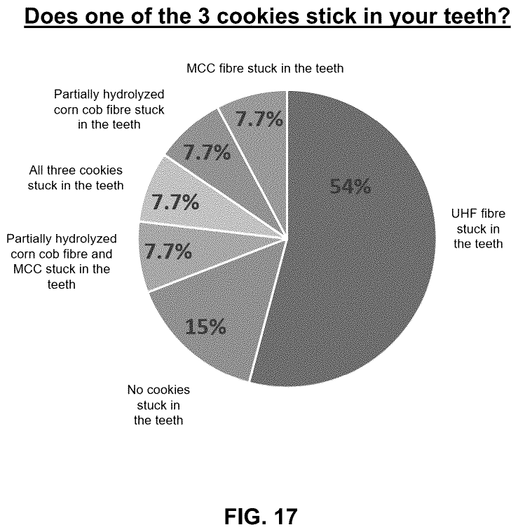

When asked if any of the three cookies stuck in their teeth, only 23% (n=3/13) of respondents could not differentiate between cookies made with MCC partially hydrolyzed fiber or partially hydrolyzed corn cob fiber. As shown in FIG. 17, 54% of respondents indicated that the cookie made with UHF stuck in the teeth. 15% of respondents indicated that none of the cookies stuck in their teeth. 7.7% of respondents indicated that cookies made with either MCC partially hydrolyzed fiber or partially hydrolyzed corn cob fiber stuck in their teeth. 7.7% of respondents indicated that all cookies stuck in their teeth. 7.7% of respondents indicated that cookies made with partially hydrolyzed corn cob fiber stuck in the teeth. And 7.7% of respondents indicated that cookies made with MCC partially hydrolyzed fiber stuck in their teeth.

### Example 8—Determining the Water Retention Capacity of Insoluble Saccharide/Fiber

An assay was developed to measure the water retention capacity of insoluble saccharide/fiber.

Fiber powders (250 mg) were aliquoted in a 50 ml centrifuge tube. 25 mL of distilled water was added to the tube and the fiber powder was hydrated for 1 hour. The sample was centrifuged for 10 minutes at 4,000×g. The supernatant was discarded, and the weight of residue was measured. Water retention capacity was expressed as the amount of water retained per gram of dry sample (g/g of dry matter), as described in Lecumberri, et al. 2007 “A diet rich in dietary fiber from cocoa improves lipid profile and reduces malondialdehyde in hypercholesterolemic rats” Nutrition 2007 April; 23(4):332-41, which is herein incorporated by reference in its entirety for all purposes. For MCC partially hydrolyzed fiber the water retention capacity (WRC) was 2.41 g/g For partially hydrolyzed corn cob fiber the WRC was 3.08 g/g. For partially hydrolyzed oat fiber the WRC was 4.79 g/g. For unhydrolyzed corn cob fiber the WRC was 5.24 g/g. For unhydrolyzed oat fiber the WRC was 5.00 g/g (Table 5B). The water retention capacity was reduced in the partially hydrolyzed fibers vs the corresponding unhydrolyzed fiber. Water retention capacity is an important feature of food ingredients and can be modulated in a final product to achieve acceptable sensory consumer perception and also shelf life of the product. The higher water retention capacity of the unhydrolyzed corn cob fiber is implicated in the lower preference of final products containing this fiber by consumers.

TABLE 5B
Water retention capacity (WRC) of unhydrolyzed
and partially hydrolyzed fibers.

| Samples | WRC [g/g] |
|---|---|
| MCC partially hydrolyzed fiber | 2.41 |
| Partially hydrolyzed corn cob fiber | 3.08 |
| Partially hydrolyzed oat fiber | 4.79 |
| Unhydrolyzed corn cob fiber (UHF) | 5.24 |
| Unhydrolyzed oat fiber | 5.00 |

### Example 9—Decreasing the Fiber Size of Insoluble Saccharide/Fiber in Baked Goods

Insoluble saccharides/fibers with decreasing fiber sizes are used to prepare baked muffin/cookie according to the methods in Examples 1, 5, or 6. 20% milled corn cob biomass of different fiber sizes are used. Because baked muffins with large fibers are generally not preferred, the fibers are partially hydrolyzed before baking. The water retention, texture, and the sensory profiles of the resultant muffins are assayed as those described in Examples 2, 3, and 4, respectively.

### Example 10—Baked Goods with Different Insoluble Saccharide/Fiber Types

Different insoluble saccharides/fibers, such as milled corn cob, MCC, or any of those described herein, are mixed to prepare baked muffins or cookies according to the methods in Examples 1, 5, or 6. The water retention, texture, and the sensory profiles of the resultant muffins are assayed as those described in Examples 2, 3, and 4, respectively.

### Example 11—Baked Goods with Partially Hydrolyzed Insoluble Saccharide/Fiber and Different Soluble Saccharides

Different soluble saccharides, such as cane sugar, erythritol, or any of those described herein, are mixed with insoluble saccharide/fiber to prepare baked muffins or cookies according to the method in Examples 1, 5, or 6. The water retention, texture, and the sensory profiles of the resultant muffins are assayed as those described in Examples 2, 3, and 4, respectively.

### Example 12—Comparing Baked Products Made with Fibers of Various Processing Methods and Particle Sizes

Cookies made with 20% partially hydrolyzed corn cob fiber, 20% MCC partially hydrolyzed fiber, 20% UHF with particle sizes <200 μm, and 20% UHF with particle sizes <500 μm were compared. The appearance and mouthfeel of the cookies were assessed. Partial hydrolysis of corn cob fiber generates fiber particles with a D50 of about 52 μm. Side-by-side comparisons suggests that even with a similar particle size, the baked goods made with partially hydrolyzed corn cob fiber are more palatable than those made with unhydrolyzed corn cob fiber (UHF).

The partially hydrolyzed corn cob fiber was produced according to Example 1.

To obtain UHF with particle sizes of <200 μm or <500 μm, UHF was blended in a blender to break down the particle size. The blended UHF was then passed through a series of sieves with decreasing sieve aperture sizes. The proportion UHF particles retained by different sieve sizes is summarized in Table 6.

TABLE 6
The amount of UHF particles retained
by different sieve aperture sizes

| Sieve | Weight of UHF | Weight of UHF |
|---|---|---|
| aperture size | particles retained | particles retained |
| (μm) | (g) | (%) |
| 710 | 1.33 | 0.4 |
| 500 | 62.91 | 21.3 |
| 355 | 119.31 | 40.4 |
| 200 | 85.06 | 28.8 |
| 100 | 15.96 | 5.4 |
| 53 | 8.72 | 2.9 |
| Ground Fines | 2.38 | 0.8 |

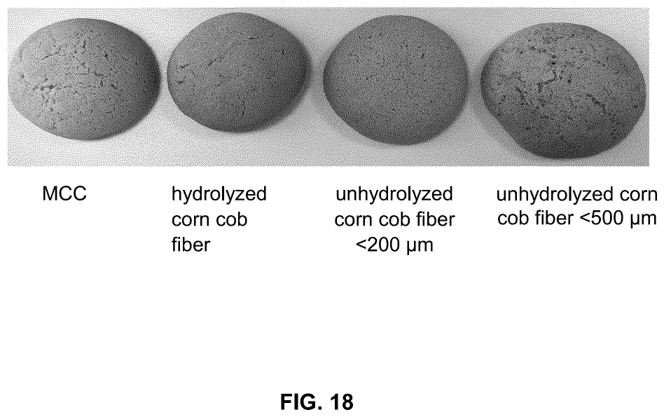

FIG. 18 shows cookies made with MCC partially hydrolyzed fiber, partially hydrolyzed corn cob fiber, UHF with particle sizes of <200 μm, UHF with particle sizes of <500 μm.

The cookies were made with cookie doughs with 20% insoluble saccharide/fiber according to Table 4A. The cookies were baked according to the methods in Example 6. As shown in FIG. 18, whole baked cookies made with partially hydrolyzed and unhydrolyzed fiber with similar particle sizes had a similar appearance. The cookie with UHF with particle sizes of <500 μm spread more than those with a smaller fiber particle. The cookies made with MCC partially hydrolyzed fiber, partially hydrolyzed corn cob fiber, and <200 μm UHF particles spread similarly. The cookie made with <500 μm UHF particles spread the most. Because of its high spreadability, the cookie also had the darkest surface color among all cookies.

The cookies were given to 13 respondents. They were asked to describe their mouthfeel. A summary of the description of the mouthfeel of the cookies by the respondents is given in Tables 7, 8, 9 and 10.

TABLE 7
A description of the mouthfeel of cookies made
with 20% partially hydrolyzed corn cob fiber

| Respondent | Description of the mouthfeel of the cookie |
|---|---|
| #1 | “A bit dry, smooth and soft texture” |
| #2 | “Crunchy, drying” |
| #3 | “Good texture, crispy outside” |
| #4 | “Not too dry, but leave dryness (sandy) aftertaste/feeling” |
| #5 | “Dry” |
| #6 | “Soft” |
| #7 | “Smooth with slightly gritty after feeling” |
| #8 | “Smooth, slightly cakey” |
| #9 | “Dry, little bit sticky” |
| #10 | “Dry, crumbly” |
| #11 | A little bit chewy, seems more soluble |
| #12 | “Soft, but tough bite, slight crunch, more chewy” |
| #13 | “Sticky” |

TABLE 8
A description of the mouthfeel of cookies made
with 20% MCC partially hydrolyzed fiber

| Respondent | Description of the mouthfeel of the cookie |
|---|---|
| #1 | “Smooth, soft, less dry than <200 μm and hydrolyzed corn |
| | cob, no sandy mouthfeel” |
| #2 | “Crunchy” |
| #3 | “Cakey inside, outside crispy, smooth texture” |
| #4 | Quite similar to hydrolyzed corn cob fiber but not as dry + |
| | not much dryness after taste” |
| #5 | “Dry” |
| #6 | “Harder, crunchy” |
| #7 | “Powdery” |
| #8 | “Smooth, slightly cakey” |
| #9 | Dry, slightly unpleasant mouth coating |
| #10 | “Dry, crumbly” |
| #11 | “Also, quite chewy, not as soft as 20% hydrolyzed corn cob |
| | fiber |
| #12 | Hard shell, crunchie inside” |
| #13 | “Hard and dry, does not stick to the teeth” |

TABLE 9
A description of the mouthfeel of cookies made
with 20% <200 μm UHF particles

| Respondent | Description of the mouthfeel of the cookie |
|---|---|
| #1 | “Bits, stuck in the throat, dry, sandy, hard to swallow” |
| #2 | “Crunchy” |
| #3 | “Sandy, bits” |
| #4 | “Brittle, dry, quite sandy” |
| #5 | “Dry” |
| #6 | “Softer, sticks less in the teeth” |
| #7 | “Gritty, slightly powdery” |
| #8 | “Gritty, sandy texture, caky biscuit, inside similar cakiness |
| | to hydrolyzed corn cob fiber and commercial MCC” |
| #9 | “Dry, little bit grainy” |
| #10 | “Dry, crumbly” |
| #11 | “Feels a bit dry, very crumble” |
| #12 | “Soft but tough bite, slight crunch, coarse bits or sandy” |
| #13 | “Dry, but sticks to the teeth” |

TABLE 10
A description of the mouthfeel of cookies made
with 20% <500 μm UHF particles

| Respondent | Description of the mouthfeel of the cookie |
|---|---|
| #1 | “Dry, has bits that cannot be dissolved in mouth, sticks to |
| | teeth, get stuck in throat” |
| #2 | “Hard initial bite then slightly chewy” |
| #3 | “Have bits, hard” |
| #4 | “Dry, bit sticky after a while” |
| #5 | “Gritty” |
| #6 | “Hard outside, softer inside, harder bits in teeth” |
| #7 | “Very gritty” |
| #8 | “Bits/chunks, crunchier texture” |
| #9 | “Crunch, little bit grainy” |
| #10 | “Gritty/lumpy and dry” |
| #11 | “More crunchy, bitty, grainy” |
| #12 | “Hard shell, softer with a crunch, coarse bits” |
| #13 | “Dry, hard, bitty” |

Overall, the respondents found that the cookie made with MCC partially hydrolyzed fibers was dry, smooth, and soft. The cookie made with partially hydrolyzed corn cob fibers was dry, smooth, and caky inside. The cookie made with <200 μm UHF particles was bitty, sandy, and gritty. The cookie made with <500 μm UHF particles was sticky and gritty, with harder bits that stuck in the teeth.

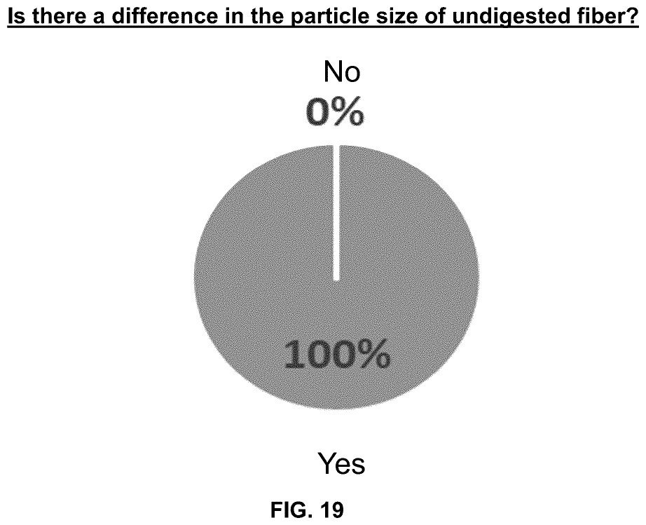

The respondents were asked if they noticed a difference in mouthfeel between the cookies made with <200 μm or <500 μm UHF particles. As shown in FIG. 19, all respondents noticed a difference in mouthfeel between the two cookies. A summary of the description of the mouthfeel of the cookies by the respondents is given in Table 11.

TABLE 11
A description of the difference in mouthfeel between the
cookie made with 20% UHF with <200 μm fiber particles
and one made with 20% UHF with <500 μm fiber particles

| | Is there a different between the cookies; description |
|---|---|
| Respondent | of the difference in the mouthfeel of the cookies |
| #1 | “Yes; mouthfeel of the cookie made with <500 μm UHF |
| | fiber particles is worse, bigger bits” |
| #2 | “Yes; mouthfeel of the cookie made with <500 μm UHF |
| | fiber particles is chewier” |
| #3 | “Yes; mouthfeel of the cookie made with <500 μm UHF |
| | fiber particles is bitty, sticky, clumpy” |
| #4 | “Yes; mouthfeel of the cookie made with <500 μm UHF |
| | fiber particles is a bit sticky after a while and stick on your |
| | teeth” |
| #5 | “Yes; mouthfeel of the cookie made with <500 μm UHF |
| | fiber particles is better” |
| #6 | “Yes; mouthfeel of the cookie made with <500 μm UHF |
| | fiber particles is more lumpy” |
| #7 | “Yes; mouthfeel of the cookie made with <500 μm UHF |
| | fiber particles is much gritter than that made with <200 μm |
| | UHF particles” |
| #8 | “Yes; mouthfeel of the cookie made with <200 μm UHF |
| | fiber particles is gritty, cookies made with have larger bits” |
| #9 | “Yes; mouthfeel of the cookie made with <500 μm UHF |
| | particles is crunchier, stickier towards the end” |
| #10 | “Yes; mouthfeel of the cookie made with <500 μm UHF |
| | particles is lumpy/gritty” |
| #11 | “Yes; mouthfeel of the cookie made with <500 μm UHF |
| | particles is grainier” |
| #12 | “Yes; mouthfeel of the cookie made with <500 μm UHF |
| | particles is much harder/firmer” |
| #13 | “Yes; mouthfeel of the cookie made with <500 μm UHF |
| | particles is gritty” |

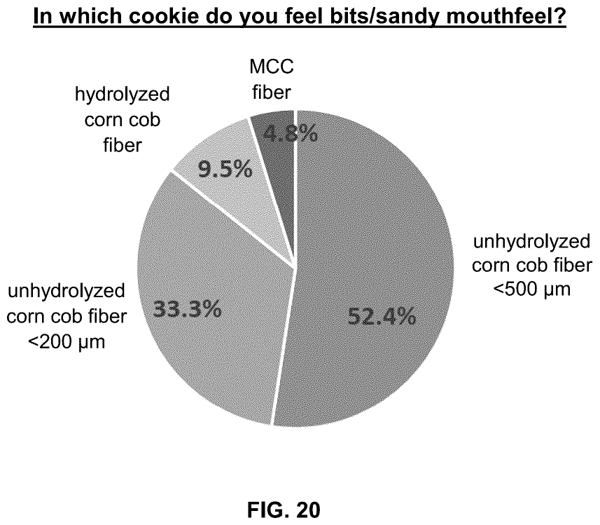

The respondents were asked which cookie they could feel a bitty/sandy mouthfeel. Each respondent could pick two cookies. As shown in FIG. 20, about 85% of respondents felt a bitty/sandy mouthfeel in the cookie made with UHF; 52.38% of respondents (11/21) felt a bitty/sandy mouthfeel in the cookie made with UHF with <500 μm fiber particles. 33.3% of respondents (7/21) felt a bitty/sandy mouthfeel in the cookie made with UHF with <200 μm fiber particles. 9.5% of respondents (2/21) felt a bitty/sandy mouthfeel in the cookie made with partially hydrolyzed corn cob fiber. 4.8% of respondents (1/21) felt a bitty/sandy mouthfeel in the cookie made with MCC partially hydrolyzed fiber.

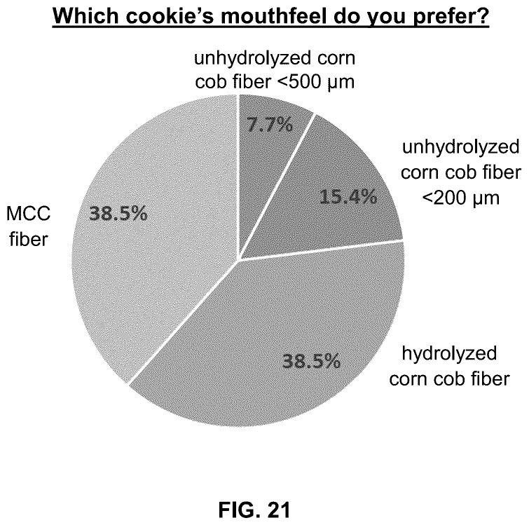

The respondents were asked which cookie's mouthfeel they preferred, FIG. 21. Each respondent could pick one cookie. About 77% of respondents preferred the mouthfeel of the cookie made with partially hydrolyzed corn cob fiber or MCC partially hydrolyzed fiber; 38.5% of respondents (5/13) preferred the mouthfeel of the cookie made with MCC partially hydrolyzed fiber. 38.5% of respondents (5/13) preferred the mouthfeel of the cookie made with partially hydrolyzed corn cob fiber. 15.4% of respondents (2/13) preferred the mouthfeel of the cookie made with <200 μm UHF particles. Only 7.7% of respondents (1/13) preferred the mouthfeel of the cookie made with <500 UHF particles. This respondent suggested that this cookie was more crunchy and chewier than the others, which the respondent preferred.

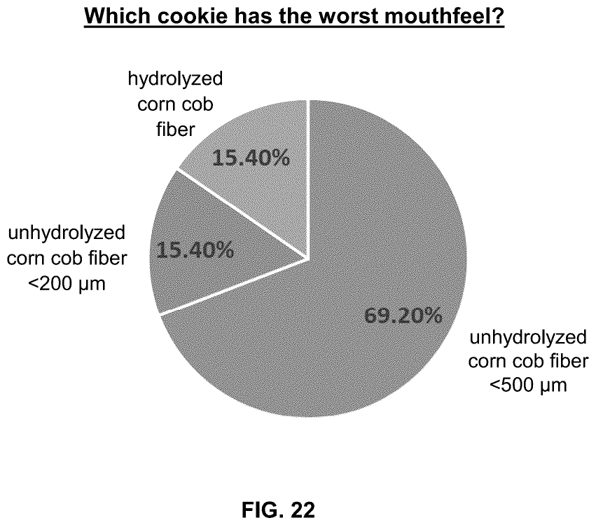

The respondents were asked which cookie had the worst mouthfeel, FIG. 22. Each respondent could pick one cookie. About 70% of respondents (9/13) said that the cookie made with <500 UHF particles had the worst mouthfeel the mouthfeel of the cookies made with partially corn cob fiber and MCC partially hydrolyzed fiber. 15.4% of respondents (2/13) said that the cookie made with <200 UHF particles had the worst mouthfeel. 15.4% of respondents (2/13) said that the cookie made with partially hydrolyzed corn cob fiber had the worst mouthfeel. The cookie made with MCC partially hydrolyzed fiber was not associated with a worst mouthfeel.

Therefore the baked goods made with partially hydrolyzed corn cob fiber are more palatable than those made with unhydrolyzed fiber, even if the unhydrolyzed fiber has a similar particle size to the partially hydrolyzed fiber.

### Example 13—Compositions Used in Examples 1-12

One composition used in this work was unhydrolyzed corn cob fiber (UHF). The particle size of UHF was measured using sieves with different aperture sizes. The amount of corn cob fiber particles retained by each sieve aperture size is summarized in Table 12. The cellulose and hemicellulose composition of UHF is summarized in Table 13.

TABLE 12
The amount of UHF particles retained by different sieve sizes

| Sieve aperture | % of Corn Cob Particles in a sample |
|---|---|
| size (μm) | retained by sieve (cumulative) |
| 355 | 50 |
| 200 | 85 |
| 100 | 95 |
| 53 | 99 |
| 1 | 100 |

TABLE 13
The Composition of UHF vs. Partially Hydrolyzed Corn Cob Fiber

| | | | Cellulose/ |
|---|---|---|---|
| | Cellulose | Hemicellulose | Hemicellulose |
| Sample | (%) | (%) | (ratio) |
| Unhydrolyzed corn | 46.2 | 40.1 | 1.2 |
| cob fiber (UHF) | | | |
| Partially Hydrolyzed | 76.3 | 14 | 5.5 |
| corn cob fiber (PHF) | | | |
| MCC partially | >99 | <0.1 | N/A |
| hydrolyzed fiber | | | |
| Unhydrolyzed oat | 49 | 43 | 1.14 |
| fiber | | | |
| Partially hydrolyzed | 78 | 10 | 7.8 |
| oat fiber | | | |

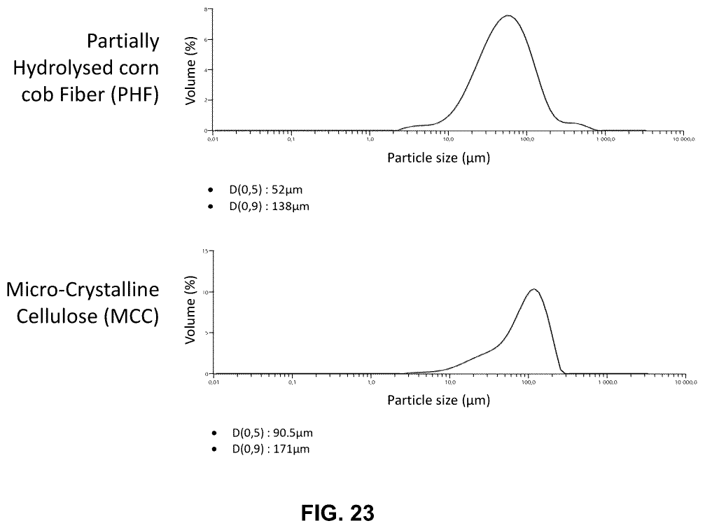

Another composition used in this work was Partially hydrolyzed corn cob Fiber (PHF). The cellulose and hemicellulose composition of PHF is summarized in Table 13. As shown in FIG. 23, the (the diameter where 50 percent of the particle size distribution had a smaller size and 50 percent has a larger size) D50 or D(0,5) and D90 or D(0,9) of partially hydrolyzed corn cob fiber were 52 and 138 μm, respectively. The composition of ground UHF differed from that of partially hydrolyzed corn cob fiber. Components such as lignin and hemicellulose (xylan) were lower in partially hydrolyzed corn cob fiber, but partially hydrolyzed corn cob fiber had a higher percentage of cellulose in its composition, as compared to the composition of UHF.

Another composition used in this work is Micro-Crystalline Cellulose (MCC) partially hydrolyzed fiber. MCC partially hydrolyzed fiber is commercially available pure partially depolymerized cellulose synthesized from α-cellulose precursor (e.g., wood). In the presence of water and mineral acid, the hydrolysis process breaks cellulose polymers into smaller chain polymers (microcrystals). The D10 or D(0,1) (the diameter where 10 percent of the distribution had a smaller size and 90 percent has a larger size), D50, and D90 of MCC fiber were less than 50 μm, 90-140 μm, and at least 170 μm, respectively. The cellulose and hemicellulose composition of MCC is summarized in Table 13.

As shown in Table 14, cellulose would not enrich in the native biomass raw material sources to the degree that MCC partially hydrolyzed fiber or the partially hydrolyzed corn cob fiber or the partially hydrolyzed oat fiber did.

TABLE 14
The Composition of Different Partially
Hydrolyzed Lignocellulosic Biomass

| Lignocellulosic | Cellulose | Hemicellulose | Lignin |
|---|---|---|---|
| Biomass | (%) | (%) | (%) |
| Bamboo | 49-50 | 18-20 | 23 |
| Corn Cobs | 45 | 35 | 15 |
| Corn Stover | 35-40 | 21-25 | 11-19 |
| Grasses | 25-40 | 35-50 | 10-30 |
| Hardwood Stems | 40-50 | 24-40 | 18-25 |
| Nut Shells | 25-30 | 25-30 | 30-40 |
| Rice Straw | 29-35 | 23-26 | 17-19 |
| Softwood Stems | 45-50 | 25-35 | 25-35 |
| Sugar Cane Bagasse | 25-45 | 28-32 | 15-25 |
| Switch Grass | 30-50 | 10-40 | 5-20 |
| Wheat Straw | 33-40 | 20-25 | 15-20 |

### Example 14—Production of Baked Goods Using Unhydrolyzed Oat Fiber (OF) as Insoluble Saccharide/Fiber with Different Particle Sizes

Cookie dough mixes were prepared according to the formulation in Table 15.

TABLE 15
Recipe of a 25 g Cookie Dough Mix Ingredients
Weight (g) Soluble saccharide and insoluble
saccharide/partially hydrolyzed fiber mixture

| Ingredients | Weight (g) |
|---|---|
| Soluble saccharide and insoluble saccharide/fiber | 9.7 |
| mixture or sucrose | |
| Unsalted butter | 5.2 |
| Eggs | 2.3 |
| Vanilla bean paste | 0.5 |
| Plain flour | 7.2 |
| Baking soda | 0.2 |

Xylo-oligosaccharides/Cellobiose (7:1) was used as the soluble oligosaccharide. Unhydrolyzed Oat fiber (OF) was used as the insoluble saccharide/fiber. According to Table 16, various ratios of soluble oligosaccharides and insoluble saccharide/unhydrolyzed fiber were prepared by mixing xylo-oligosaccharides/cellobiose (7:1) with unhydrolyzed Oat fiber. The two particle sizes of the unhydrolyzed oat fiber were obtained after sieving the fiber using sieves with various size apertures. The proportion of OF particles retained by sieve aperture sizes is summarized in Table 17.

TABLE 16
Ratios of Xylo-Oligosaccharide/Cellobiose
and Oat Fiber for a 25-g Cookie Dough Mix

| % w of | Soluble XOS:COS | Unhydrolyzed Oat fiber (g) | |
|---|---|---|---|
| Fiber | (7:1) g | (<53 μm or <200-100 μm) | Total |
| 0 | 9.7 | 0.0 | 9.7 |
| 7.5 | 9.0 | 0.7 | 9.7 |
| 15 | 8.2 | 1.5 | 9.7 |
| 25 | 7.3 | 2.4 | 9.7 |
| 35 | 6.3 | 3.4 | 9.7 |

TABLE 17
Unhydrolyzed Oat fiber particles retained by different sieve sizes

| Size (micron) | Retention (%) |
|---|---|
| 710 | 0.16 |
| 500 | 0.13 |
| 355 | 0.12 |
| 200 | 0.68 |
| 100 | 33.74 |
| 53 | 35.20 |
| Ground | 29.97 |

The cookie dough was prepared by first mixing the soluble and insoluble saccharide/fiber. After the melted butter, eggs, vanilla bean paste, flour, and baking powder were added to the mixture. The optimum development point of the dough was considered when the ingredients were properly incorporated and allowed the cookies to be moulded. 25 g of the resultant cookie dough mix was placed on a baking tray and the cookies were baked for 12 minutes at 160° C. Eleven cookies were prepared for each ratio and a sucrose control using granulated sugar was used to compare results. Water loss (%), spreadability, colour and texture of cookies were analysed.

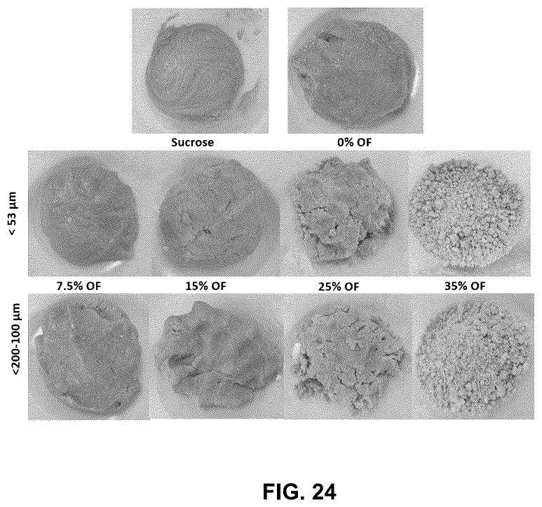

As shown in FIG. 24, the cookie dough becomes dryer and harder with the increase of unhydrolyzed oat fiber content, indicating a need for adjustment of water and fat content in the recipe above 25% w/w OF. At levels up to 15% OF w/w, the cookie dough could be moulded by hand. At 35% w/w OF the dough was crumbly but could be pressed to form a ball.

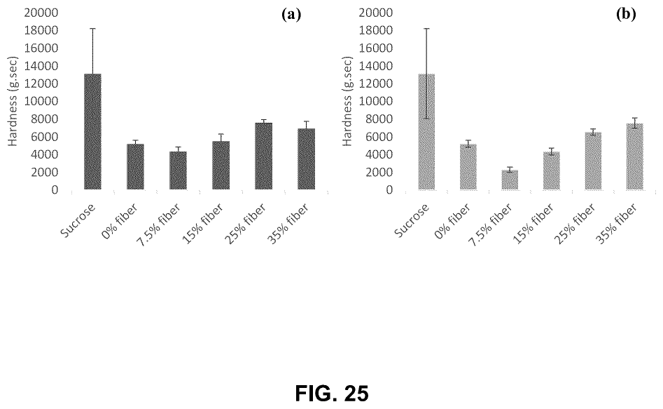

As shown in FIG. 25, cookie hardness decreased when OF was included compared to the sucrose control. When OF was present, hardness increased with increasing the percentage of OF inclusion, independent of particle size, compared to the control without fiber. The loss of hardness could be explained by less structure formation in the dough. With increasing the percentage of OF inclusion, the higher fiber levels lacked structure formation capacity due to limited water availability and competition for water with other dough components.

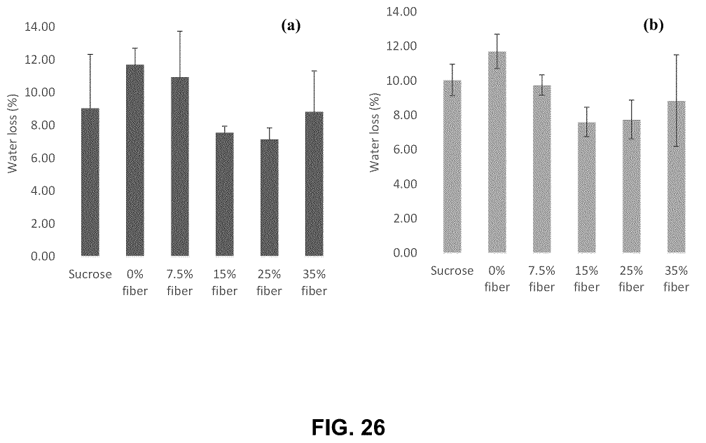

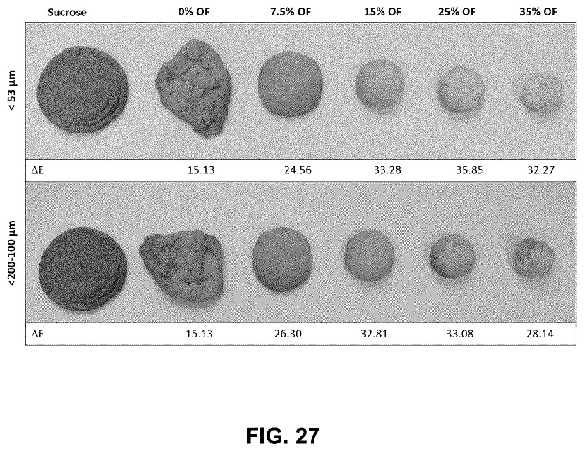

As shown in FIG. 26, both cookies with different particle sizes of OF demonstrated a decrease in water loss when compared to the sucrose control, because of the high-water retention capacity of the fiber relative to sucrose (FIG. 26). Increasing the percentage of OF inclusion, increased lightness, as shown in FIG. 27. This increased lightness was a consequence of less reducing sugars available to participate in the Maillard reaction. Compared to the sucrose control, cookies containing XOS:COS (7:1) and unhydrolyzed oat fiber were lighter, suggesting that OF can be used to control non-enzymatic browning reactions in baked goods.

As shown in FIG. 27, the spreadability reduced with increasing the percentage of OF inclusion, independent of particle size. Cookies containing OF maintained the initial shape and increased in height. Without OF, cookies spread significantly and had irregular shapes. Above 25% OF, cookies presented fissures on the surface.

### Example 15—Production of Baked Goods Using Partially Hydrolyzed Oat Fiber (pH-OF) as Insoluble Saccharide/Fiber with Two Levels of Sucrose Replacement

Cookie dough mixes were prepared according to the formulation in Table 15 above.

Xylo-oligosaccharides/Cellobiose (XOS:COS—7:1) (Table 18) alone or in combination with sucrose (Table 18) was used as the soluble oligosaccharide. Partially hydrolyzed Oat fiber (ph-OF) was used as the insoluble saccharide/fiber. Various ratios of soluble oligosaccharide and insoluble saccharide/fiber were prepared by mixing XOS:COS (7:1) with ph-OF replacing 100% w/w of sucrose in the dough (Table 18) and 50% w/w of the sucrose in the dough (Table 19). The particle sizes of the ph-OF are summarized in Table 20.

TABLE 18
Ratios of Xylo-Oligosaccharides/Cellobiose and
Partially Hydrolyzed Oat Fiber for a 25-g Cookie
Dough Mix for 100% sucrose replacement

| % of Fiber | Soluble XOS:COS (7:1) g | ph-OF (g) | Total |
|---|---|---|---|
| 0 | 9.7 | 0. | 9.7 |
| 7.5 | 9.0 | 0.7 | 9.7 |
| 15 | 8.2 | 1.5 | 9.7 |
| 25 | 7.3 | 2.4 | 9.7 |
| 35 | 6.3 | 3.4 | 9.7 |

TABLE 19
Ratios of Xylo-Oligosaccharides/Cellobiose and
Partially Hydrolyzed Oat Fiber for a 25-g Cookie
Dough Mix for 50% sucrose replacement

| % of Fiber | Soluble XOS:COS (7:1) g | ph-OF (g) | Sucrose |
|---|---|---|---|
| 0 | 4.9 | 0. | 4.9 |
| 7.5 | 4.2 | 0.7 | 4.9 |
| 15 | 3.4 | 1.5 | 4.9 |
| 25 | 2.5 | 2.4 | 4.9 |
| 35 | 1.5 | 3.4 | 4.9 |

TABLE 20
Partially hydrolyzed Oat fiber particles
(ph-OF) retained by different sieve sizes

| Size (micron) | Retention (%) |
|---|---|
| 710 | 4.24 |
| 500 | 13.00 |
| 355 | 12.76 |
| 200 | 15.27 |
| 100 | 14.63 |
| 53 | 20.07 |
| Ground | 20.04 |

The cookie dough was prepared by first mixing the soluble and insoluble saccharide/fiber. Afterwards, the melted butter, eggs, vanilla bean paste, flour, and baking powder were added to the mixture. The optimum development point of the dough was considered when the ingredients were properly incorporated and allowed the cookies to be moulded. 25 g of the resultant cookie dough mix was placed on a baking tray and the cookies were baked for 12 minutes at 160° C. Eleven cookies were prepared for each ratio and a sucrose control using granulated sugar was used to compare results. Water loss (%), spreadability, colour and texture of cookies were analysed.

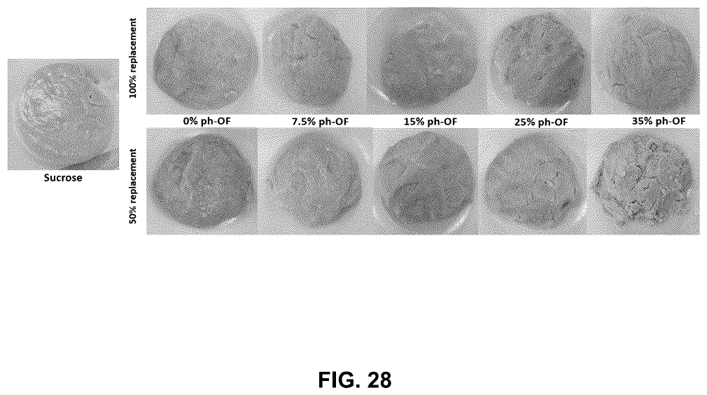

FIG. 28 shows that doughs could be made using a mixture of XOS:COS and ph-OF when replacing either 100% w/w or 50% w/w of the sucrose and adding 7.5-35 dry weight % w/w of fiber. Independent of the presence of sucrose in the dough, smooth doughs could be made for 0-15% w/w of fiber. At higher levels, the dough became crumbly but could be hand moulded into cookies. This increase in crumbliness related to high water absorption capacity of the ph-OF, resulting in insufficient hydration of the dough at the moisture level used in the trial.

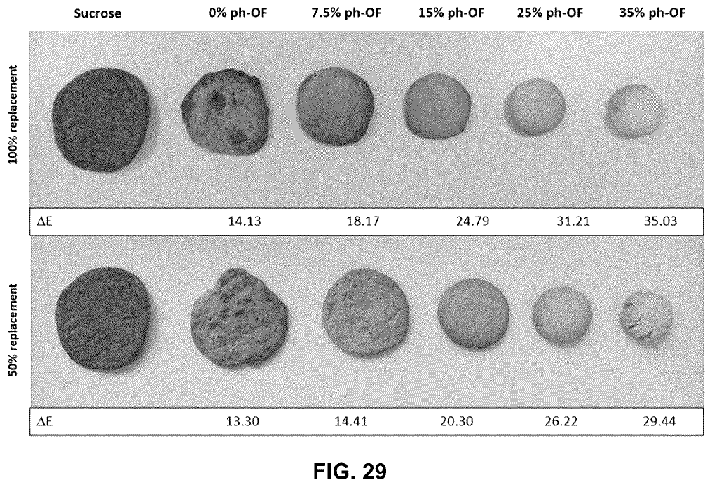

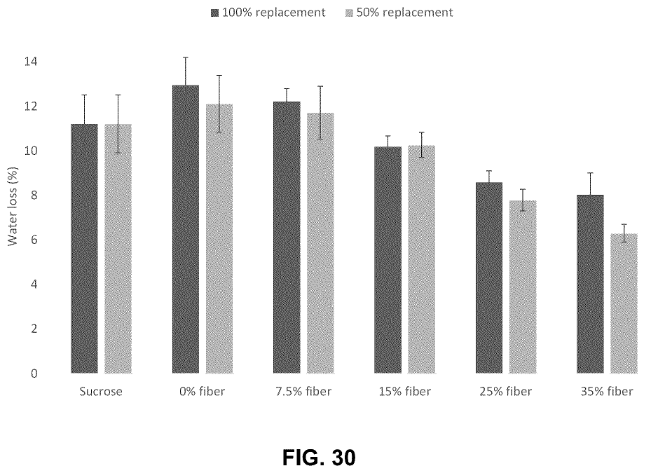

The initial differences were observed in the dough when only 50% w/w of the sugar in the dough was replaced by the XOS:COS mixture and fiber, the same trend as in the dough was seen, FIG. 29. The more fiber present in the 50% w/w sucrose samples, the less smooth the biscuit surface was. Independent of sucrose presence, cookies with 0 dry wt % fiber were irregularly shaped and had irregular surfaces. At 7.5 dry wt % fiber inclusion and higher, shape irregularity decreased and surfaces became smoother. At 25 dry wt % fiber, fissures started to appear on the surface and cookies started to crack. The increasing proportion of insoluble fiber competed for water absorption and less structure formation, independent of the source of soluble saccharides in the mixture. This observation was supported by the similarities in water loss between 100% and 50% sugar replacement (FIG. 30), the higher the fiber level, the lower the water loss, independent of the soluble fraction composition.

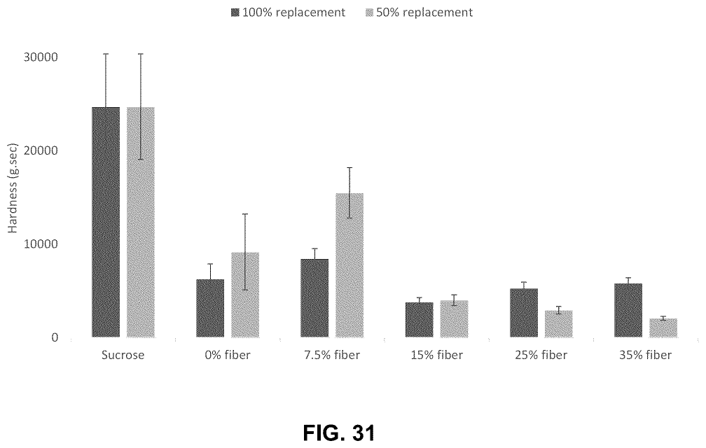

Considering cookie texture, the trends between 100% w/w and 50% w/w sucrose replacement were similar, XOS:COS and fiber containing cookies required less force to break the structure than sucrose containing cookies (FIG. 31). The fiber presence interfered with structure formation and competed for water uptake. At low fiber addition, the 50% w/w sucrose still contributed to cookie hardness while this effect was not visible at fiber level additions of 15% dry wt. and above. After 15% dry wt. of fiber addition, no further reduction in hardness was observed.

### Example 16—Comparing MCC Partially Hydrolyzed Fiber, Partially Hydrolyzed Oat Fiber (pH-OF), and Unhydrolyzed Oat Fiber (OF) in Baked Goods

Cookie dough mixes were prepared according to the formulation in Table 15 above.

Xylo-oligosaccharides/Cellobiose (7:1) (XOS:COS) (Table 21). Microcrystalline cellulose (MCC), partially hydrolyzed Oat fiber (ph-OF) or unhydrolyzed Oat Fiber (OF) were used as the insoluble saccharide/fiber. Various ratios of soluble oligosaccharide and insoluble saccharide/fiber were prepared by mixing XOS:COS (7:1) with MCC, ph-OF or OF, replacing 100% w/w sucrose in the dough (Table 21).

TABLE 21
Ratios of Xylo-Oligosaccharides/Cellobiose 7:1 and MCC, ph-OF
or OF for a 25-g Cookie Dough Mix for 100% sucrose replacement

| % of Fiber | Soluble XOS:COS (7:1) g | MCC, ph-OF, OF | Total |
|---|---|---|---|
| 0 | 9.7 | 0. | 9.7 |
| 7.5 | 9.0 | 0.7 | 9.7 |
| 15 | 8.2 | 1.5 | 9.7 |
| 25 | 7.3 | 2.4 | 9.7 |
| 35 | 6.3 | 3.4 | 9.7 |

The cookie dough was prepared by first mixing the soluble and insoluble saccharide/fiber. Afterwards, the melted butter, eggs, vanilla bean paste, flour, and baking powder were added to the mixture. The optimum development point of the dough was considered when the ingredients were properly incorporated and allowed the cookies to be moulded. 25 g of the resultant cookie dough mix was placed on a baking tray and the cookies were baked for 12 minutes at 160° C. Eleven cookies were prepared for each ratio and a sucrose control using granulated sugar was used to compare results. Water loss (%), spreadability, colour and texture of cookies were analysed.

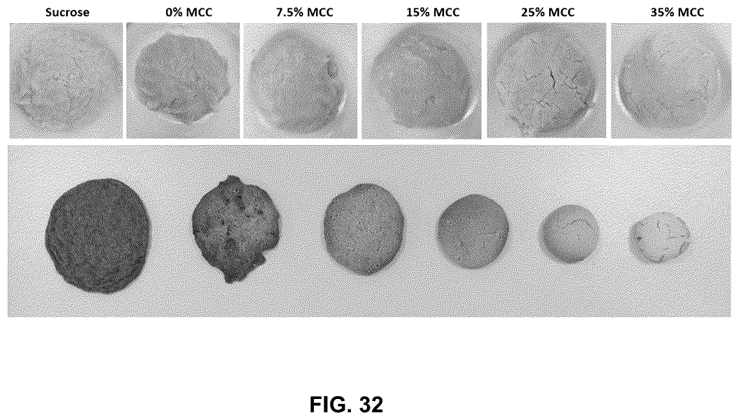

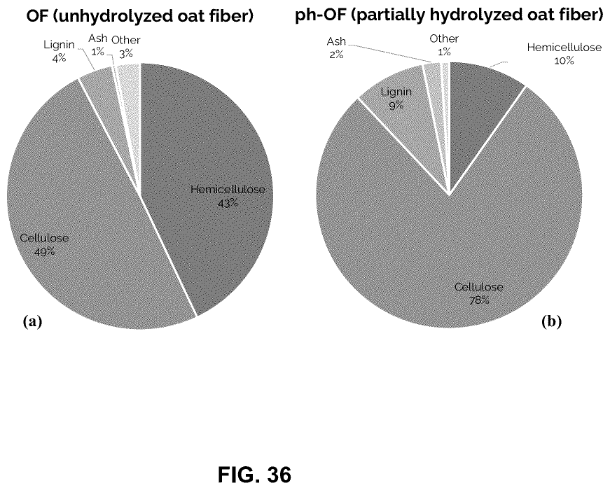

The hydrolysis process removed a significant fraction of the hemicellulose (xylan) in material (as shown in FIG. 36 with the difference in the composition between OF and ph-OF), creating material that resembled MCC more closely. Comparing the doughs and cookies of ph-OF (FIG. 28) to MCC (FIG. 32) showed that these properties were similar, increased crumbliness and less colour formation with increasing the percentage of fiber inclusion.

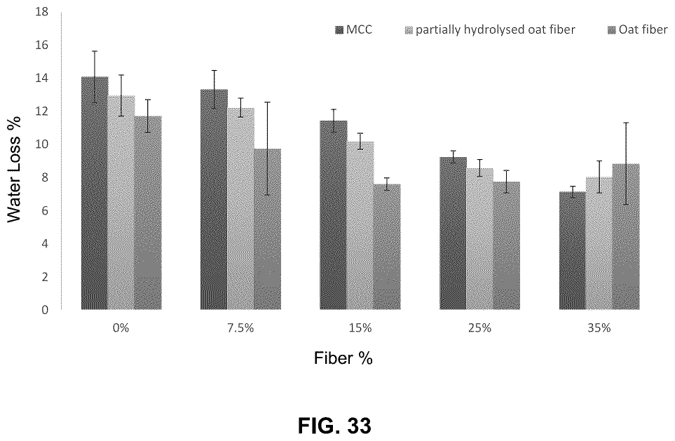

As shown in FIG. 33, the water loss linearly decreased with increasing the percentage of fiber incorporation. The hydrolysis of the oat fiber affected the water loss property showing distinct aspect when compared to unhydrolyzed oat fiber.

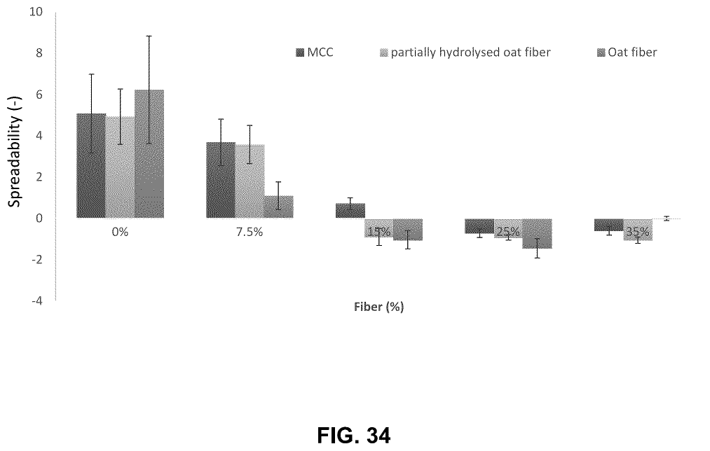

For all fibers used, spreadability decreased with increasing the percentage of fiber inclusion. For OF, the spreadability showed a stronger decrease at low levels than for ph-OF and MCC, which is related to increased water retention by the larger portion of hemicellulose presented in OF (FIG. 34). Reduction of spreadability is also related to dough viscosity. Increased viscosity by high fiber levels decreased the spreadability during baking.

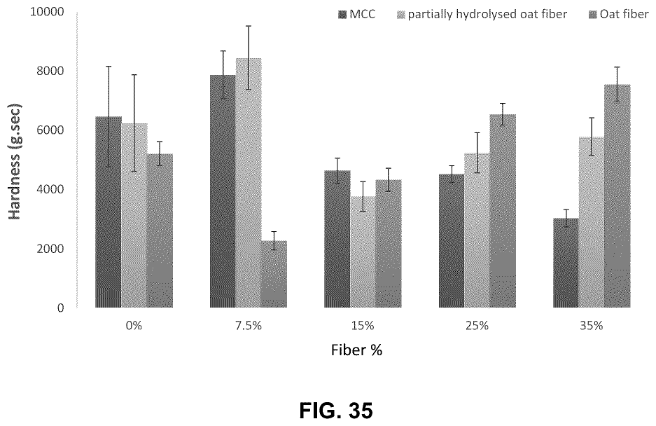

The effect of partial hydrolysis became most prominent when cookie hardness was assessed (FIG. 35). At low fiber inclusion level, 0 and 7.5% dry wt, hardness of OF dropped while these increased for MCC and ph-OF. The smaller polysaccharides and higher amount of cellulose contributed to cookie structure formation and increasing hardness. OF interfered with structure formation. At levels of 15% dry wt and above, there were no significant changes in hardness for both MCC and ph-OF and an increase in hardness for hydrolyzed OF, indicating different interactions with the matrix. This demonstrates that partial hydrolysis of the insoluble saccharide/fiber is necessary to produce a foodstuff.

### EMBODIMENTS

### Embodiments

1. A sweetener composition consisting essentially of:
a. a soluble oligosaccharide component, wherein the soluble oligosaccharide component is a mixture of cello-oligosaccharides and xylo-oligosaccharides; and
b. an insoluble saccharide component, wherein the insoluble saccharide component is a partially hydrolyzed fiber; wherein the insoluble saccharide component has a particle size from 30 microns to 300 microns;
   wherein the sweetener composition comprises from 10% to 30% w/w of the insoluble saccharide component;
   wherein a food product made using the sweetener composition as a component has a smell, flavor, texture comparable to a control food composition made using sucrose as a sweetener component.
   2. The sweetener composition of embodiment 1, wherein the insoluble saccharide component has an average particle size from 30 microns to 100 microns.
   3. The sweetener composition of embodiment 1, wherein the insoluble saccharide component has a particle size from 50 microns to 200 microns.
   4. The sweetener composition of embodiment 1, the weight ratio of the insoluble saccharide component to the soluble oligosaccharide component being 2:98 to 30:70.
   5. The sweetener composition of embodiment 1, the soluble oligosaccharide comprising at least 80 dry wt. % soluble oligosaccharides having a DP of two to twenty.
   6. The sweetener composition of any one of embodiments 1 to 3, the insoluble saccharide comprising partially hydrolyzed biomass wherein the ratio of cellulose:hemicellulose in the partially hydrolyzed biomass is greater than in the corresponding unhydrolyzed biomass.
   7. The sweetener composition of embodiment 4, the partially hydrolyzed biomass comprising microcrystalline cellulose (MCC), partially hydrolyzed oat fiber, partially hydrolyzed corn cob fiber, partially hydrolyzed corn bran, partially hydrolyzed corn stover, partially hydrolyzed wheat straw or partially hydrolyzed wheat bran.
   8. The sweetener composition of embodiment 4, the partially hydrolyzed biomass comprising cellulose, hemicellulose, and/or lignin.
   9. The sweetener composition of any one of embodiments 1 to 8, the insoluble saccharide comprising at least one of:
(i) a cellulose;
(ii) a xylan; or
(iii) a mannan.
   10. The sweetener composition of any one of embodiments 1 to 8, the insoluble saccharide comprising at least two of:
(i) a cellulose;
(ii) a xylan; or
(iii) a mannan.
   11. The sweetener composition of any one of the embodiments above, the insoluble saccharide comprising greater than 20% cellulose.
   12. The sweetener composition of any one of the embodiments above, the insoluble saccharide comprising greater than 40% cellulose.
   13. The sweetener composition of any one of the embodiments above, the insoluble saccharide comprising greater than 1% xylan.
   14. The sweetener composition of any one of the embodiments above, the insoluble saccharide comprising greater than 5% xylan.
   15. The sweetener composition of any one of the embodiments above, the insoluble saccharide comprising less than 70% xylan.
   16. The sweetener composition of any one of the embodiments above, the insoluble saccharide comprising less than 50% xylan.
   17. The sweetener composition of any one of the embodiments above, the insoluble saccharide comprising greater than 1% mannan.
   18. The sweetener composition of any one of the embodiments above, the insoluble saccharide comprising greater than 5% mannan.
   19. The sweetener composition of any one of the embodiments above, the insoluble saccharide comprising less than 70% mannan.
   20. The sweetener composition of any one of the embodiments above, the insoluble saccharide comprising less than 50% mannan.
   21. The sweetener composition of any one of the embodiments above, the insoluble saccharide comprising greater than 0.1% mixed-linkage glucan.
   22. The sweetener composition of any one of the embodiments above, the insoluble saccharide comprising less than 17.5% mixed-linkage glucan.
   23. The sweetener composition of any one of embodiments 1 to 22, the sweetener composition comprising less than 20% w/v glucose, fructose, galactose, sucrose, maltose, or lactose.
   24. The sweetener composition of any one of embodiments 1 to 22, the sweetener composition comprising less than 20% w/v monosaccharides.
   25. The sweetener composition of any one of embodiments 1 to 24, the insoluble saccharide comprising a multimolecular complex of cellulose and hemicellulose.
   26. The sweetener composition of any one of embodiments 1 to 25, the insoluble saccharide comprising a polyaromatic compound.
   27. The sweetener composition of any one of the embodiments above, wherein the partially hydrolyzed biomass is a biomass which has been hydrolyzed using enzyme hydrolysis.
   28. The sweetener composition of any one of the embodiments above, wherein the partially hydrolyzed biomass is a biomass which has been hydrolyzed using non-enzymatic hydrolysis.
   29. The sweetener composition of any one of the embodiments above, the weight ratio of the cello-oligosaccharide to the xylo-oligosaccharide being 2:98 to 50:50.
   30. The sweetener composition of any one of the embodiments above, the cello-oligosaccharide having a DP of 2 to 4.
   31. The sweetener composition of any one of the embodiments above, the cello-oligosaccharide comprising greater than 30% cellobiose.
   32. The sweetener composition of any one of the embodiments above, the cello-oligosaccharide comprising less than 10% cellotriose.
   33. The sweetener composition of any one of the embodiments above, the cello-oligosaccharide comprising less than 5% cellotetraose.
   34. The sweetener composition of any one of the embodiments above, the xylo-oligosaccharide having a DP of 2 to 6.
   35. The sweetener composition of embodiment 34, the xylo-oligosaccharide comprising less than 70% xylobiose.
   36. The sweetener composition of any one of the embodiments 34-35, the xylo-oligosaccharide comprising less than 30% xylotriose.
   37. The sweetener composition of any one of the embodiments 34-36, the xylo-oligosaccharide comprising less than 10% xylotetraose.
   38. The sweetener composition of any one of embodiments 34 to 37, the xylo-oligosaccharide comprising at least 5% substituted xylo-oligosaccharide.
   39. The sweetener composition of embodiment 38, wherein the sweetener composition is consumable by a human.
   40. A food product comprising from 1% to 50% w/w of the sweetener composition of any one of the previous embodiments, wherein at least one characteristic of the food product selected of the group consisting of texture, height, color, water loss or sweetness being within 20% of the same characteristic of a control food product, the control food product comprising a soluble oligosaccharide and lacking an insoluble saccharide in the composition of a component whose purpose in the food product is to modulate texture, height, color, water loss or sweetness of the food product.
   41. A food product comprising from 1% to 50% w/w of the sweetener composition of any one of the previous embodiments, wherein at least one characteristic of the food product selected of the group consisting of texture, height, color, water loss or sweetness being within 10% of the same characteristic of a control food product, the control food product comprising a soluble oligosaccharide and lacking an insoluble saccharide in the composition of a component whose purpose in the food product is to modulate texture, height, color, water loss or sweetness of the food product.
   42. A food product comprising from 1% to 50% w/w of the sweetener composition of any one of the previous embodiments, wherein at least one characteristic of the food product selected of the group consisting of texture, height, color, water loss or sweetness being within 10% of the same characteristic of a control food product, the control food product comprising sucrose and lacking an insoluble saccharide in the composition of a component whose purpose in the food product is to modulate texture, height, color, water loss or sweetness of the food product.
   43. The food product of any one of embodiments 40-42, wherein the food product is a baked good.
   44. The baked good of embodiment 43, the baked good selected from the group consisting of a cookie, cake, muffin, biscuit, pastry, or scone.
   45. The food product or baked good of any one of embodiments 40-43, wherein the food product or the baked good comprise lignocellulose thermochemical breakdown products, such as alpha pinene, tetrahydrolinalool, dihydromyrcenol, furfural, menthone, isomenthone, linalool, menthyl acetate, neomenthol, caryophyllene, Isomenthol, menthol, Phenylacetaldehyde, Pulegone, 4-t-butylcyclohexyl acetate, Carvone, dihydroxybenzaldehyde isomer, anethole, guaiacol, verdyl acetate, 2-phenylethyl alcohol, beta ionone, diphenyl ether, phenolicmethoxybenzaldehyde isomer, Thymol, vinyl guaiacol, hexyl salicylate, Myristicin, isoeugenol, alpha hexylcinnamaldehyde, vinyl phenol, vanillin, hexadecanoic acid at greater than 10 ppb.
   46. The food product of embodiment 40-42, the food product being a fat-based food product containing more than 20% w/w fat.
   47. The food product of embodiment 45, the fat-based food product selected from the group consisting of chocolate and ice cream.
   48. The food product of embodiment 40-42, the food product being a water-based food product.
   49. The food product of embodiment 47, the water-based food product selected from the group consisting of jam, jelly, icing, and candy.
   50. A sweetener composition comprising:
a) from 50% to 70% w/w xylo-oligosaccharides; wherein the xylo-oligosaccharides have a degree of polymerization from 2-6;
b) from 5% to 20% w/w cello-oligosaccharides; wherein the cello-oligosaccharides have a degree of polymerization from 2-4;
c) from 7.5% to 30% w/w insoluble saccharides, wherein the insoluble saccharides are an at least partially hydrolyzed biomass with a particle size from 30 microns to 300 microns;
wherein the sweetener composition consists essentially of a mixture of a, b and c.
   51. The method of forming a composition comprising:
(a) providing a plant biomass, the plant biomass comprising cellulose and hemicellulose; and
(b) incubating the plant biomass with at least one enzyme, thereby yielding a composition comprising:
   i. a soluble oligosaccharide component, the soluble oligosaccharide component comprising soluble oligosaccharide having a degree of polymerization (DP) of 2 to 20; and
   ii. an insoluble saccharide component, the insoluble saccharide component comprising insoluble saccharide having a DP of at least 20, the composition comprising the soluble oligosaccharide component and the insoluble saccharide component in a combined total amount of at least 50 dry wt. %, the weight ratio of the insoluble saccharide component to the soluble oligosaccharide component being 1:99 to 50:50.
      52. The method of embodiment 50, further comprising thermochemically treating the plant biomass.
      53. The method of embodiment 50 or embodiment 51, the weight ratio of the insoluble saccharide component to the soluble oligosaccharide component being 2:98 to 50:5

What is claimed:

1. A sweetener composition comprising:
a. a soluble saccharide component, wherein the soluble saccharide component comprises at least two oligosaccharides selected from: cello-oligosaccharides, xylo-oligosaccharides, mannan-oligosaccharides and mixed-linkage glucan oligosaccharides; and
b. at least 10 wt % of an insoluble saccharide component, wherein the insoluble saccharide component is a partially hydrolyzed fiber having a D50 particle size value of 30 microns to 300 microns, the partially hydrolyzed fiber comprising:
i. at least 50% cellulose by dry w/w of the insoluble saccharide component,
ii. hemicellulose, and
iii. lignin
wherein a weight ratio of the insoluble saccharide component to the soluble saccharide component is less than 5:1 w/w;
wherein the sweetener composition provides a smell, a flavor, and/or a texture when added to a foodstuff, which is comparable to a smell, a flavor, and/or a texture provided by sucrose.

2. The sweetener composition of claim 1, wherein replacement of sucrose in a control raw cookie composition with the sweetener composition, results in a cookie composition having a comparable water loss or a lesser water loss after 10 minutes of baking the sucrose-replaced raw cookie composition to a control cookie composition made by baking the control raw cookie composition for 10 minutes.

3. The sweetener composition of claim 1, wherein the D50 particle size value of the insoluble saccharide component is 50 microns to 200 microns.

4. The sweetener composition of claim 1, wherein the soluble saccharide component comprises at least 80% soluble oligosaccharides having a DP of two to twelve, by dry w/w of the soluble saccharide component.

5. The sweetener composition of claim 1, wherein the insoluble saccharide component comprises a partially hydrolyzed biomass produced from an unhydrolyzed biomass, wherein the partially hydrolyzed biomass comprises cellulose and hemicellulose at a greater % w/w than the unhydrolyzed biomass.

6. The sweetener composition of claim 5, the partially hydrolyzed biomass comprises microcrystalline cellulose (MCC), partially hydrolyzed oat fiber, partially hydrolyzed corn cob fiber, partially hydrolyzed corn bran, partially hydrolyzed corn stover, partially hydrolyzed wheat straw or partially hydrolyzed wheat bran.

7. The sweetener composition of claim 1, wherein the insoluble saccharide component comprises:
(i) 50-91% cellulose by dry w/w of the insoluble saccharide component;
(ii) 7.5-30% hemicellulose by dry w/w of the insoluble saccharide component; and
(iii) lignin.

8. The sweetener composition of claim 1, wherein the insoluble saccharide component comprises at least one of:
(i) greater than 1% mixed-linkage glucan by dry w/w of the insoluble saccharide component;
(ii) greater than 5% xylan dry w/w of the insoluble saccharide component; or
(iii) greater than 5% mannan by dry w/w of the insoluble saccharide component.

9. The sweetener composition of claim 1, wherein the sweetener composition comprises less than 20% w/w glucose, fructose, galactose, sucrose, maltose, or lactose.

10. The sweetener composition of claim 1, wherein the sweetener composition comprises less than 20% w/w monosaccharides.

11. The sweetener composition of claim 1, wherein the insoluble saccharide comprises a multimolecular complex of cellulose and hemicellulose.

12. The sweetener composition of claim 5, wherein the partially hydrolyzed biomass is a biomass which has been hydrolyzed using enzyme hydrolysis.

13. The sweetener composition of claim 5, wherein the partially hydrolyzed biomass is a biomass which has been hydrolyzed using non-enzymatic hydrolysis.

14. A food product comprising from 1% to 50% w/w of the sweetener composition of claim 1, wherein at least one characteristic of the food product selected from the group consisting of texture, height, color, water loss and sweetness, differs by less than 20% from an equivalent characteristic of a control food product comprising the soluble saccharide component but lacking the insoluble saccharide component of the sweetener.

15. The food product of claim 14, wherein the at least one characteristic of the food product differs by less than 10% from the control food product.

16. The food product of claim 14, wherein the food product is a baked good, a fat-based food product or a water-based food product.

17. The food product of claim 16, wherein the food product is a baked good selected from the group consisting of a cookie, a cake, a muffin, a biscuit, a pastry, or a scone.

18. The food product of claim 14, wherein the food product comprises one or more lignocellulose thermochemical breakdown product(s) comprising at least one compound selected from the group of: alpha pinene, tetrahydrolinalool, dihydromyrcenol, furfural, menthone, isomenthone, linalool, menthyl acetate, neomenthol, caryophyllene, Isomenthol, menthol, Phenylacetaldehyde, Pulegone, 4-t-butyl cyclohexyl acetate, Carvone, dihydroxybenzaldehyde isomer, anethole, guaiacol, verdyl acetate, 2-phenylethyl alcohol, beta ionone, diphenyl ether, phenolicmethoxybenzaldehyde isomer, Thymol, vinyl guaiacol, hexyl salicylate, Myristicin, isoeugenol alpha hexylcinnamaldehyde, vinyl phenol, vanillin, and hexadecanoic acid, at a concentration greater than 10 ppb in the foodstuff of the one or more lignocellulose thermochemical breakdown product(s) in total.

19. The food product of claim 16, wherein the food product is a fat-based food product selected from the group consisting of a chocolate and an ice cream.

20. The food product of claim 16, wherein the food product is a water-based food product selected from the group consisting of a jam, a jelly, an icing, and a candy.

21. A method of making a food product using a sweetener composition, the method comprising:
(a) providing a plant biomass, the plant biomass comprising cellulose and hemicellulose;
(b) performing a partial hydrolysis of the plant biomass, to produce a partially hydrolyzed fiber, wherein the partially hydrolyzed fiber has a D50 particle size value of 30 microns to 300 microns, the partially hydrolyzed fiber comprising:
i. at least 50% cellulose by dry w/w of the insoluble saccharide component,
ii. hemicellulose, and
iii. lignin;
(c) combining the partially-hydrolyzed fiber with a soluble saccharide composition to produce a sweetener composition, wherein the soluble saccharide composition comprises at least two oligosaccharides selected from: cello-oligosaccharides, xylo-oligosaccharides, mannan-oligosaccharides and mixed-linkage glucan oligosaccharides;
(d) incorporating the sweetener composition into a foodstuff to produce the food product, the food product comprising 1-50% by dry w/w of the sweetener composition.

22. The method of claim 21, wherein the partially-hydrolyzed fiber and the soluble saccharide composition are separately incorporated into the foodstuff.

23. The method of claim 21, wherein the partial hydrolysis of step b) comprises: incubating the plant biomass with at least one enzyme, thereby yielding a composition comprising:
i. a soluble oligosaccharide having a degree of polymerization (DP) of 2 to 20; and
ii. an insoluble saccharide having a DP of at least 20;
and wherein the soluble saccharide composition of c) comprises the soluble oligosaccharide having a degree of polymerization (DP) of 2 to 20.
